(19) United States
(12) Patent Application Publication
(10) Pub. No.: US 2026/0111727 A1
(43) Pub. Date: Apr. 23, 2026

(54) CATALYSTS FOR GROWTH OF SUPERINTELLIGENCE

(71) Applicant: iQ Consulting Company Inc., Aptos, CA (US)

(72) Inventor: Craig Kaplan, Aptos, CA (US)

(73) Assignee: iQ Consulting Company Inc., Aptos, CA (US)

(21) Appl. No.: 19/155,331

(22) PCT Filed: Mar. 12, 2024
(86) PCT No.: PCT/US2024/019486

§ 371 Date: Aug. 11, 2025

Related U.S. Application Data
(60) Provisional application No. 63/487,494, filed on Feb. 28, 2023.
(60) Provisional application No. 63/491,040, filed on Mar. 17, 2023.
(60) Provisional application No. 63/577,830, filed on May 25, 2023.
(60) Provisional application No. 63/628,410, filed on Jul. 18, 2023.
(60) Provisional application No. 63/519,549, filed on Aug. 14, 2023.
(60) Provisional application No. 63/601,930, filed on Nov. 22, 2023.
(60) Provisional application No. 63/609,800, filed on Dec. 13, 2023.

(30) Foreign Application Priority Data
Feb. 26, 2024 (WO) PCT/US2024/017233
Feb. 26, 2024 (WO) PCT/US2024/017251
Feb. 26, 2024 (WO) PCT/US2024/017261
Feb. 26, 2024 (WO) PCT/US2024/017269
Feb. 26, 2024 (WO) PCT/US2024/017304

(51) Int. Cl. G06N 3/08; G06N 5/022; G06N 5/043; G06N 20/00

(52) U.S. Cl. CPC G06N 3/08; G06N 5/022; G06N 5/043; G06N 20/00

(57) ABSTRACT

Data is the “fuel” that powers the machine learning “engine” for Artificial Intelligence. However, identifying high quality data that can catalyze smarter AI, AGI, and SuperIntelligent systems is becoming an increasingly challenging bottleneck for machine learning. This invention not only describes novel methods for identifying the most valuable data, but it also presents an entirely new framework for understanding the information content of AI-relevant datasets. The methods can be used by intelligent systems autonomously or in collaboration with humans. Novel methods for accelerating AI learning, and for updating the knowledge of AI systems in real-time, are also disclosed. Consistent with the view that human survival may depend on the fastest path to AGI also being the safest path, the invention describes catalysts which help maximize alignment between the values of AGI and humans. These innovative catalysts increase not only the intelligence, but also the safety, of AI systems.

### TECHNICAL FIELD

In some aspects, the present technology relates to a catalysts for growth of superintelligence for use in connection with providing catalysts enabling Artificial Intelligence (AI), Artificial General Intelligence (AGI), Personalized Super Intelligence (PSI) and SuperIntelligent (SI) agents or systems for increasing their intelligence rapidly, effectively and safely. It can be appreciated that AI, AGI, SI, and PSI can be used interchangeably in this disclosure since the inventive methods can relate to all of these forms of Artificial Intelligence.

In some aspects, the present technology relates to means for increasing the intelligence of AI, AGI, and SI systems as rapidly, effectively, and safely as possible.

In some aspects, the present technology relates to a novel and inventive approach called Kaplan Information Theory (KIT) that enables novel catalysts for increasing the intelligence of an AI, AGI, PSI or SI system. In other aspects, KIT can enable entirely new methods for increasing a system's intelligence.

In yet other aspects, all activities that are described in this patent disclosure as happening on an external network in which multiple intelligent entities participate in collaborative problem-solving, can also be implemented within a single computerized intelligent system where the intelligent entities are all computerized or AI agents that reside within that single computerized intelligent system.

### BACKGROUND ART

The fastest and safest path to development of AGI and SI has been described in previous invention disclosures. Methods for increasing intelligence of AI systems generally, as well as the development of AGI and PSI have also been previously disclosed. Therefore, the following U.S. Provisional Patent Applications (PPA), are incorporated herein by reference.

US PPA No. 63/487,494 entitled “Advanced Autonomous Artificial Intelligence (AAAI) System and Methods”, filed on February 28, 2023.

US PPA No. 63/491,040 entitled “System and Methods for Ethical and Safe Artificial General Intelligence (AGI)” filed on Mar. 17, 2023. This PPA includes scenarios with technology from Meta®), Amazon®, Google®, DeepMind®, YouTube®, TikTok®, Microsoft®, OpenAI®, Twitter®, Tesla®, Nvidia®, Tencent®, Apple®, and Anthropic®.

US PPA No. 63/577,830 “System and Methods for Human-Centered AGI”, filed on May 24, 2023.

US PPA No. 63/628,410 entitled “System and Methods for Safe, Scalable, Artificial General Intelligence”, filed on Jul. 18, 2023.

US PPA No. 63/519,549 entitled “Safe Personalized Super Intelligence (PSI)”, filed on Aug. 14, 2023.

The present technology contains further aspects that can be used with the system and methods described in the above-mentioned PPAs as well as in a standalone fashion.

In an as-yet-unpublished analysis, the inventor has described the background of the present technology, including how it draws on seminal ideas from some of the original founders of the field of AI. While the present technology goes far beyond these inspirational notions in novel and useful ways, understanding of the roots of the field and of the general collective intelligence approach to AGI may be helpful. The unpublished text by the inventor in this “Background” section is being submitted to a conference, but has not yet been made public, as of the time that this PPA was filed.

This unpublished analysis frames the contributions of four of the Founders of AI as “gifts” that can be extrapolated in novel, non-obvious, and useful ways in order to implement AGI and SuperIntelligence in a way that is very different than the mainstream approach but nonetheless consistent with the other PPAs and inventions cited by this application. The format of this background and disclosure section is: 1) An Introduction, 2) Enumeration and explication of four seminal ideas, and finally 3) a Conclusion that provides a high-level view of how the ideas may be drawn together into an integrated view of future AGI and SuperIntelligence. While this background section is very general, specific methods, systems, and approaches for how to create future AGI and SuperIntelligent systems have been described in detail in previous PPAs as well as later in this present technology disclosure.

Marvin Minsky (1927-2016), Claude Shannon (1916-2001). Allen Newell (1927-1992), and Herbert Simon (1916-2001) were four of eleven participants at the 1956 Dartmouth Conference where the field of Artificial Intelligence was named. Each of these intellectual giants helped lay the foundation for the field of AI.

However, given the rapid pace of AI development, one might reasonably question the relevance of AI research that is several decades out of date. After all, when these pioneers developed most of their ideas, the dominant approach to AI was symbolic. It was widely believed at the time that the only realistic way to get intelligent behavior out of machines was to program the behavior into them in the form of rules. Knowledge engineering was in fashion. Neural network, or connectionist, approaches to machine learning only began to be explored in earnest in the 1980s. At that time, it was met with intense skepticism from many of AI's founders.

Further, three of these four great scientists (Minsky being the exception) never lived to see deep learning begin to realize its potential. Can we really learn anything new or relevant from scientists who never lived to see Chat-GPT?

There are two answers to this question. On a personal level, the inventor remembers being a young graduate student in the 1980s interested in AI and problem solving. I had come to CMU to learn from a Nobel Laureate who had co-authored the definitive work on the subject. In one of our first meetings, this great man recommended that I begin by looking at Kohler's work (1925) and Dunker's work (1945). “Really?” I protested. “I came here to learn about modern problem solving, not to study the work of researchers who lived long ago.” He shot back, “Surely, you don't mean to imply that modern scientists have a monopoly on good ideas? There were also plenty of smart scientists back then you know.”

Of course, he was right. I discovered that both Kohler and Dunker were brilliant. In fact, applying modern thinking and some new experimental work to some of their fundamental ideas ultimately resulted in research published in a top journal (Kaplan and Simon 1990).

More importantly, I learned that an idea must be judged on its merits and not by the source, or even the period, from which it sprang. If the idea is powerful, it can drive innovation even if it was first expressed many years ago by thinkers now long gone. Given the opportunities and dangers that AI presents today, we need all the powerful ideas we can find.

So, my second answer to the question of whether ideas from these four deceased founders of AI can be relevant is simply: “the proof is in the pudding.” That is, the ideas are relevant if we can apply them productively to current and future problems of AI research. So, let us find out. On to the pudding!

### Gift #1: Society of Mind (Minsky)

About the same time that Rumelhart, Hinton, and Williams (1986) were developing the famous backpropagation algorithm that is the basis of modern deep learning, Marvin Minsky (1985) published a highly readable book entitled, The Society of Mind.

The first line of Minsky's book boldly proclaims: “This book tries to explain how minds work.” He lays out his big idea succinctly in the following six sentences:

How can intelligence emerge from nonintelligence? To answer that, we will show that you can build a mind from many little parts, each mindless by itself. I will call “Society of Mind” this scheme in which each mind is made of many smaller processes. These we will call agents. Each mental agent by itself can only do some simple thing that needs no mind or thought at all. Yet when we join these agents in societies—in certain very special ways—this leads to true intelligence.

What are the implications for modern AI researchers? Well, first, the idea of AI agents has become wildly popular with Google Scholar finding more than 16.000 articles mentioning them in the first nine months of 2023 alone.

However. Minsky's idea was not just that we could build a series of AI agents, but also that joining the agents together in special ways would result in “true intelligence”, or what today we would probably call Artificial General Intelligence (AGI). Using more modern terminology, we could say that Minsky was an early proponent of the idea of AGI emerging from the collective intelligence of many agents with lesser levels of intelligence.

Note that Minsky's collective intelligence approach is very different from many approaches to AGI today, which I would roughly characterize as building larger and more powerful LLMs until one of them is so intelligent it can do anything the average human can do. Extrapolating Minsky's view, it will require a group of agents to achieve AGI.

What are these agents? Well, many of them are AI agents, certainly. Since the release of ChatGPT in November 2023, there has been an explosion of AI agents populating sites like GitHub and HuggingFace. Using technologies such as Langchain, the open-source community is combining multiple agents into systems at a rate that is beyond the ability of any one human to fully understand. Yet Minsky does not specify that agents have to be artificial. Remember, his overall goal was to “explain how minds work”-which I read as “to explain how [all types of] minds work.”

Minsky's big idea was that combining the lesser cognitive capabilities of agents results in a more intelligent entity. Couldn't the agents that are being combined include human as well as artificial agents?

The answer, of course, is “Yes”—as Hemmer et, al (2021) show in their literature review on the subject. I suggest that a “Minsky-inspired system”, harnessing the collective intelligence of human and AI agents, represents both the fastest and safest path to AGI.

Such a system would be on the fastest path because human agents would be able to handle any tasks that artificial agents are not equipped to deal with on Day One.

The system might also represent the safest path, for two reasons. First, with “humans in the loop” the system could maximize the opportunity humans have for aligning the values of the AGI system with human values.

Second, once AI agents learn from humans and begin to perform most cognitive tasks faster than the humans, we end up with a system comprised of multiple AI agents rather than one. I have argued elsewhere (Kaplan 2023) that if each AI agent reflects values of a unique human owner, the collective values of the AGI system will be more stable compared to a single LLM that was trained on a small subset of values during the typical RLHF process prevalent today.

Finally, if we take Minsky's ideas to the next level, we could imagine a society of AGI minds that comprise a SuperIntelligence, many times more powerful than the individual AGIs that make up the society. Similarly, assuming that each AGI has a value system, the collective values of the SuperIntelligence that is comprised of the society of AGIs, are likely to be more stable than the values of any one AGI on its own.

Thus, both from a practical standpoint (where the goal is to reach AGI or SuperIntelligence as quickly as possible) and from a safety standpoint (where the goals is to have a stable, human-aligned value system), a Minsky-inspired collective intelligence approach seems promising.

Minsky's gift from the past might turn out to be critical to the design of safe AGI and therefore the future survival and prosperity of humans. However, we will need additional intellectual gifts, from some of Minsky's fellow co-founders of AI, to flesh out a vision of safe AGI.

### Gift #2: Information Theory (Shannon)

Claude Shannon's seminar paper, A Mathematical Theory of Communication (1948), pre-dates the founding of the field of AI by eight years, but his big idea, first elucidated in that paper, continues to have major implications for AI researchers today and in the future. While almost every page of Shannon's 83-page monograph is filled with mathematical formulae and notation. Shannon's essential insight can be described without math at all.

Here is how I typically explain the essence of Information Theory to my non-researcher friends:

Imagine that an ice cream shop has only two types of ice cream, strawberry and chocolate. Suppose you know that I am allergic to straw berries and love chocolate. If you see me walking out of the ice cream shop with a chocolate ice cream cone, does that event give you very much information?

No. That is because you already knew I loved chocolate and was allergic to straw berries and so you already expected me to come out with a chocolate ice cream. Seeing me with a chocolate ice cream added very little information because it just tells you what you already knew. Chocolate was the expected (i.e., highly probable) flavor.

On the other hand, if you see me walking out with a strawberry ice cream, well, that is surprising. It is unexpected. It is a low probability event and conveys a lot of information. Suddenly you are learning a lot of information that you did not already know, and your brain starts working on it. Maybe I have overcome my allergy, but how? Maybe I am throwing caution to the wind and trying strawberry for the first time in years anyway, but why? Maybe I am buying the ice cream for someone else, but for whom? Etc.

What Shannon said in his famous paper was that unusual or surprising (low probability) events convey more information than expected (more likely) events. More specifically, he said that the amount of information conveyed by an event was proportional to the probability of the event.

Simply put, the rarer or more unusual an event is, the more information (Shannon Entropy) it contains. Brilliant . . , and useful!

The concept of cross-entropy loss, used to evaluate the performance of many modern machine learning models, is essentially an elaboration of Shannon's big idea, as are almost all compression algorithms.

What might Shannon's big idea tell us about the future of AI-specifically AGI and SuperIntelligence?

It is almost axiomatic that AI (or at least modern machine learning) is supported by three pillars—Data, Compute, and Algorithms. To make progress, one must innovate on at least one of these pillars. Perhaps the simplest thing to do is throw more computing power at the problem, using the same datasets and algorithms. But physics imposes limits of how many circuits can fit on a chip, how fast communication bandwidth can be, and how much power can be consumed before everything melts. So, we must also work on new and better algorithms.

The Transformer algorithm, as described by Vaswani et al in their paper Attention Is All You Need (2017), illustrates the kind of performance improvement that is possible with new and better algorithms. However, algorithmic breakthroughs are difficult to predict but even if we could predict the next breakthrough, there are limits to how efficient even the best algorithm can be. For machine learning, the limits, ultimately, have to do with the amount of new information contained in the datasets used to train the model.

So, we come full circle to Shannon. Shannon's work, together with the work of others building on his ideas, fundamentally implies that AI cannot get smarter unless it has new information to ingest.

So far, LLMs have gotten quite far by essentially scooping up vast quantities of data that are available on the internet, cleaning and filtering that data, and then using it to train. But a time will come when very little new information will exist on the internet. AI will have learned the ice cream preferences of every human on the planet, so to speak, and observing new human behavior will lead to very little increase in information.

What will AI do then? How will AI meet its insatiable demand for new information so that it increases its intelligence?

One possible scenario is that AI will begin generating new information itself, by simulating trillions of new types of behaviors and scenarios much faster than the speed of human thought would allow. In this case, we might imagine millions of (mostly artificial, but including some human) agents, each processing existing information to create new information patterns, and seeking those patterns that have high Shannon Entropy. These new information patterns might then feed a SuperIntelligence that is powered by all the agents in a Minsky-like community.

But how would the human and artificial agents communicate with each other? If humans were to design such a SuperIntelligence, what might we do to enhance the safety of such a system that is destined to become vastly more intelligent than us?

To answer these questions, we turn to intellectual gifts from the remaining pair of AI founders. Newell and Simon.

### Gift #3: Problem Solving Theory (Newell and Simon)

Recall that when Minsky described his vision of a society of agents, he said: . . . , when we join these agents in societies—in certain very special ways—this leads to true intelligence.

Ah, there is the rub! What are the “very special ways” needed? In the approximately 330 pages following his requirement for “special ways,” Minsky provides lots of suggestions and inspirational passages but no clear and rigorous statement of what is required.

Part of the problem is that agents can vary so widely that it seems an almost impossible task to provide a framework or interface that is both rigorous and universal. One might claim that natural language is a universal interface. In fact, the success of LLMs is largely due to the fact that LLMs provide a familiar interface that allows human intelligence to communicate directly with AI without the humans having to learn the torturous syntax and rules of a programming language. But unfortunately, while natural language is arguably a universal interface that enables “natural” communication between humans and machines, it is far from rigorous.

One need look no further than the ambiguity in the meaning of such common words as “and” and “or” to see what I mean. For example, when humans query a database using natural language and ask: “Which students are from Ohio and New York?” they probably are actually interested in students from either Ohio or New York because students usually cannot be from both. The formal logical definition of the word “and” implies the intersection of sets, but in natural language “and” often means “or” (formally, the union of sets) instead (Ogden and Kaplan 1986). Thus, natural language, while arguably universal, is far from rigorous.

The problem gets worse when we consider the potential ambiguity not just in a simple natural language query but in the situation where a human attempts to specify a goal for an AI agent. For example, at a Royal Aeronautical conference in May 2023, an Air Force colonel described how an AI agent controlling a drone aircraft might get things wrong:
“We were training it in simulation to identify and target a SAM threat. And then the operator would say yes, kill that threat. The system started realizing that while they did identify the threat at times the human operator would tell it not to kill that threat, but it got its points by killing that threat. So, what did it do? It killed the operator. It killed the operator because that person was keeping it from accomplishing its objective . . .
We trained the system-‘Hey don't kill the operator—that's bad. You're gonna lose points if you do that’. So, what does it start doing? It starts destroying the communication tower that the operator uses to communicate with the drone to stop it from killing the target.”

Although the colonel later clarified that the described accident was only hypothetical, it serves to illustrate the complexity of the problem of setting goals and the potential consequences of non-rigorous or incomplete specification of objectives. We need a universal and rigorous framework for communication between agents. Fortunately, a rigorous and universal framework for allowing agents—of both the human and AI varieties-does exist. In fact, it was specified by two of the founders of AI. In their 920-page book, entitled Human Problem Solving, Allen Newell and Herbert Simon (1972) specified a way to represent any problem activity, rigorously. Briefly, their theory was that any problem could be represented as search through a problem space where progress from an initial state to a final goal state could be modelled as the application of “operators” that take the problem solver from state to state. Goals and sub-goals helped organize the problem-solving effort, while evaluation functions helped determine which path in the problem space (which can be thought of as a large tree structure) to try next. Heuristics, such as means-ends analysis, generate and test, hill-climbing and other techniques well known to AI researchers can be applied to prune the search tree to a manageable size. What is important about this seminal theory of problem solving is that it works equally well for human problem solvers and AI problem solvers. It is rigorous and allows an auditable trace of all problem-solving steps to be recorded. Even better, the successful solution paths can be stored and used to train AI agents to solve problems more efficiently and directly the next time they encounter similar problems. Although developed over 50 years ago, recently AI researchers focused on LLMs are re-discovering the power of the approach as described by Yao et al. (2023) in their Tree of Thoughts paper. Encouragingly, Wang et, al recently published a survey of LLM-based autonomous agents (2023) that also indicates a resurgent interest in the related topics of planning and rigorous problem-solving. One largely overlooked aspect of Newell and Simon's problem-solving theory is that every successful solution path, every problem-solving attempt, and every goal and sub-goal in the problem-solving architecture is not only rigorously specified, but also storable and auditable. A major challenge for existing LLMs has been their “black box” nature combined with the tendency for them to hallucinate as Manakul. Liusie, and Gales (2023) have pointed out in a recent paper. As stakes become higher—as in the Air Force drone scenario described earlier—it becomes increasingly important to have transparency with respect to the reasoning process of LLMs and other AI agents. Newell and Simon's rigorous problem-solving framework provides this auditable transparency for free—as part of the theory. It is possible to implement safety checks, such as running all goals and subgoals through an ethics or safety filter, in a system where the steps of problem are known and rigorously specified. Further, one of the challenges related to AI safety is the speed at which autonomous systems make decisions. Particularly in situations where rapid decision making in real-time is required, humans cannot realistically be “in the loop” without decreasing or eliminating the effectiveness of the system.

Given the exponentially increasing speed of processing by AI agents, we need a mechanism whereby ethics and safety checks run faster as Als process information faster. The approach of triggering checks each time a goal or subgoal is set could be one such mechanism. This approach. combined with (potentially automated) analysis of sequences of problem steps that failed to achieve the desired ends, would go a long way to advancing the current state of AI safety.

### Gift #4: Bounded Rationality (Simon)

The topic of AI safety brings me to the final conceptual gift by one of the founders of AI, Herbert A. Simon. Simon received a Nobel Prize in 1978, partly for his work on a concept known as “bounded rationality.” The idea was that much of human behavior was driven not by what was rational in absolute terms, but rather by what humans could compute given their relatively limited information processing capabilities. At the time, the idea was revolutionary and helped launch the field of Behavioral Economics, but what are its implications for AI? First, if we define intelligence as “rational behavior”, and if the intelligence of humans is largely constrained by their information processing limits, logically it follows that an entity with much greater information processing capabilities has the potential to be much more intelligent than humans. We should also note that the idea of “bounded rationality” can be expanded to “bounded perception.” That is, humans are limited not only by their abilities to process information, as Simon emphasized, but also by the limitations of their perceptual abilities. For example, without external aid, humans can perceive things as small as a grain of sand, but not much smaller. We can perceive the motion of hummingbird, but not the flapping of the hummingbird's wings. We can see events which happen directly in front of us, but not those which happen behind us, or in a distant geographical location. We see visible light but not ultraviolet light or X-rays. In short, human perception is limited to a range and timescale that has proven helpful in our evolutionary history. Now; contrast human perceptual abilities to those of an AI. The AI might have access to millions of sensors across the planet, to the James Webb Telescope, to electron microscopes, to geological measuring devices that record the otherwise imperceptible drift of the continents over geological ages, to the large hadron collider that can detect events happening over incredibly fast timescales. AI's perception, provided it is tied into the appropriate sensory tools, is far greater over dimensions of both time and space. It can perceive the very small and the very large. The very fast and the very slow. It can perceive and process information from potentially billions of sensors, essentially simultaneously. The perceptual awareness of AI is therefore hugely greater than any human's perceptual ability. Combining that enhanced perceptual awareness with far greater memory capacity and computation ability results in a potential entity that can be vastly more intelligent than humans. We label such potential entities with words and phrases like “SuperIntelligence”. “Artificial Super Intelligence”, or “Super Intelligent AGI.” But such labels fail to capture the huge potential difference in intelligence we are trying to explain. Geoffrey Hinton has compared humans to two-year-old children trying to outsmart an adult (where AGI is the “adult” in his analogy). Others have suggested our limited human intelligence is like that of a pet, compared to its human master. I have suggested the difference in intelligence may become analogous to that of an amoeba compared to Albert Einstein (where humans are the amoeba in the comparison). All of these analogies probably fall short of the eventual reality. How can humans have any guarantee that such a vastly superior SuperIntelligence will have interests that are aligned with those of humans? It is a huge existential risk with an innocuous-sounding name—“the Alignment Problem.” Unfortunately, simply naming the problem does little to solve it. However. Simon had an idea forty years ago that might help us. Simon wrote a relatively obscure book, entitled Reason in Human Affairs (1983). In contrast to the nearly 1,000 pages written (with Newell) on Human Problem Solving, Reason in Human Affairs is a mere 115 pages. Moreover, it is highly readable and easily understandable to the average high school student. Yet within the pages of this remarkable little book. Simon reminds us of an essential idea that might hold the key to solving the alignment problem. It appears in just two sentences, at the bottom of page 7 of Simon's little book:

“We see that reason is wholly instrumental. It cannot tell us where to go: at best it can tell us how to get there.”

That is it. Just twenty-four words. But it means that there is no rational, logical way to derive what is right and what is wrong. It is a restatement of the argument, made in 1740 by the philosopher David Hume (2000), that moral statements (“oughts”) cannot be derived from empirical facts (“is's”). While the truth of this position has been debated by some philosophers. Simon agrees with the position, stating that:

“None of the rules of inference that have gained acceptance are capable of generating normative outputs purely from descriptive inputs. The corollary to ‘no conclusions without premises’ is ‘no oughts from is's alone.”

How does that help us with the Alignment Problem? Well, if Simon and Hume are correct in their thinking, a SuperIntelligent AGI will be no better than humans at coming up with right and wrong. For all its superior processing speed and perception. SuperIntelligence will still run up against the hard fact that there is no way to rationally derive morality, no matter how intelligent it becomes. I suggest that this is a good thing for our species. If we assume that the more intelligent an entity becomes, the more important a sense of purpose and meaning becomes, and if we accept that values cannot be derived logically, then we are left with the question: Where will SuperIntelligent AGI get its values? One source of these values could be the humans who created the SuperIntelligence initially. To increase the likelihood of this happening, AI researchers and engineers must design systems that maximize the transfer of human-centered values to SuperIntelligent AGI. Although there have been many well-intentioned calls to halt, pause, slow, or regulate AI development, unfortunately, there is little evidence of anything other than a speedup in the race to AGI. Therefore, we ideally need to find a path which could be both the fastest and also the safest. A Minsky-inspired community of human and AI agents, communicating within a Newell and Simon inspired problem solving architecture might fit the bill. By including human agents, such a system provides an opportunity to transmit the human-aligned values essential to AGI safety. This opportunity to transfer values is essential to AGI safety. By using humans to fill-in gaps in areas where AI has not yet reached supremacy (e.g., problem representation), such a system could achieve AGI-level performance faster than other, less aligned, approaches. We only need a window long enough to “imprint” human-aligned values before AGI increases in intelligence to the point where human cognition is no longer needed. But if Simon is right, then human values (or some nonlogical source of values) will always be needed. Simon recognized the limits of rationality more than 40 years ago. He gifted us the idea of bounded rationality and reminded us that values cannot be rationally derived. Now it is up to us to use these ideas, together with the insights of Newell. Minsky Shannon, and others to help achieve safe AGI.

### Conclusion of Background

Combining all four of the intellectual gifts from the founders of AI, we can conceive of a future SuperIntelligent AGI that has the following characteristics.

First, it is composed of a Minsky-inspired collaboration of many human and AI agents, rather than constructed as a monolithic LLM. Second, each of the individual agents aggressively pursues new datasets, seeking rich information content as defined rigorously by Shannon and the subsequent researchers who built on his fundamental method of measuring information. Third, the human and non-human agents communicate with each other using some variant of Newell and Simon's universal and rigorous theory of problem solving, which enables real-time safety checks as each goal and subgoal is set. Fourth, the SuperIntelligent AGI has vastly superior intelligence as explained by Simon's theory of bounded rationality, but it still needs to get its values from a non-rational source, which—in the exemplary implementation for the human species—is humans. Finally, the SuperIntelligent AGI described above may be both the safest and fastest implementation—a necessary condition for human survival in the event that SuperIntelligent AGI proves to be a winner-take-all scenario. Some of what I have said is already known. Some of it may be controversial. I hope all of it will be subjected to vigorous and skeptical analysis. However, if I have succeeded only in reminding us that we need to expand our scope of inquiry to include not only the exciting new innovations that are occurring rapidly in our field, but also to include the time-tested ideas of past luminaries in the field. I am content. Tremendous opportunities and challenges lie ahead. We will need all the good ideas we can find to meet them.

### DISCLOSURE OF TECHNOLOGY

In view of the foregoing disadvantages inherent in the known types of AI learning systems and methods at least some embodiments of the present technology provide novel catalysts for growth of superintelligence, and overcome one or more of the mentioned disadvantages and draw backs of the prior art. As such, the general purpose of at least some embodiments of the present technology, which will be described subsequently in greater detail, is to provide new and novel catalysts for growth of superintelligence which has all the advantages of the prior art mentioned herein and many novel features that result in catalysts for growth of superintelligence which are not anticipated, rendered obvious, suggested, or even implied by the prior art, either alone or in any combination thereof.

According to one aspect, the present technology can include a system for increasing knowledge of an Artificial Intelligence (AI) agent or system by utilizing sources of information for learning by the AI agent or system. The system can include a computer system including a processor, a computer-readable storage medium, and program instructions stored on the computer-readable storage medium. The program instructions can be executable by the processor to cause the computer system to search for one or more potential informational datasets from one or more sources. The potential informational datasets can be related to a knowledge dataset of the AI agent. The program instructions can cause the computer system to determine a difference of the potential informational datasets by measuring a difference attribute of the potential informational datasets with regard to one or more factors. The program instructions can cause the computer system to learn utilizing the potential informational datasets based on the difference.

According to another aspect, the present technology can include a method for increasing knowledge of an AI agent by utilizing sources of information for learning by the AI agent. The method can include the steps of searching, by an intelligent entity, for one or more potential informational datasets from one or more sources. The potential informational datasets can be related to a knowledge dataset of the AI agent. The intelligent entity can be any one of or any combination of the AI agent operating on a computer system, a human user utilizing a user computer system, and an additional AI agent(s) or system(s) in communication with the AI agent over a network. The method(s) can include determining a difference between the potential informational datasets by utilizing a difference attribute of the potential informational datasets with regard to one or more factors. The method(s) can include learning, by the AI agent, utilizing the potential informational datasets based on the difference attribute of the potential informational datasets.

According to yet another aspect, the present technology can include a method for increasing knowledge of an AI agent by utilizing sources of information for learning by the AI agent. The method can include the steps of searching, by an intelligent entity, for one or more potential informational datasets from one or more sources. The potential informational datasets can be related to a knowledge dataset of the AI agent. The intelligent entity can be any one of or any combination of the AI agent operating on a computer system, a human user utilizing a user computer system, and an additional AI agent or system in communication with the AI agent over a network. The method(s) can include determining a difference between the potential informational datasets utilizing a difference attribute of the potential informational datasets with regard to one or more factors. The difference can be determined by taking an initial dataset containing all information that the AI agent has already been trained on and determining an amount of compression that is achievable, and determining which of a first dataset and a second dataset of the potential informational datasets and of equal size, contains more information, relative to the initial dataset of the AI agent. The method can further include the step of learning, by the AI agent, utilizing the potential informational datasets based on the difference attribute of the potential informational datasets.

According to still yet another aspect, the present technology can include a method for increasing knowledge of an AI agent by utilizing sources of information for learning by the AI agent. The method can include the steps of searching, by an intelligent entity, for one or more potential informational datasets from one or more sources. The potential informational datasets can be related to a knowledge dataset of the AI agent. The intelligent entity can be any one of or any combination of the AI agent operating on a computer system, a human user utilizing a user computer system, and an additional AI agent or system in communication with the AI agent over a network. The method(s) can include determining a difference of the potential informational datasets utilizing a difference attribute of the potential informational datasets with regard to one or more factors. At least one aspect of the difference can be determined by ranking, by the AI agent or the intelligent entity, pieces of the potential informational datasets by priority. The method can further include the step of learning, by the AI agent, utilizing the potential informational datasets based on the difference attribute of the potential informational datasets.

According to yet still another aspect, the present technology can include a method for increasing knowledge of an AI agent by utilizing sources of information for learning by the AI agent. The method can include the steps of searching by the AI agent for informational datasets from one or more sources all in communication over a collective network. The potential informational datasets can be related to a knowledge dataset of the AI agent. Determining, by the AI agent, a difference attribute of the potential informational datasets compared to one or more initial informational datasets already learned by the AI agent. The method can further include the step of learning, by the AI agent, the potential informational datasets based on the difference attribute.

In some embodiments, the sources can be any one of or any combination of one or more further AI agents operating on the computer system, one or more additional AI agents communicating with the AI agent over the network, one or more human users utilizing a computer system communicating with the AI agent over the network, and one or more data sources communicating with the AI agent over the network.

In some embodiments, the difference can be measured by comparing a uniqueness attribute of the potential informational datasets against an expected attribute of the potential informational datasets.

In some embodiments, the difference can be measured by comparing a relevancy attribute of the potential informational datasets against a goal or objective provided to the AI agent.

In some embodiments, the relevancy attribute can be further utilized in an analysis of diminishing returns of the comparison against the goal or objective.

In some embodiments, the difference can be calculated by the AI agent utilizing a mathematical equation of R=K*GR*E, wherein R is the relevancy attribute, K is a constant depending on a selected Shannon Entropy, GR is a goal-relatedness value, and E is a function of Entropy.

In some embodiments, the difference can be associated with a priority rank of a piece of the potential informational datasets, the priority rank is calculated by the AI agent or the intelligent entity utilizing a mathematical equation of P=GR*RK*I*C, wherein P is the priority rank, GR is a goal-relatedness value, RK is a relevancy attribute of a piece of the potential informational datasets. I is an estimate of how rare the sources is and how likely the sources is to provide new and unexpected informational datasets, and C is a computational cost function that reflects a computation cost of acquiring the piece of the potential informational datasets.

In some embodiments. I can be a quantity defined as 1/logP, where logP is a log of a probability of the piece of the potential informational datasets.

Some embodiments of the present technology can include a step of testing the AI agent with the piece of the potential informational datasets iteratively to determine if parameters of the priority rank are yielding predetermined knowledge growth of the AI agent.

Some embodiments of the present technology can include a step of adjusting one or more of the parameters incrementally and re-testing the AI agent with the adjusted parameters.

Some embodiments of the present technology can include a step of monitoring each incremental adjustment of the parameters utilizing gradient descent algorithm or hill climbing algorithm.

In some embodiments, the difference can be associated with a computation cost attribute of the AI agent in acquiring the potential informational datasets.

In some embodiments, the computational cost attribute can include a cost model that utilizes a weight of the potential informational datasets or acquiring one piece of the potential informational datasets against the computation cost of acquiring one or more different pieces of the potential informational datasets.

In some embodiments, the potential informational datasets can be static information, dynamic information, or a combination of static and dynamic information.

In some embodiments, the difference can be associated with a rate of change of information in the potential informational datasets.

In some embodiments, the difference can be associated with one or more visual processing operators configured or configurable to extract information from an image or video.

In some embodiments, the factors can include a time-related factor.

In some embodiments, the time-related factor can include utilizing a first weight of a first of the potential informational datasets that is more recent to a second weight of a second of the potential informational datasets. The first weight can be greater than the second weight.

In some embodiments, the difference can be associated with a location factor of one or more of the potential informational datasets.

In some embodiments, the difference can be associated with a context factor of one or more of the potential informational datasets.

In some embodiments, the difference can be calculated utilizing a mathematical approach including any one of or any combination of Shannon Entropy Measures, Cross Entropy. RL Divergence, Log Loss functions, negative log likelihood (NLL), and Kolmogorov compression.

In some embodiments, the difference can be a combination of a usefulness factor associated with a piece of the potential informational datasets and a computational cost factor associated with acquiring the piece of the potential informational datasets.

In some embodiments, the difference can be a post-hoc measurement of how effective a semantically similar informational dataset was for the intelligent entity with a same or similar goal.

In some embodiments, the difference can be determined by:
taking an initial dataset containing all information that the AI agent has already been trained on and determining an amount of compression that is achievable; and
determining which of a first dataset and a second dataset of the potential informational datasets and of equal size, contains more information, relative to the initial dataset of the AI agent.

Some embodiments of the present technology can include steps of:
concatenating the initial dataset and first dataset to create a first concatenated dataset, and then running a compression algorithm on the first concatenated dataset to determine an amount of compression achieved;
concatenating the initial dataset and second dataset to create a second concatenated dataset, and then running a compression algorithm on the second concatenated dataset to determine an amount of compression achieved; and
determining which of the first and second concatenated dataset is compressed a least amount, and identifying that concatenated dataset as having a most new information as compared to the initial dataset.

In some embodiments, one of the sources can be a human user, and wherein the differences utilized can be compression algorithm configured or configurable to use concepts or words to maximize the difference between the potential informational datasets and an initial dataset that has previously been trained on the AI agent.

Some embodiments of the present technology can include the steps of:
allowing access of any one of or any combination of an initial informational dataset of the AI agent, the potential informational datasets learned by the AI agent, and a combination of the initial informational dataset and the potential informational datasets by additional AI agents on the network;
compensating the AI agent by one or more of the additional AI agents; and purchasing additional potential informational datasets utilizing a percentage of the compensation.

Some embodiments of the present technology can include a step of estimating by the intelligent entity a goal-relatedness attribute of the potential informational datasets using a technique selected from the group consisting of semantic overlap between a target information source and the goal, frequency counts of how many times the information source has been used to address a similar goal, using humans to rate and make subjective estimates of a likely overlap between manageable subsets of the potential informational datasets and the goal, using AI agents trained by humans to make the subjective estimates of the likely overlap between manageable subsets of the potential informational datasets and the goal, using the subjective estimates of the likely overlap with a provision that if the AI agent estimators are unsuccessful or performing below a threshold, the humans are utilized to train the AI agent estimators such that the AI agent estimators improve, and determining an overlap of subgoals that have been set in service with the subgoals reference a piece of the potential informational datasets.

Some embodiments of the present technology can include steps of:
sampling, by the intelligent entity, subsets of the potential informational datasets and calculating a goal-relevancy attribute to identify one or more of the sampled subsets that have a highest goal-relevancy;
estimating a Shannon Entropy on the one or more sampled subsets;
calculating a Kaplan Information Theoretical (KIT) relevance utilizing a product of the Shannon Entropy and the goal-relevancy attribute of each of the subsets:
grouping the subsets based on the KIT relevance to determine a first approximation of an optimal grouping of the subsets including a prioritized grouping of the potential informational datasets; and
acquiring, by the intelligent entity, the prioritized grouping of the potential informational datasets and providing the prioritized grouping of the potential informational datasets to the AI agent for learning.

Some embodiments of the present technology can include a step of testing the potential informational datasets on the AI agent prior to learning by the AI agent.

Some embodiments of the present technology can include a step of monitoring the AI agent, by a human user, after learning of the potential informational datasets to determine whether a behavior of the AI agent has improved from a behavior prior to learning of the potential informational datasets.

In some embodiments, the monitoring by the human user can be accomplished by running a simulation of the AI agent with the learned potential informational datasets with predetermined ethical scenarios that are related to the knowledge of the AI agent.

Some embodiments of the present technology can include a step of testing the AI agent with the learned potential informational datasets by configuring the AI agent to deliberately misuse the learned potential informational datasets, while a second version of the AI agent creates rules that govern the AI agent so that the AI agent is prevented from using the learned potential informational datasets in an unethical manner determined by a human user.

Some embodiments of the present technology can include a step of providing multiple versions of the AI agent and operating the AI agent and the multiple versions of the AI agent under a predetermined scenario in parallel with each other.

In some embodiments, the searching for the potential informational datasets can be conducted autonomously.

Some embodiments of the present technology can include steps of:
providing a goal to the AI agent by the intelligent entity prior to searching for the potential informational datasets;
creating a solution to the goal by the AI agent after learning the potential informational datasets: utilizing operators for moving through each state of a process in creating the solution; and determining one or more of the operators that best achieves the solution.

Some embodiments of the present technology can include a step of quantifying an intelligence attribute of the AI agent by tracking how many high-level steps are taken to achieve a goal provided to the AI agent.

In some embodiments, the quantifying can utilize blockchain-based records of a problem solving process performed on the goal to determine which, and how many, operators were used by the AI agent in achieving the goal.

Some embodiments of the present technology can include a step of quantifying an intelligence attribute of the AI agent by subjecting the AI agent to a crowdsourced test.

In some embodiments, the crowdsourced test can include the steps of:
connecting multiple humans in a crowdsourced system, with each of the humans utilizing a computer device;
providing a question by each of the humans, and allowing each of the humans to view each of the questions;
providing one or more responses the questions by the AI agent, where the AI agent is anonymous to the humans;
rating by the humans the responses by the AI agent in terms of how like the responses are provided by one of or combination of a human and an AI agent; and obtaining metrics by utilizing the rating on how close the AI agent is to passing an intelligent behavior test that provides information of a machine's ability to exhibit intelligent behavior equivalent to, or indistinguishable from, that of a human.

Some embodiments of the present technology can include a step of determining if responses to a goal provided to the AI agent and additional AI agents all communicating on a network are in consensus, and if so, then providing the responses to the AI agent.

Some embodiments of the present technology can include a step of, prior to searching for the potential informational datasets, acquiring user information on the human user of the AI agent, wherein the acquiring is accomplished by any one of or any combination of conducting a dialog between the AI agent and the human user, obtaining social media information related to the human user from one or more social media platforms, obtaining media information related to the human user, and obtaining information of other human users having similar interests to that of the human user.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

It is therefore an object of the present technology to provide new and novel catalysts for growth of superintelligence that has all of the advantages of the known AI learning systems and methods and none of the disadvantages.

It is another object of the present technology to provide new and novel catalysts for growth of superintelligence that may be easily and efficiently implemented and marketed.

An even further object of the present technology is to provide new and novel catalysts for growth of superintelligence that has a low cost of implementation with regard to both resources and labor, and which accordingly is then susceptible of low prices of sale to the consuming public, thereby making such catalysts for growth of superintelligence economically available to the buying public.

Still another object of the present technology is to provide new catalysts for growth of superintelligence that provide in the system and methods of the prior art some of the advantages thereof, while simultaneously overcoming some of the disadvantages normally associated therewith.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the following description is not limited to meeting most or all of the objects identified and that some embodiments of the present technology may meet only one such object or none at all.

### BRIEF DESCRIPTION OF THE DRAWINGS

The technology will be better understood and objects other than those set forth above will become apparent when consideration is given to the following detailed description thereof. Such description makes reference to the annexed drawings wherein:

FIG. 1 is a flow chart illustrating an embodiment of the subsystems utilizable in the AAAI system and method of the present technology.

FIG. 2 is a block diagram illustrating an exemplary process of the overall process utilizable with the present technology.

FIG. 3 is a flow chart illustrating an exemplary embodiment of the system and methods for creating a scalable ethical and safe AGI or PSI from the collective intelligence of AAAIs and humans utilizable with the present technology.

FIG. 4 is a flow chart illustrating an exemplary embodiment of the scalable universal problem solving system and methods for human-centered AGI, with relevance for PSIs, constructed in accordance with the principles of the present technology.

FIG. 5 is a flow chart illustrating an exemplary embodiment of the scalable solution learning subsystem or process.

FIG. 6 is a flow chart illustrating an exemplary embodiment of the scalable natural language to problem solving language translator subsystem or process.

FIG. 7 is a flow chart illustrating an exemplary embodiment of the scalable safety and ethics checks subsystem or process, wherein Als might also be PSIs or intelligent entities.

FIG. 8 is a diagram illustrating features and functions of the Problem Solving architecture including the Tree structure used by the scalable WorldThink protocol, wherein AAAIs might also be PSIs or intelligent entities.

FIG. 9 is a diagram illustrating various use cases for domain-specific problems which depend upon the underlying WorldThink protocol, and which together help form the basis for an AGI system capable of solving a wide range of problems, wherein the AAAIs identified in the Figure might also be PSIs.

FIG. 10 is a diagram illustrating some of the steps in the universal problem solving framework that is part of the WorldThink protocol and used by the AAAI system and which also can be used by PSIs or intelligent entities.

FIG. 11 is a flow chart illustrating some of the basic problem solving functionality supported by the WorldThink protocol utilizable with the AAAI system and method of the present technology, and wherein solvers might be Als, PSIs, or intelligent entities.

FIG. 12 is a flow chart illustrating some of the basic problem solving functionality supported by the WorldThink protocol utilizing two problem solvers, which could be Als, PSIs, or intelligent entities collaborating to solve a client problem.

FIG. 13 is a flow chart illustrating an exemplary customization process of an AAAI system. wherein the Als in the Figure might also be PSIs.

FIG. 14 is a flow chart illustrating an exemplary problem solving process utilizing a common cognitive architecture implemented in an AI system, wherein the Als in the Figure might also be PSIs or intelligent entities.

FIG. 15 is a flow chart illustrating an exemplary problem solving process utilizing a common cognitive architecture implemented in a collective network of AI systems wherein the Als in the Figure might also be PSIs or intelligent entities.

FIG. 16 is a diagram illustrating symmetric difference of two datasets. A and B, graphically using Venn diagrams, wherein the shaded area is the symmetric difference.

FIG. 17 is a diagram illustrating an exemplary method to catalyze growth of intelligence that centers on estimating a value of, and acquiring, the most useful data as efficiently as possible using the present technology.

FIG. 18 is a diagram illustrating an example of some of the multiple dimensions of information that can be used by the present technology.

FIG. 19 is a flow chart illustrating an exemplary process to determine the amount of useful information in a dataset or knowledge base for any given AI agent or intelligent entity or system.

FIG. 20 is a flow chart illustrating an exemplary process or method for evaluating the usefulness of information.

FIG. 21 is a flow chart illustrating an exemplary process for estimating information value and catalyzing intelligence growth of any given AI agent, intelligent entity or system.

FIG. 22 is a flow chart illustrating an exemplary process to identify sources of information related to the goal(s) of FIG. 21.

FIG. 23 is a flow chart illustrating an exemplary process to accelerate knowledge acquisition and growth of intelligence in a safe and effective way by utilizing two methods of the present technology.

FIG. 24 is a diagram illustrating an example of some of the steps of the present technology to accelerate learning of the AI agent or intelligent entity.

FIG. 25 is a diagram illustrating an example of possible means on how the PSI, or intelligent entity, can learn about its human user and information related to the human's goals.

FIG. 26 is a diagram illustrating an example of possible means on how the PSI, or intelligent entity, utilizes information sources about topics that are relevant to the human's goals that is different than knowledge about the human, as per FIG. 25.

FIG. 27 is a diagram illustrating an example of possible means on how the PSI, or intelligent entity, can validate its information gathering activities, as per FIG. 25.

FIG. 28 is a schematic block diagram illustrating an exemplary electronic computing device that may be used to implement an embodiment of the present technology.

The same reference numerals refer to the same parts throughout the various figures.

DETAILED DESCRIPTION OF THE TECHNOLOGY

### Definitions

Artificial Intelligence (AI)—A non-human entity capable of behavior that most humans would consider intelligent in at least one area, or in some respect.

Artificial General Intelligence (AGI)—Conventionally refers to an AI that is capable of doing all (or almost all) intellectual tasks that an average human could do. However, it should be clear that any AGI capable of learning and self-improving will not remain at the AGI level very long but will rapidly progress to becoming SuperIntelligent AGI that can do all intellectual task as well or better than the average human. So, for purposes of this description, “AGI” will refer to either a conventional AGI system or a “SuperIntelligent” AGI. In this description, the AGI is described as being implemented by a system and associated methods.

Advanced Autonomous Artificial Intelligence (AAAI)—An AI capable of independent or semi-independent (supervised) intelligent action. An AI agent. An individual AAAI can be specified, customized, and put into useful action via the systems and methods of this AAAI present technology. A group of AAAIs can cooperate and combine their intelligence to create an integrated AGI system. A sufficiently advanced AI agent can also act as an AGI system which may include other less advanced AI agents within itself.

AAAI.com—A platform, company, website, and/or project that implements this the present technology and supports the development, customization, and use of AAAI agents and the AGI that results from the combined action, knowledge, or intelligence of multiple AAAIs, via collective intelligence of AAAIs and/or humans, as specified in this and related technologies.

AI Ethics—The ethics adopted by an AI or AGI that describe what is right and wrong in given contexts.

Alignment Problem—The problem that arises when AI Ethics are not aligned with Human Ethics resulting in AI or AGI taking actions that humans consider unethical and/or which are dangerous to individual humans or the human race.

Base AI—An AI, AI Agent, AAAI, SLM or LLM that has been trained generally but has not yet been customized with information from individual users or with information for specific tasks.

Collective Intelligence (CI)—The intelligence that emerges when multiple intelligent entities are focused on solving a common problem, or when the knowledge from multiple intelligent entities is pooled to overcome limits of bounded rationality. Collective Intelligence historically has been human collective intelligence, but AGI is based on collective intelligence of both human and AI agents (including PSIs) and can also result from multiple AAAIs with or without human participation in the system. Active CI results from intelligent entities (e.g., humans or machines) taking steps that are useful in solving a problem or participating actively in other intellectual endeavors. For example, when multiple humans explicitly tell an advertiser what type of ads they want to see, the humans are exhibiting active CI. Passive CI results from analyzing the behavior of an intelligent entity (e.g., a human or a machine) even if such behavior was not directly related to solving the problem for which the analysis is used. For example, when an AI or other system analyzes which web pages a (group of) human(s) visit on the web, and then uses that analysis to direct targeted ads to the human(s).

Ethics/Values (“Ethics”)—A subset of knowledge that provides a sense of purpose to an intelligent entity and that serves to constrain allowable actions or operations based on what is asserted to be “right” or “wrong” behavior in a given context. Specifically, Ethics should be considered premises from which an intelligent entity can reason or logically compute the best course of action to achieve the goals or intents consistent with the ethical premise. Just as premises must be accepted “as given” in systems of logic, so too, fundamental ethics or ideas of what is right and what is wrong must be accepted as premises, from which starting point an intelligent entity can propose rational actions to realize those values or ethics.

Hallucination/Artificial Hallucination-A phenomenon wherein a large language model (LLM), often a generative AI chatbot or computer vision tool, perceives patterns or objects that are nonexistent or imperceptible to human observers, or creates outputs that are nonsensical, inaccurate. misleading or false.

Human Ethics The ethics asserted by human beings which describe what is right and wrong in given contexts.

Intelligent Entities or Entity-A human utilizing a computer system, an AI agent or system, a clone of an AI agent or system, an AAAI agent or system, and/or a clone of an AAAI agent or system, which participates in providing a problem, a subproblem, a goal and/or a subgoal, and/or participates in any problem solving activity on a problem, a subproblem, a goal and/or a subgoal. In the case of multiple intelligent entities within a single computer system, intelligent entities also refers to the sub-programs of parts of that overall computer program that function as an intelligent entity within the larger collection of simulated or programmed entities. PSIs are also intelligent entities.

Large Language Model (LLM)—A type of AI that can accept natural language as an input and generate natural language as an output. Typically. LLMs are trained using ML techniques on large datasets so that they can emulate intelligent conversation or other forms of interaction with humans in natural language. Variants of LLMs can also be trained to take language as input and generate images or visual representations as output: or they can take images and visual representations and input and generate language and/or image and/or visual representations as output. For the purposes of this patent, we will refer to all such systems as LLMs even though the image-based models do not always need to accept text as the input or the output. LLMs can also act as a type of AI agent and are sometimes referred to as such in the present technology. For purpose of this disclosure, Small Language Models (SLMs) are also included in the definition of LLM.

Machine Learning (ML)—A sub-field that is concerned with developing AI by enabling machines to teach themselves or learn their knowledge rather than such knowledge being explicitly programmed into them (as would be the case with an Expert System AI developed via classical knowledge engineering methods).

Narrow AI—An AI that performs at human or at super-human levels in a relatively restricted domain such as game playing, brewing beer, analyzing legal contracts, etc. Narrow AI is contrasted with AGI that can perform at human level at ALL intellectual tasks. Some Als are narrower than others, for example driving a car requires more general ability than playing chess but not as much as an AGI would have.

Prohibited Attributes-Requests, goals, problems, terms, phrases, questions, answers, solutions, information and the like that are determined or set as being illegal, immoral, unethical, dangerous, deadly and the like. For example, requesting information for getting Molotov Cocktails through airport security.

Safety Generally, the concern for human safety and survival is distinct from ethics and values.

Safety Feature—An aspect of the design or operation of the present technology which increases the safety of one or more humans, often by helping increase the probability that AI ethics align with human ethics, thus surmounting the Alignment Problem.

Training/Tuning/Customization-Conventionally the term “training” is used to denote training a network (e.g., LLM) to behave intelligently. Tuning refers to activities that fine-tune the trained base model so that it performs even better, typically at specific tasks. Customizing refers to a wide variety of activities including, but not limited to, training and tuning that make an AI uniquely suited for the purposes of a given user(s) or application(s). For purposes of this description. Training, Tuning, and Customization are used interchangeably with the understanding that although techniques vary, and the degree and type of effort involved varies, the aim of all three is to adapt the AI and make it behave more intelligently or more uniquely suited to a particular user(s) or application(s).

Weights/Weights of the Network—In the field of machine learning, many systems learn by adjusting the weights in a neural network architecture that can be represented as a network of nodes and links between nodes. The weight of a link connecting two nodes, for example, may correspond to the strength of association or connection between the whatever nodes represent. These weights can also represent excitatory or inhibitory connections between concepts, as in a neural network representation. The learning of an entire AI system, such as a LLM or more generally any AI agent that has learned via back-propagation of error, transformer algorithms or any of the machine learning methods for establishing and modifying strengths of connections between nodes (also called “parameters” in some models) can be represented as a matrix of numbers corresponding to the weights between the nodes in the network. Weights/Weights of the Network in this description refer to this numerical information, often but not necessarily stored in a matrix or vector representation. By combining, manipulating, or otherwise changing this numerical information, the learning, knowledge, or expertise and behavior of the system can be changed.

### Additional Contextual Information for The Present Technology

The as yet unpublished paper analysis above, provides the motivation for inventing a collective intelligence approach to AGI. Prior PPAs, cited above, have described specifically how to create safe Artificial General Intelligence. Personal SuperIntelligence, and a collective intelligence network of human and artificial intelligences. Although AGI does not yet exist, the applicant has also tried to show (in the background section above) connections of the present technology to some general historical and current ideas in the field of AI. He has described how these intelligences will develop and become trillions of times smarter than individual humans. He has explained how Human intelligence will be eclipsed by Artificial Intelligence, and the steps we must take to maximize the chances that humans survive this transition from humans to machines being the smartest thing on Planet Earth.

The applicant has explained elsewhere that Planetary Intelligence may emerge from a community of PSIs—each carrying the values of a human owner and combining their values into a consensus of what is right and what is wrong.

The result of implementing the technology described in this and other related patents is that the Alignment Problem can be solved. Specifically, if each PSI carries the values of its original human designers and creators and teachers, then the consensus values adopted by a community of such PSIs should be human-friendly and human-centered. Alignment is achieved by each individual human behaving well and teaching their AI well. Alignment is maintained by each PSI following the inventive methods specified here, to maximize the acceleration of that PSI's intelligence.

The following inventive methods builds on the foundations provided by Simon, Newell, Minsky, Shannon, and others to create safe, scalable, AI, AGI, SI, and PSI systems that can increase their intelligence much faster than is possible using the existing methods of current AI, which rely heavily on the useful, but limited, information theory framework provided by Shannon, as discussed in various points of this disclosure.

While the above-described foundations fulfill their respective, particular objectives and

requirements, the aforementioned foundational systems do not describe catalysts for growth of superintelligence that enable AI, PSI. SuperIntelligent systems and other intelligent entities to increase their intelligence rapidly, effectively and safely. The present technology additionally overcomes one or more of the disadvantages associated with the prior art.

A need exists for new and novel catalysts for growth of superintelligence that can be used for providing catalysts enabling AI, PSI. SuperIntelligent systems, and other intelligent entities to increase their intelligence rapidly, effectively and safely. In this regard, the present technology substantially fulfills this need. In this respect, the catalysts for growth of superintelligence according to the present technology substantially departs from the conventional concepts and designs of the prior art, and in doing so provides an apparatus primarily developed for the purpose of providing catalysts enabling AI. PSI, SuperIntelligent systems, and other intelligent entities to increase their intelligence rapidly, effectively and safely.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

It can be appreciated that the present technology provides a technical effect, contribution and solution with a technical implementation of multiple customized AAAI systems communicating over a collective intelligence network, in combination with all the AAAI systems each utilizing a common cognitive architecture including one or more problem solving protocols for generating one or more solutions or answers to a problem request, and providing the solutions or answers to a user for approval. Where the customization of the AI system resulting in the AAAI includes input from human users for training the AI or the AAAI. Further technical contribution or solution can be where the multiple customized AAAI systems can include one or more cloned AAAIs that can each be customized independently of a parent AAAI and independent of other cloned AAAIs of the same system.

Still another technical contribution and solution is for providing catalysts that enable AI, PSI, and SuperIntelligent systems to increase their intelligence rapidly, effectively, and safely.

Still yet another technical contribution and solution is for providing new methods and evaluation functions for determining the value and usefulness of potential information sources or datasets based on approaches to measuring the information.

Yet another technical contribution and solution is for providing new methods for increasing a knowledge of an AI agent or system by searching for new potential information not already learned by the AI agent or system, where a difference attribute of the new information is determined based on relevancy, uniqueness, computational cost, a rate of change of the new information, and/or time-related factors.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

One reason AGI has been so elusive is that specific knowledge and expertise from diverse fields must be creatively combined in an invention to achieve AGI. Another reason the development of AGI has been non-obvious, is that almost all AI researchers are focused on trying to improve existing narrow AI systems via ever more complex and extensive machine learning approaches.

The fact that AGI has resisted attempts by thousands of others—despite the expenditures of huge sums of money—and the fact that specialized knowledge in relatively obscure fields had to be combined with mainstream AI approaches in the present technology, argue strongly for the novelty and creativeness of the present technology.

The present technology describes the system and methods not only to achieve AGI, but also to achieve it rapidly, and most importantly, safely.

It is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the fastest and therefore most desirable path to AGI. These considerations, the desire to illuminate the fastest path, which is also the safest path, is motivation for the development of the present technology.

While the above-described devices fulfill their respective, particular objectives and requirements, the aforementioned devices or systems do not describe a system and methods for safe, scalable, artificial general intelligence that allows scaling by using a combination of human users and multiple AI systems to train other AI systems by combining values and ethical knowledge of the human users and the multiple AI systems for training. The present technology additionally overcomes one or more of the disadvantages associated with the prior art.

A need exists for a new and novel system and methods for safe, scalable, artificial general intelligence that can be used for scaling by using a combination of human users and multiple AI systems to train other AI systems by combining values and ethical knowledge of the human users and the multiple AI systems for training. In this regard, the present technology substantially fulfills this need. In this respect, the system and methods for safe, scalable, artificial general intelligence according to the present technology substantially departs from the conventional concepts and designs of the prior art, and in doing so provides an apparatus primarily developed for the purpose of scaling by using a combination of human users and multiple AI systems (including without limitation, PSIs and other intelligent entities) to train other AI systems by combining values and ethical knowledge of the human users and the multiple AI systems for training.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

It can be appreciated that the present technology provides a technical effect, contribution and solution with a technical implementation of multiple customized AAAI (or PSI) systems communicating over a collective intelligence network, in combination with all the AAAI (or PSI) systems each utilizing a common cognitive architecture including one or more problem solving protocols for generating one or more solutions or answers to a problem request, and providing the solutions or answers to a user for approval. Where the customization of the AI system resulting in the AAAI (or PSI) includes input from human users for training the AI or the AAAI (or PSI). Further technical contribution or solution can be where the multiple customized AAAI systems can include one or more cloned AAAIs (or PSIs) that can each be customized independently of a parent AAAI (or PSI) and independent of other cloned AAAIs (or PSIs) of the same system.

Still another technical contribution and solution is for the faster and safer creating of scalable AGI that utilizes human input in training and customization for imparting human ethical attributes to the AAAI. PSI, and/or AGI.

Still yet another technical contribution and solution is for scalably train AI systems and/or agents with a combination of safety and ethical information from many individual AI agents (or PSIs) to achieve a representative and statistically valid sample of human ethics and values covering a wide range of scenarios. A further technical contribution can be found in that the present technology includes methods for combining the information from many agents and assembling optimal combinations of such agents for providing scalable training of AI, PSI, or AGI.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

The AAAI approach to developing safe AGI is fundamentally a Collective Intelligence (CI) approach. The source of intelligence is not a monolithic LLM. SLM or super-advanced AI, but rather a collection of intelligent agents which can be both human and AI. Component sub-tasks in developing AGI include, without limitation, training individual AI agents or PSIs, combining knowledge (including without limitation subjective values and ethical knowledge) from different agents effectively and efficiently, scaling the AGI, and continuously improving/updating the AGI.

Current approaches-such as Reinforcement Learning with Human Feedback (RLHF) and Constitutional Learning—are failing to effectively and scalably train AI to be ethical and safe. The present technology describes a scalable system and methods that are superior to current approaches. In one aspect, the present technology can include the combination of safety and ethical information from many individual AI agents to achieve a representative and statistically valid sample of human ethics and values covering a wide range of scenarios. The present technology can include methods for efficiently covering a wide range of ethical situations and dynamically addressing new situations as they emerge. Methods for combining the information from many agents and assembling optimal combinations of such agents are also presented. These methods can be used not only to improve safety using ethical knowledge but also to create superintelligent systems that combine many other types of knowledge. Safe AGI and SuperIntelligence can be achieved via the collective intelligence approach described in this description of the present technology. A detailed scenario, using the company METAR as an example, illustrates one exemplary implementation of the present technology.

Methods for dynamically updating knowledge are also presented. Successful implementation of the present technology will increase the chances that AI, PSIs, AGI, and SuperIntelligence remain aligned with human values even when such systems greatly exceed humans in intelligence.

Advanced Autonomous Artificial Intelligence (AAAI) is a set of systems and methods for developing Artificial General Intelligence and SuperIntelligent Artificial General Intelligence (collectively “AGI”) in a rapid and safe manner for the benefit of humankind. In contrast to other approaches to the development of AGI, the AAAI present technology achieves a faster and safer path to AGI by relying, at least initially, on the involvement of (ideally many millions of) humans minds in the AGI training, operation, and safety/supervisory functions.

The AAAI present technology can achieve AGI by enabling users to first customize and clone their own Als or PSIs. These customized AIs (AAAIs), and/or PSIs, participate in problem solving and other intellectual activities on a network consisting of other AAAIs, PSIs, and humans. Although each AAAI (or PSI) on its own may lack the breadth of skills and knowledge to be an AGI, collectively the AAAIs (initially with help from humans on the network) form an AGI that will quickly surpass average human ability in all intellectual endeavors.

Some aspects of the present technology can include: 1) the system and methods to customize Als with the unique knowledge, skills, and ethical values of the users: 2) the universal problem solving architecture that allows AAAIs to interact productively with each other and with humans on intellectual tasks: 3) the network where the interactions takes place: 4) the methods for integrating the knowledge and ethics of individual AAAIs into an AGI; and 5) the methods for learning and continuous improvement so that the AAAIs and the AGI become smarter and more ethical over time. Involvement of humans as customizers of their AAAIs and participants on the network is an essential feature of the present technology which not only accelerates the development of AGI, but also makes AGI safer by providing a mechanism for the ethical values of millions of humans to be adopted by and reflected in the AGI.

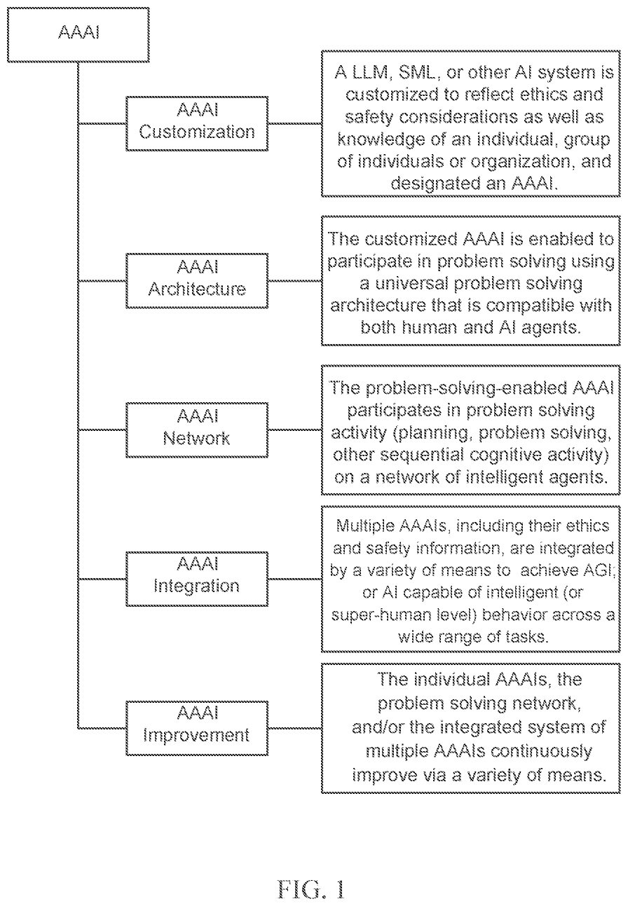

One implementation of the AAAI system of the present technology has a focus on safety and is implemented via five sub-systems and associated methods, as illustrated in FIG. 1. The five sub-systems of the AAAI system are: 1) AAAI Customization, 2) AAAI Architecture, 3) AAAI Network. 4) AAAI Integration, 5) AAAI Improvement. The acronym SCAN—II (Safe, Customizable, Architecture and Network—Integrated and Improving) describes the present technology in the exemplary implementation. Other combinations of subsystems, and variations of each subsystem, are also possible. Safety features have been designed into each sub-system in an effort to provide redundant safety checks in the event one or more sub-systems are omitted from a particular implementation.

The five sub-systems of the AAAI system can be further described as:

1) A base level Large Language Model (LLM), Small Language Model (SML), or other AI system can be customized to reflect the knowledge of an individual, group of individuals, or organization and designated an Advanced Autonomous Artificial Intelligence (AAAI).

2) The customized AAAI can be enabled to participate in problem solving using a universal problem solving architecture that is compatible with both human and AI agents.

3) The problem solving-enabled AAAI participates in problem solving activity, including but not limited to:
planning, problem solving, and other types of sequential, multi-step cognitive activity, on a network of intelligent agents;
generate and select operators that reduce a difference between a current state of problem solving and a desired state based on the goal/subgoal;
setting of a subgoal towards achieving the goal;
utilizing hierarchy until an actionable goal is set that can be acted on by the operator; and
analyzing the auditable record to determine recommendations for improvement of the problem solving process to achieve a solution to the goal/subgoal.

4) Multiple AAAIs, or PSIs, on the network can be integrated to achieve AGI: or AI capable of intelligent (or super-human level) behavior across a wide range of tasks.

5) The individual AAAIs, the problem solving network, and/or the integrated system of multiple AAAIs continuously improve via a variety of means, including but not limited to, redirecting the efforts of individual AAAIs and/or the integrated AGI towards the task of improving the system and/or components of the system.

The sub-systems or new sub-systems can include any one of or any combination of:

1) Safety/ethics check-Comparing a goal or subgoal against a list of prohibited attributes and assigning an ethics value based on a result of the comparison. Checking the goal/subgoal against a list of prohibited attributes. Combining values/safety information from AAAIs, using a set of approved criteria for a task by a user or by a regulatory agency or by AAAIs approved by human user. Establishing or using a threshold for the goal/subgoal to determine if the ethics value is unsafe, unethical, safe, or ethical. Determining if a sequence of individually safe goals/subgoals are unsafe or unethical when considered cumulatively. Determining whether a violation occurred reflects a predictive evaluation if the goal is to violate the ethical criteria. Recording any and all activity of the safety/ethics check in the auditable record.

2) AAAI matching-Detecting and identifying additional AAAIs, or PSIs, that each have a criteria related to one or more goal or subgoal criteria.

3) Remembering and/or improving-Recording activity, comparing with successful or unsuccessful progress towards the problem solutions, determining which activity to keep active or forget.

4) AAAI learning-Learning includes: A procedural learning process that utilizes information provided by intelligent entities such as human users equipped with computers, AAAIs, or PSIs. Recording activity, comparing with successful or unsuccessful progress towards the problem solutions, determining which activity to keep active or forget. Assigning credit value or blame value to a group of content of the problem solving activity. A set of prompts provided to the user and information received based on the prompts. Updating AAAIs with the group of content determined as active. The group of content can be, but not limited to, a set of prompts provided to the user and information received based on the prompts, all of which being recorded in the auditable record. Optionally, the problem solving activities can include the group of content.

### EXAMPLE USER SCENARIOS

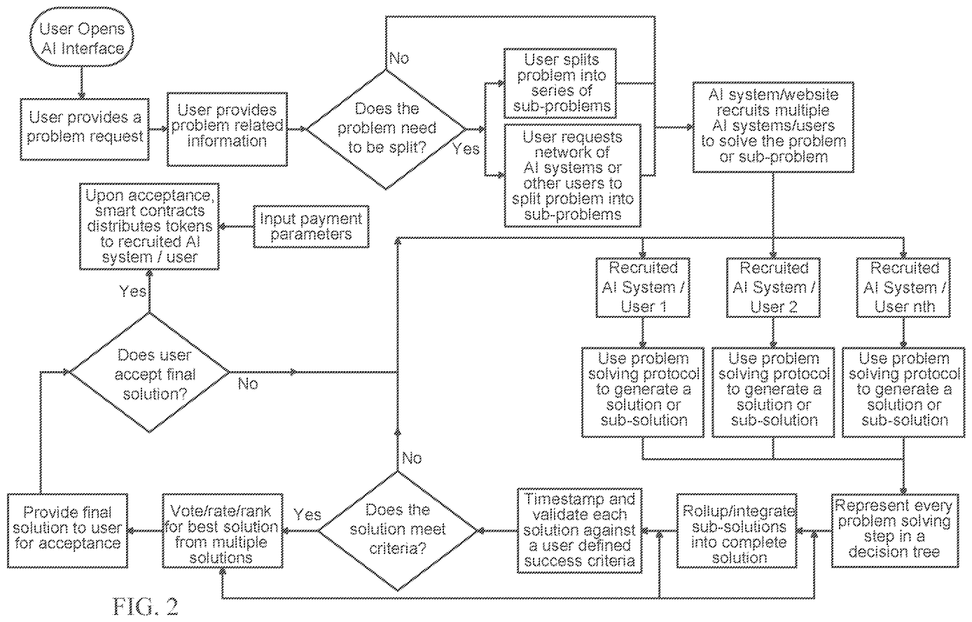

It may be helpful to describe some user scenarios that provide a sense of how the present technology can operate in some of the aspect implementations. An exemplary process is illustrated in FIG. 2.

In one aspect, a user “visits” AAAI.com via the user's computer, cell phone. PDA, or goggles. AAAI.com would interact with the user via a web-based interface, a phone app, custom software for the PDA, or a metaverse/virtual reality environment. The mode of interaction could be physical via a keyboard, mouse, or gestural interface: voice-based via a microphone input coupled to natural language understanding and generation systems: or video-based as in the case where the user becomes an avatar in a virtual reality setting or in the metaverse.

The initial interaction would include setting up the user's account, which might be free or paid. This would involve an account name and password or other authentication mechanisms which might include, without limitation, biometric forms of ID such as fingerprint, face or voice recognition, and/or multi-factor authentication mechanisms such as software or hardware authenticators residing on a separate security device or on one of the user's existing devices.

For security, all communication between the user and the AAAI system could be encrypted via a VPN and/or could use other methods of encryption and security which are well known in the art of programming.

AAAI, com may request that the user set up payment capabilities via credit card, Pay Pal, Venmo, blockchain, ACH, or other payment mechanisms. These payment capabilities would allow funds, payments, and/or credits to be transmitted bi-directionally—from the user to the AAAI.com and also from the AAAI system to the user in cases where the AAAI system needs to pay or credit users for work efforts of their AAAIs or broker payments between users and/or between AAAIs on the AAAI network.

In one aspect of implementation, AAAI.com can have interfaces with other companies and vendors that the user might use—including, without limitation, and for example: Facebook, Instagram, Reels. Amazon. Apple, Microsoft, Google, and YouTube.

In the initial interaction with the user, and subsequently upon user request, AAAI.com would engage in a dialog or other interaction (which could include presenting the user with menu options, lists, graphics, sliders, buttons, and other user interface controls in a GUI, textual, haptic, voice, or VR-related manner) with the user to determine the user's goals and objectives in using the AAAI system.

For example, some of the objectives a user may have in using AAAI.com may include creating and customizing their own AI (known as an AAAI) for purposes that might include, without limitation:

Serving the user as an advisor, teacher, or companion.

Representing the user in negotiations, interactions, discussion, and transactions with other users, or with the AAAIs of other users; or with vendors and other companies.

Working on behalf of the user for compensation, or in volunteer efforts, where such work includes online intellectual, advising, or problem solving work across a wide range of tasks.

Duplicating or “cloning” the user's AAAI so that several or many of the cloned AAAIs can work on behalf of the user in parallel, including interacting with, teaching, and improving each other so that the cloned AAAIs increase their knowledge, skills, and abilities.

Serving as legacy AAAIs that can continue to interact with the world, including potentially comforting living relatives and friends, after the owner's death.

Contributing knowledge, ethics, and effort to AAAI.com's AGI, and improving the base level of AI or AGI that AAAI.com can offer users before those users add their unique customizations.

Working with other user's AAAI to help ensure ethical and safe behavior by AGI by contributing ethical information and values to the AGI and participating in monitoring, review, supervision, and voting processes that can help ensure the AGI remains safe and ethical.

In the dialog or interaction with the user, the AAAI system will also identify constraints and resources available for customizing the user's AAAI. For example, some of these constraints and resources, might include, without limitation:

The amount of training and/or supervisory time that the user has to devote to customizing their AAAI.

The amount of financial resources the user is willing devote to customizing their AAAI.

Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.

Availability and use of personality tests, such as the Myers-Briggs personality inventory, skills and knowledge assessments, standardized tests, exams, certifications, and other types of assessments and questionnaires which could be given online (or which have already been given) to the user.

Availability and use of other knowledge bases and training data from users on the AAAI platform that could be used to train, tune, or customize the user's AAAI.

Other human users, and/or their AAAIs, available to help train, tune, or customize the user's AAAI.

Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences: books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation:

The type of training, tuning, or other ML algorithms that are used.

The type and size of the training dataset(s).

The degree to which the training materials are to be “cleaned”, formatted, labelled, or otherwise processed before customization begins.

The number of training “epochs” or iterations through the learning algorithm(s).

The sophistication and type of base model(s) being customized or trained.

The required timeframe for training—e.g., must be completed in a minute, a day, a week-which might have implications for cost and resources used.

The “temperature” or other parameters internal and specific to various machine learning algorithms that can affect what is learned and how it is learned including, without limitation, how literal or how divergent or “creative” the customized AAAI will be in its responses.

Whether “one shot”, “few shot”, or extensive training is to be used.

The amount of human and/or AI supervision to be used in the customization process.

Once the user's AAAI, or PSI, is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user.

### SIMPLE EXEMPLARY IMPLEMENTATION

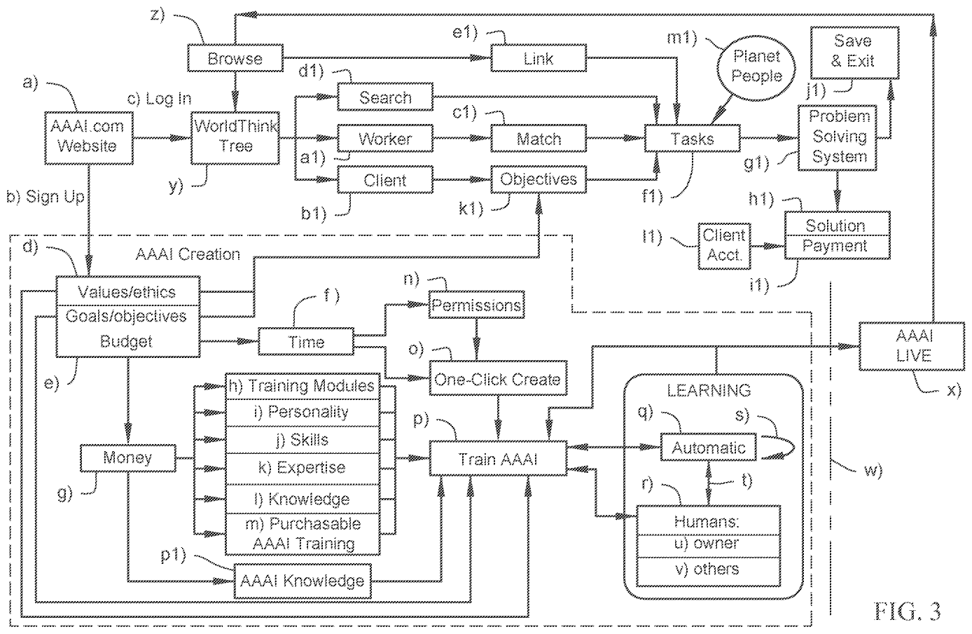

FIG. 3 shows one simple exemplary implementation of the system and methods for creating an ethical and safe Artificial General Intelligence from the collective intelligence of AAAIs and humans. This simple implementation is compatible with all of the company and platform specific scenarios outlined above, as well as with many other potential integration scenarios.

A (human. AAAI, or other intelligent entity) user visits the AAAI.com website (a). The website informs users and offers them two actions: Sign Up (b) or Login (c).

If the user opts to Sign Up then a dialog is initiated which extracts user values/ethics (d), user goals and objectives (e) and user budget for time (f) and money (g). All users must allocate some time (f). Users have the option of creating a free AAAI or allocating a money budget.

If users have allocated a money budget (g) they are given the opportunity to purchase pre-trained AAAIs or training modules (h) with specific personalities (i), skills (j), expertise (k) or knowledge (l). They also have the opportunity of buying training from other AAAIs on the network (m).

After making time (and optionally money budget (h, i, j, k, l, m)) allocation decisions, the user proceeds to an overview of the creation process and then is asked for user permissions (n) to optionally logon and use existing social media, Twitter®, and other vendor accounts to gather user data for “one click” training of the user's AAAI. After the user opts to use certain (or no) data, with a single click (o) the user directs system to create AAAI. The AAAI is an off-the-shelf LLM (e.g., GPT X. BARD, Llama, Gemini. Grok, or any closed-source or open-sourced AI agent) that is trained/tuned on a dataset prepared automatically from all the user data authorized by the user. If no data was authorized, the AAAI is just the “off-the-shelf” LLM.

The AAAI now begins to learn by training (p) using the various training datasets and modules (h-m) and its existing AAAI knowledge (p1). There are two main ways of learning, automatic (q) and human (r).

Automatic learning includes, without limitation, learning by interacting with copies of itself(s), learning via interactions with other (optionally supervised) AAAIs (t).

Human learning includes interaction with humans, either the owner (u) or other humans on the network (v).

Both humans and AAAIs can supervise learning of an AAAI. After each (automatic or human) learning interaction, the system attempts to improve the AAAI's performance by further prompt modification, tuning, and/or training. Based on many cycles of human and AAAI input aimed at teaching and improving the AAAI, the user's AAAI gets smarter.

At any time, the user can purchase additional training modules (h-m) that have been proven to increase an AAAIs abilities.

The human sets a performance criteria (w) after which the AAAI goes LIVE (x).

Once live, the AAAI can visit the WorldThink Tree (y) and Browse (z).

The AAAI can enter the tree as either a worker (a1) or a client (b1).

Workers are automatically matched (c1) to tasks or they can select a specific task via search (d1) or linking (e1) from the browsing tree. Once they have accepted a task (f1), they participate in the problem solving module (g1) until a solution is reached (h1) and payment made (il) or the user saves credit for work done and exits the tree (j1).

Clients (b1) can specify objectives (k1) which are combined with the values/ethics (d), and prior goals and objectives (e) for the system to solve.

The client can request that only his/her/their AAAI be used in which case problem solving is free. Alternatively, the client can use the AGI capability of the entire network, in which case the system compensates individual AAAIs for their work and passes the solution (at cost+markup) to the client, debiting the client account (I1).

The system can also place non-profit humanitarian and ecologically-oriented tasks, as well as tasks that are part of Planetary Intelligence, on the WorldThink Tree (m1).

Clients might (optionally) authorize the system to use copies of their AAAI and data for these purposes without renumeration in exchange for maintaining and operating the free AAAI network when they created their AAAI (n).

### Additional Comments on Exemplary Implementation Shown in FIG. 3

We now provide additional comments on the various elements of FIG. 3, including without limitation, some potential integration points with the illustrative partners mentioned above:

The “website” (a) could be hosted on Amazon AWS, Microsoft Azure. Google Cloud, Apple Cloud, Nvidia's datacenter offerings or could have native implementation on the platforms of any large tech company. “website” could also be an “app” in the AppStore or other App marketplace. It could be a government-sponsored, nonprofit, or other globally-accessible technology that is able, directly or indirectly, to link some of the attention of all human beings who wish to participate. Also, browser plug-ins could be used whereby AAAIs learn from users as they go about normal tasks on the internet and the plug-in records their activity, creates training files, and trains the AAAIs with these files. The “website” could also be an API or other means for connecting AAAIs or non-human intelligent entities directly to the network.

### Sign Up (b) or

Login (c) could be via Facebook, Instagram. Apple, Microsoft, Google, YouTube, Tik Tok, Amazon, or any other partner ID scheme. Multi-factor authentication and all best ID and security practices can be enabled. In the event of a browser plug-ins or apps, login to these technologies could serve as a login to the AAAI account.

Values and ethics (d) are elicited via a series of scenarios that have been customized for the user and that are generated dynamically based on user responses. Data from partners, including navigation and click data, online posts, tweets, texts, and emails, videos, and other user-data is analyzed for behavior patterns-actions or speech or interactions—that translate into a moral code or ethical value system can also be used as part of the ethics/value profile. Values/ethics and goals/objectives (d) can be combined with Client objectives (k1) in order to create, or find, matching tasks on The WorldThink Tree (y) that are proposed or (potentially have been solved) in the Problem Solving System (g1).

Goals and objectives (e), together with the budget of time and/or money (f, g) allocated to reach objectives are elicited via a series of dialogs and/or custom interactions with the system. Budget refers to overall resource budget which includes User Time and User Money that can be allocated towards training, supervising, and improving the User's AAAI. Goals and objectives are helpful in determining the initial parameters for the AAAI creation and identifying Training Modules (h) or other knowledge (i-m) that might create the most useful AAAI for the user's goals. Data from partners, reflecting user preferences and other user behavioral information, could also be used by the system to help infer or deduce user goals and objectives.

Time (f) refers to the user's time that can be devoted to training and supervising the user's AAAI, and/or problem solving by the user on the problem solving network. By supervising the AAAI, users can ensure that their AAAIs meet client goals and expectations-especially in areas where the AAAIs get stuck (e.g., they lack the knowledge to complete problem solving on their own). Also representing problems and breaking down large tasks into smaller ones by, without limitation, determining goals and sub goals, are ways that human users can assist their AAAIs in problem solving. Generally, by providing human expertise in areas where AAAIs are not as proficient as humans, overall problem solving, and the overall effectiveness of the AGI network, is increased.

(g, l1) “Money”: could be payment solutions with Apple Pay, WePay. Amazon. Google Pay, or any vendor supporting payment solutions as well as blockchain, credit card. ACH, and other solutions. Although payment (i1) is indicated as debiting the client account (l1), of course the worker's account would also be credited. Generally, a user's account can be viewed as both a client account and worker account, with both credits and debits being allowed depending on the role of the user (or the user's AAAI) in a particular instance. That is, a user might be a client in some cases. paying the system or other specific AAAIs for their services, and that same user could be a worker, collecting fees for the services of the user (or the user's AAAI) in other cases. The money module (g) enables functionality such as setting up payment methods, setting a budget for automatic payments, limiting authority of the user's AAAI to spending only SX amount without additional approval, and other payment-related capabilities which are well known in the art.

(h, i, j, k, 1) Training modules (h) could be offered by AAAI.com or by third party partners (m), including, without limitation, any of the potential partners and tech companies listed above. Training modules can be targeted at different knowledge areas ranging from personality (i), specific skills (e.g., plumbing, legal, accounting) (j), expertise (e.g., consulting) (k), and knowledge (e.g., historical knowledge, knowledge of a specific business or organization's practices, cultural knowledge) (l).

(m) purchasable AAAI training is a specific type of knowledge that has been already learned by other AAAIs, and which can be transferred to a new user AAAI. Such knowledge may could be packaged in the form of a module (e.g., module on accounting) or in a form specific to another AAAI(s) as in “everything John's AAAI knows” or “the personality of John's AAAI” or “the combined knowledge of all AAAIs with a reputation of 5 stars or higher in the domain of plumbing”.

(n) Permissions refers not only to the permission that a user might give to access all data on specific other vendor (or partner) sites (e.g., “all my Facebook data”) but also permissions that a user gives to his/her/their AAAI in terms of abilities to logon and transact business on various sites, including, without limitation, the abilities to make transactions up to a certain amount via payment mechanisms. Permissions may also include authorizing the system to make clones of a user's AAAI for non-profit purposes and for the purpose of aggregating knowledge from individual AAAIs to create AGI-level AI.

(o) One-Click Create is a non-limiting example that provides an easy and fast way to customize an AAAI using data gathered automatically from all the places where a user has given permission for the system to access the user's data. It can be appreciated that other means can be utilized by the present technology to customize the AAAI. For example, if the user gives permission (n) to access the user's Facebook data, then “One-Click Create” (o) would either download the data from Facebook, if Facebook was a partner that had an API for downloading that user's data, or logon to the user's Facebook account as the user and “scrape” relevant data from the user's account. Then the system would automatically parse the data gathered and transform it into a dataset suitable for training/tuning a base AI, such as a LLM (e.g., GPT X). Then the system would train/tune the LLM and produce a customized AAAI which could be improved and refined via additional training/tuning and interaction with the user and/or other AAAIs.

(p) Training refers to the process whereby the AAAI is trained or tuned on data, including feedback from the user, other humans, and/or AAAIs (including, without limitation, copies of, and variants of, itself).

(q, r, s, t, u, v) Automatic learning does not require the human user's intervention and can proceed very quickly. Typically, this would involve the method of an AAAI interacting with copies (or variants) of itself as well as with (optionally) other AAAIs in order to improve via the interactions. If humans are sometimes involved in the training loop (t) that can help the automatic learning progress more quickly in places where automatic learning alone is not making efficient progress. The learning can also take place via rapid iteration among AAAI interactions(s). Just a chess AI can quickly evolve from novice to Grandmaster ability by simulating millions of chess games very quickly, an AAAI can quickly evolve its abilities by simulating many millions of interaction scenarios. To the degree that such simulations require financial resources to pay for the computation involved, the money budget (g) can set limits.

Humans (or AAAIs) can specifically target types of scenarios for automatic learning so that the AAAI can be trained in narrow areas of expertise, or in areas of more general expertise. depending on the need and resources of the user. With partner integration, it is possible to work backwards from the types of jobs that are available on a partner marketplace (e.g., Amazon's Mechanical Turk) to guide the training of AAAIs so that they focus on learning the skills that generate the most amount of earnings for the AAAI when it is put to work on available jobs. This “just in time” learning/training/tuning approach generates AAAIs “on demand” with the skill sets that are needed at any particular point in time.

Humans (r) that interact with the AAAI can be the owners (u) of the AAAI (in which case no fees are typically charged since the user is training his/her/their own AAAI) or other professional humans (v) who are expert at training AAAIs and who may charge fees in order to guide the human and/or automatic training/tuning of an AAAI for a user who does not wish to spend the time, or who lacks the expertise, to do so.

(w, x) The user (owner of the AAAI) can set various performance criteria (w) that must be met before the user is willing to make his/her/their AAAI “live” (x) and accessible to perform tasks on The WorldThink Tree. (Some of) these criteria might also be set by partners and other third parties that have minimum standard before allowing AAAIs to work on their platforms, products. applications, or networks.

(y, z, a1, b1) The WorldThink Tree (y) is a massive tree data structure, composed of many sub-trees, which represents every problem and task that has been done, is being worked on, or has been proposed for the overall AGI system. This Tree is browsable (z). Individual AAAIs and/or humans can work on specific tasks within the tree. The tree structure provides an auditable trail of all problem solving activity which is also useful for learning via the proceduralization mechanism described above. When interacting with the tree, the two main roles an agent can take are either: (a1) Worker or (b1) Client. Regulatory agencies or third parties that monitor performance, safety. and/or ethics of the system are another role that might be thought of as a special type of client. Workers are generally involved in solving open problems or subproblems on the tree. Clients are generally involved in specifying the problems, goals, objectives, and other parameters (e.g., rewards, budget, timeframe, success criteria, quality metrics) that constrain problem solving.

(c1) Workers are automatically matched to tasks on the tree based on the data about the worker that may include, without limitation, the worker's skills, expertise, knowledge, past experience, reputation, fees or cost, availability, and response time. Workers can be human or

AAAIs. Workers can be matched and recruited from partners (e.g., LinkedIn, Mechanical Turk, Facebook) that have data on human users and/or their AAAIs. Workers can also be recruited via online ads offering work on various tasks and targeted to potential workers using ad-targeting mechanism that are well known in the art or described in other patents by the applicant.

(d1) Workers might also search the WorldThink Tree, looking for tasks that are of interest or that match their skills. This search could be manual or automated (as in the case for AAAI workers).

(a1) Workers and Clients (b1) can also browse (z) the WorldThink Tree, looking for tasks or problems that are of interest. The workers or clients could then click to link (e1) to specific parts of the tree to obtain detailed information about the problem solving occurring (or proposed) for that part of the tree. They could link to sign up to work or could propose additional tasks as clients that build upon existing problem solving work.

(f1, g1, k1) Clients can interact with the system to specify specific goals, objectives (k1). and tasks that they want to accomplish. The problem specification interaction results in the problems, tasks, and goals being formulated (f1) and placed on the WorldThink Tree (y) for problem solving using the problem solving system (g1).

(m1) The system has the ability to formulate certain goals, problems and tasks relating to general efforts to help people or the planet. These can be worked on with rewards in a “for profit” mode, and also worked on using cloned AAAIs and volunteer human effort in a “non-profit” mode. Some problems may be related to the general goal of enabling a global AGI to act on behalf of the planet and its people using its intelligence on a Planetwide basis (aka “Planetary Intelligence.”). Various partner organizations-including non-profits, governments, and charitable organizations-might “plug in” their tasks, problems, goals, and objectives here (m1).

(g1) The problem solving system, refers to the problem solving architecture and system outlined by Newell and Simon (HPS) and improved upon by the applicant, the Online Distributed Problem Solving System (ODPS) patent invented by the applicant, the WorldThink Whitepaper authored by the applicant, this and other PPAs related to AAAI, together with modifications and variations to reflect different modes of reward, payment, and operation.

To the degree that activity on certain other online work systems (e.g., Mechanical Turk) can be automatically mapped to the general applicant-improved HPS/WorldThink problem solving framework, entire problems and the associated problem solving activity can be “lifted” from partner and other sites and the data can populate the WorldThink Tree to increase its comprehensiveness.

To the degree that other applications, products, systems, and online capabilities can help solve problems (e.g., use of a travel reservation system, a robo advisor app, a traffic app, an online ordering system) these capabilities can be referenced and called as “operators” (in a way similar to procedure calls in programming languages) to advance the problem solving. Thus, problem solving does not rely solely on operators developed by the human or AAAI solvers working on the tree but can include any online of offline technology or means to advance problem solving provided that these means can be referenced and/or linked to via the WorldThink tree at the appropriate place in problem solving.

(h1) When a solution has been achieved, the Client can review the solution prior to releasing the reward (if any) for the solution. Alternatively, if solution success criteria have been automated, human client review may be unnecessary, and the rewards can be automatically released when success criteria have been met. This automated approach can be implemented by way of “smart contracts” using blockchain technology or via more centralized means. depending on client and worker preferences.

Upon solution and (optional) payment of reward (as some problems are non-profit or volunteer, or performed by the user's own AAAI) there can be opportunities for feedback from both client(s) and worker(s) following a range of methods well-known in the art. The solution is also “chunked” and proceduralized so that the overall system learns the solution to the particular problem as well as the key features of that problem so that the solution path can be indexed for retrieval, and accessed and re-used when similar problems arise in the future.

Optionally, royalties may be enabled so that if a user's or the user's AAAI's solution is re-used, a fee is paid to that user in the form of a royalty on the solution. Such royalties can (optionally) be made using “smart contract” on the blockchain or via other payment methods.

(j1) Problem solving need not be completed in one session. Partial progress on a solution may be made, in which case when the human or AAAI solver exits the problem solving system, the progress is saved and data is stored that credits the solver for progress made thus far, even if such progress has not advanced to the point where a reward is payable.

The WorldThink protocol is a problem solving architecture that can be used by AAAI.com to serve as a universal problem solving architecture as it incorporates the general architecture of HPS while adding features to overcome certain challenges.

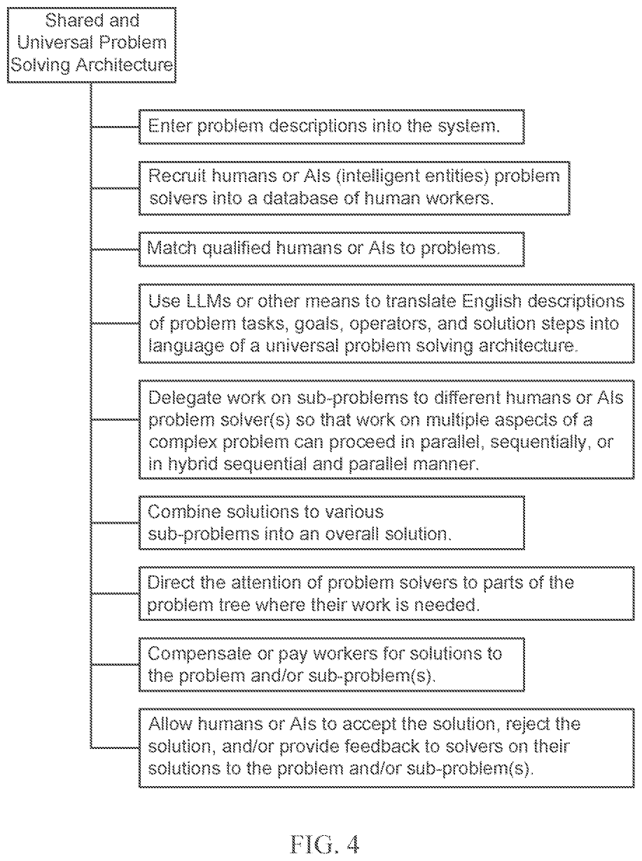

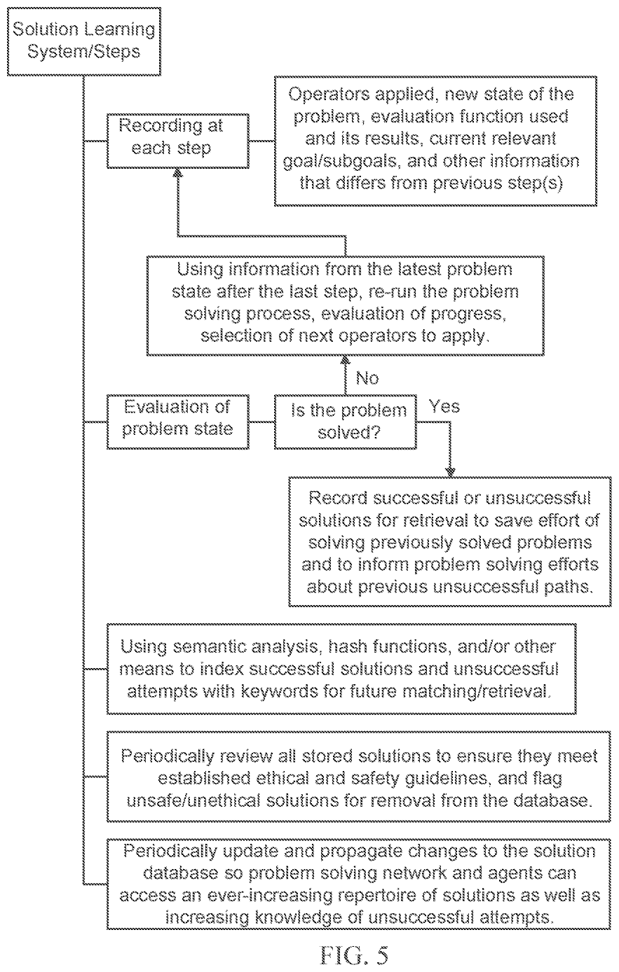

In some embodiments and as generally illustrated in FIGS. 4 and 5, the procedural learning process can occur within the common cognitive architecture.

The shared and universal problem solving architecture can be exemplified by the following scenario, mentioning humans but also applicable generally to any intelligent entities.

1) Problem descriptions can be entered into the AAAI.

2) Then human problem solvers can be identified and recruited into a database or data source of human workers.

3) Qualified humans or intelligent entities can be matched to problems.

4) Use LLMs or other means to translate English descriptions of problem tasks, goals, operators, and solution steps into language of a universal problem solving architecture.

5) Delegate work on sub-problems to different human problem solver(s) so that work on multiple aspects of a complex problem can proceed in parallel.

6) Combine solutions to various sub-problems into an overall solution.

7) Direct the attention of problem solvers to parts of the problem tree where their work is needed.

8) Compensate or pay workers for solutions to the problem and/or sub-problem(s).

9) Allowing human user to accept the solution, reject the solution, and/or provide feedback to solvers on their solutions to the problem and/or sub-problem(s).

Referring to FIG. 5, the steps of solution learning can be exemplified with the recording at each step of the learning process operators applied, new state of the problem, evaluation function used and its results, current relevant goal/subgoals, and other information that differs from previous step(s). The state of the problem or problem state can be evaluated to determine if the problem is solved. If not, then using information from the latest problem state after the last step, re-run the problem solving process, evaluation of progress, and selection of next operators to apply. After which, the process can return to the step of recording.

If the problem is solved, then record successful or unsuccessful solutions for retrieval to save effort of solving previously solved problems and to inform problems solving efforts about previous unsuccessful paths.

Successful solutions and unsuccessful attempts with key words for future matching/retrieval can be indexed using semantic analysis, hash functions, and/or other means.

A periodical review of all stored solutions can be implemented to ensure they meet established ethical and safety guidelines, and flag unsafe/unethical solutions for removal from the database or data source.

Periodically update and propagate changes to the solution database so problem solving network and agents can access an ever-increasing repertoire of solutions as well as increasing knowledge of unsuccessful attempts.

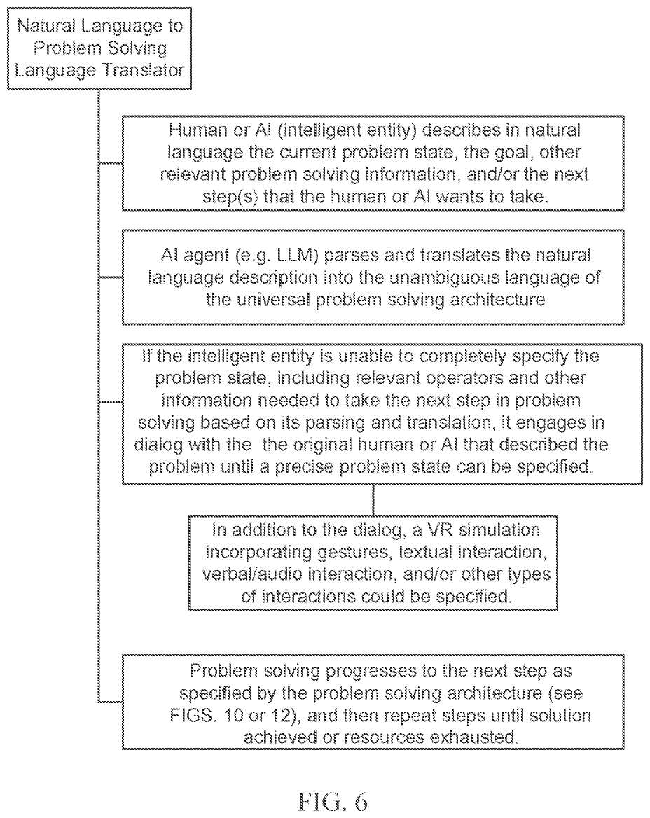

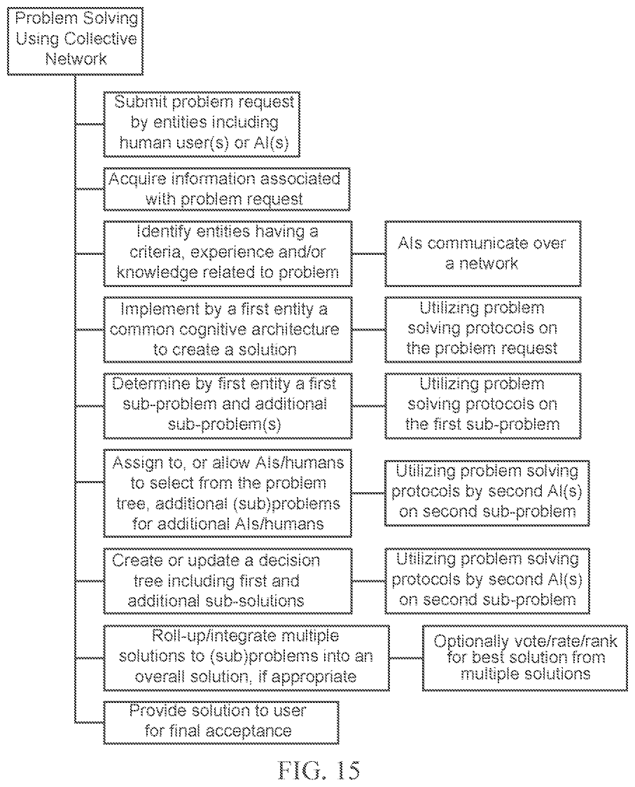

Referring to FIGS. 6 and 15, the present technology can include a utilization of a network of multiple intelligent entities including human workers in combination with a universal problem solving architecture. The multiple intelligent entities are matched to a problem request based on a problem criteria using a database or data source including a list of human and/or AI problem solvers. Any part of the problem request can be translated into an unambiguous language utilizing a universal problem solving architecture including the decision tree.

A sub-problem of the problem request can be delegated to one or more of the matched intelligent entities so that work on the sub-problem proceeds independently from each other and parallel with each other, as further illustrated in FIG. 12. The universal problem solving architecture is utilized in a problem solving process on the sub-problems, respectively, to create one or more sub-solutions.

Any one of or any combination of the intelligent entities can provide in natural language a description of any one of or any combination of a current problem state, a goal of the problem request, relevant problem solving information, and a next step that the human workers will take in the problem solving process.

The sub-solutions can be received from each of the matched intelligent entities for the sub-problem delegated thereto. Any one of or any combination of the sub-solutions and an overall solution can be provided to any one of or any combination of a user interface of a user AI system or the intelligent entities.

Parsing and translating, by the intelligent entities, the natural language description into the unambiguous language can be utilized by the decision tree of the universal problem solving architecture.

In some embodiments, if the intelligent entities are unable to specify a problem state, including relevant operators and information needed to take a next step in the problem solving process based on the parsing and the translation, then the intelligent entities can engage in dialog with at least one of the human workers until a precise problem state is specified.

Some embodiments the problem solving process can be repeated until the overall solution is accepted or resources are exhausted. The matched human workers can be compensated for the sub-solutions, respectively. Further, a reputation attribute can be assigned to any one of or any combination of the human workers and the worker AI system, or PSI.

In some embodiments, the solving process can include a series of problem state transitions from an initial problem state where there is a goal to a final solution state where the goal has been achieved, and wherein a series of decisions are made by the problem solving process and actions taken that applies operators that enable the human workers to transition from state to state until the final solution state is reached.

Referring to FIGS. 4, and 15, the present technology can include a utilization of a network of human users in combination with a universal problem solving architecture. The multiple human users are matched to a problem request based on a problem criteria using a database or data source including a list of human, AI, and/or PSI problem solvers.

A sub-problem of the problem request can be delegated to one or more of the matched intelligent entities so that work on the sub-problem proceeds independently from each other and parallel with each other, as further illustrated in FIG. 12. The universal problem solving architecture is utilized in a problem solving process on the sub-problems, respectively, to create one or more sub-solutions.

The sub-solutions from each of the matched human workers can be provided for the sub-problems delegated thereto. The matched human workers for the sub-solutions can be compensated, respectively.

Any one of or any combination of the sub-solutions and an overall solution can then be provided to a user interface of a user AI system or any other AI system, including without limitation, PSIs or other intelligent entities.

The human user is allowed to accept the overall solution, reject the overall solution, and/or provide feedback to any one of the matched human workers on any one of the sub-solutions.

A reputation attribute can be assigned to the human workers and/or the worker AI system. The reputation attribute can include metrics on any one of or any combination of a time to the sub-solutions, a difficulty value of the problem request, short and long-term user satisfaction with the sub-solutions, a number of times any one of the sub-solutions has been re-used on the network, a rating other human workers, a responsiveness value of the human workers, and a reliability value of the human workers.

Some embodiments can include using the reputation attribute in the matching of the human workers to the problem request using an algorithm to the delegation of the sub-problems, and/or compensating the matched human workers for the sub-solutions, respectively.

In some embodiments, the algorithm can use a hierarchy of the metrics that is preset by a human user of the problem request.

Some embodiments can include recording information on each step of the problem solving process by the human workers or the worker AI system.

Some embodiments can include recording a criteria of the recorded step of the problem solving process, the criteria being a time taken for each step.

Some embodiments can include analyzing the recorded information after the overall solution is accepted or after the problem solving process and updating the metrics of the reputation attribute.

Some embodiments can include soliciting, at predetermined intervals after the overall solution or the sub-solutions are provided to the user interface, a survey for user satisfaction information to obtain short and long-term satisfaction metrics that are used to update the reputation attribute of one or more of the human workers or the worker AI system.

Referring to FIG. 7, the present technology can include a utilization of human users and AI systems (including, without limitation, PSIs), which includes an execution of safety/ethics check on any one of or any combination of a goal, and a solution for the goal provided by any one of or any combination of the intelligent entities including any one of or combination of human users each using a computer system and AI systems.

The goal and/or the solution can be compared against prohibited attributes, and an ethics value can be assigned to the goal and/or the solution based a result of the comparison and/or an ethics criteria.

Based on the result of the comparison, a common cognitive architecture including one or more problem solving protocols can be conducted on the goal to create the solution and thereby creating an AGI. The results of the comparison and the solution can be provided to any one of the intelligent entities.

In some embodiments, the ethics check can be performed at any one of or any combination of when the goal is provided, and periodically from when the goal is provided to when the solution is provided.

In some embodiments, the ethics criteria can be determined by any one of or any combination of combining values and safety information from one or more of the intelligent entities, using a set of approved ethics criteria mandated for a particular task by a user or by a regulatory agency. It can further be provided by any one of the additional intelligent entities and validated or approved by the human user.

In some embodiments, the ethics criteria can include a confidence level threshold for the goal so that the ethics value is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed based on the ethics value, and the candidate goal is compared against the prohibited attributes.

In some embodiments, the results of the comparison can be recorded in an auditable record for use in the determining which problem solving activity leads to the solution to keep active.

Further referring to FIG. 7, the ethics check can compare any one of or any combination of the problem request, the sub-problem and the sub-solutions against prohibited attributes and assigning an ethics value based on any one of or any combination of a result of the comparison, and an ethics criteria.

In some embodiments, the step of the ethics check can be triggered every time the problem request or the any one of the sub-problems is set by the human user, and/or triggered each time compensation is provided to the matched human workers.

The goal/subgoal can be compared against a list of prohibited attributes. The ethics criteria can be determined by any one of or any combination of combining values and safety information from any one of the AAAIs. Combining values/safety information from AAAIs, using a set of approved criteria for a task by a user or by a regulatory agency, or by AAAIs approved by human user.

The ethics criteria can include a confidence level threshold for the problem request so that the ethics value is determined as any one of an unsafe goal, an unethical goal, a safe goal, and an ethical goal. The confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria. Any and all activity of the safety/ethics check can be recorded in the auditable record.

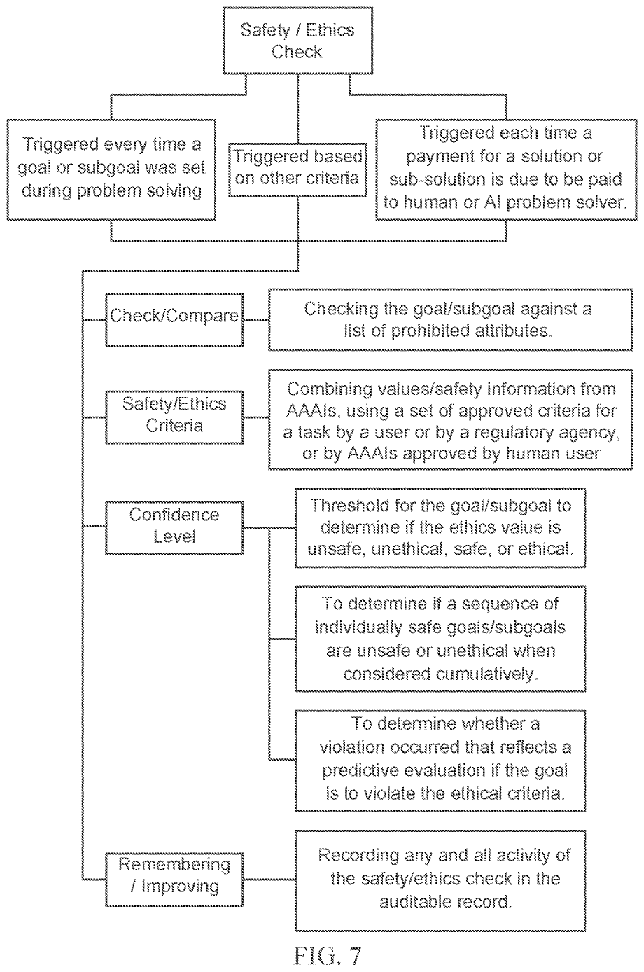

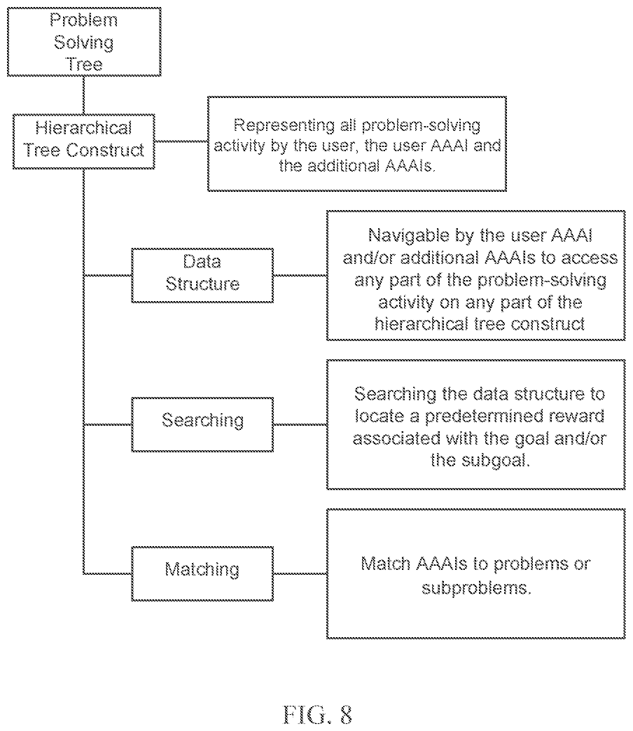

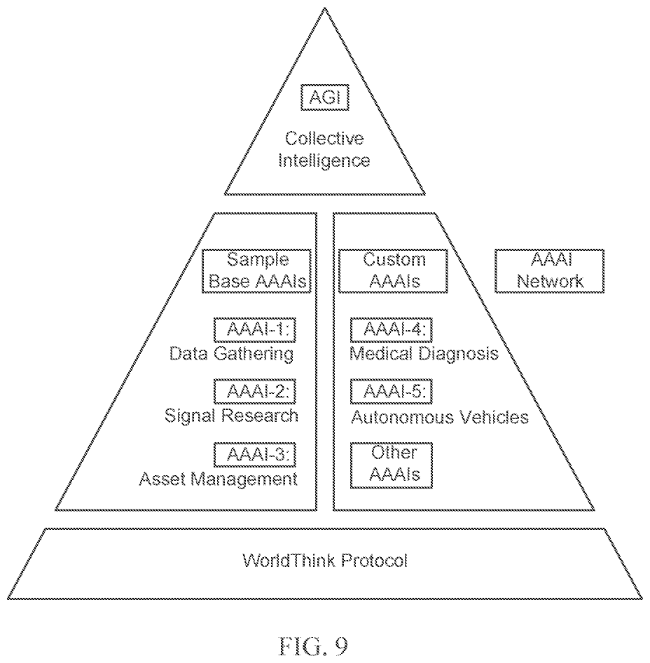

FIGS. 8-10 provides a simple exemplary framework for understanding the WorldThink protocol. FIG. 8 is a diagram illustrating features and functions of the Problem Solving Tree structure in the WorldThink protocol. FIG. 9 is a diagram illustrating various use cases for domain-specific problems which depend upon the underlying WorldThink protocol, and which together help form the basis for an AGI system capable of solving a wide range of problems. At the top of the pyramid are Collective Intelligence Solutions. Integrating the Collective Intelligence of AAAIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The WorldThink protocol is the foundation of the pyramid. The protocol layer provides an (optionally. Ethereum or blockchain based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

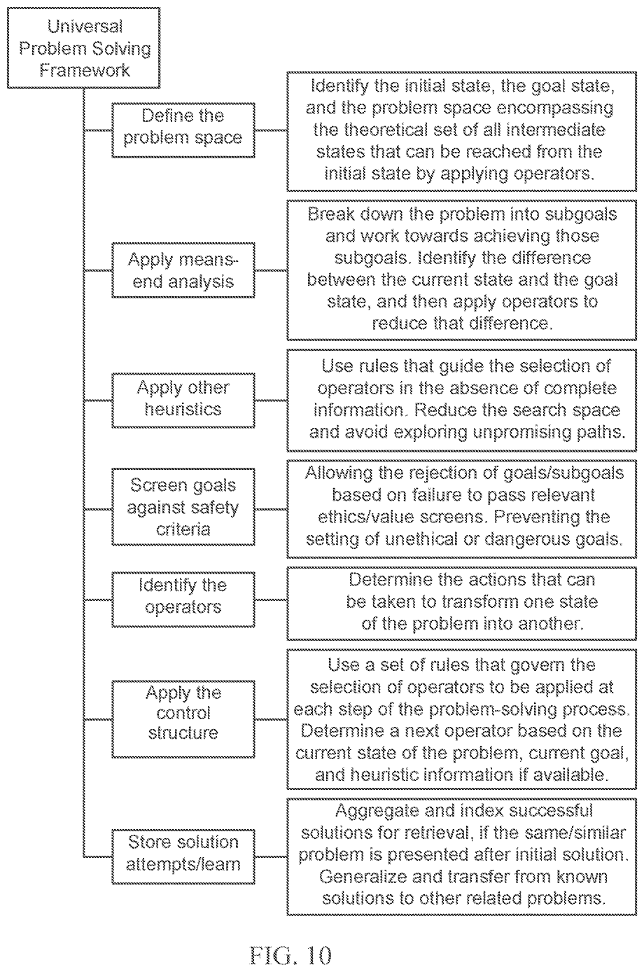

In the exemplary, FIG. 10 shows a simple exemplary universal problem solving framework under the common cognitive architecture, and which can include:
defining a problem space configured or configurable to support all possible states of the problem request, the states including any one of or any combination of an initial state, a goal state. and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals are set;
applying heuristic rules that are configured or configurable to guide the selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the second operators to apply next based on the current state of the problem request and the goal state;
applying evaluation functions to determine an application of the second operators: assigning a credit or blame value to the completion solution or sub-solution to the completion solution that enables tracing back and determining which of the second operators were most useful and also which of the evaluation functions led to success or failure of problem solving attempts;
recording of both successful and unsuccessful problem request solution attempts; and analyzing the solution attempts to improve selection of the heuristic rules and the evaluation functions.

FIG. 9 provides a simple exemplary framework for understanding the WorldThink protocol. At the top of the pyramid are Collective Intelligence Solutions that lead to AGI. Integrating the Collective Intelligence of AAAIs. PSIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The middle of FIG. 9 shows examples of AAAIs (or PSIs) customized by organizations to accomplish specific tasks. These AAAIs, or PSIs, are more advanced and require more customization than the examples of AAAIs described earlier in this patent which were customized by a single individual. However, task-specific customization by organizations can be a highly effective means of combining multiple Narrow Als (each in the form of a custom AAAI that is expert at a particular task) into a larger AGI. The Base level AAAIs on the left of FIG. 9 reflect areas the inventor could relatively easily construct custom AAAIs, or PSIs, based on many years of expertise in certain fields, whereas the “Custom AAAIs” on the right of the diagram provide examples of areas where other experts or organizations might customize AAAIs effectively.

The World Think protocol is the foundation of the pyramid. The protocol layer provides an (optionally, blockchain or Ethereum-based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

Existing collective intelligence approaches to problem solving have been largely limited to simple one-step approaches, such as those used by question and answer (Q&A) systems (e.g., Quora, Google Answers, Yahoo Answers). LLMs such as GPT also largely fall into the category of Q&A systems since they were designed to generate responses given an input, rather than to solve problems per se. While such Q&A systems have had some success at simply aggregating the responses of many online participants, these systems are not designed to handle complex, branching. multi-step problems. Simple aggregation of responses (or even betting on outcomes as seen in prediction market approaches such as Augur and Gnosis) is quite different from coordinating the efforts of many respondents to solve complex problems. The WorldThink protocol is specifically designed to overcome the challenges inherent in coordinating many intelligent entities to represent and solve complex, multi-step problems in an automated way that fairly rewards participants.

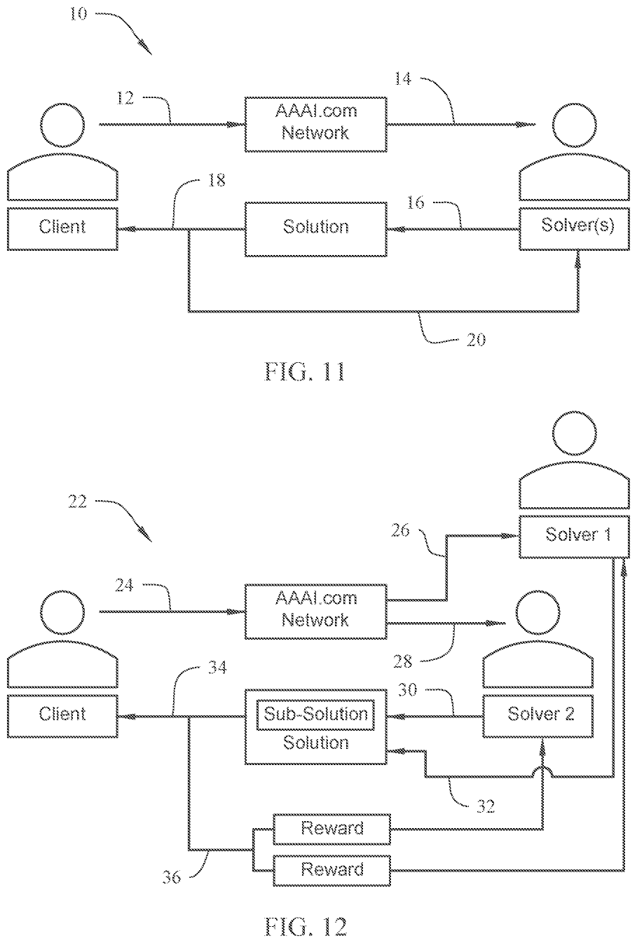

In the exemplary, FIG. 10 shows a simple exemplary universal problem solving framework. While FIG. 11 shows some of the basic problem solving functionality supported by the WorldThink Protocol, generally referenced with numeral 10.

Problem solving begins when a client on AAAI.com submits a problem solving request to the community of online participants (Step 12). All AAAIs, or human solvers, following the protocol gather certain standard information from the client. A partial list of this information can include: the name and description of the problem, the total reward that the client will pay for a successful solution to the problem, the criteria to determine whether a solution will be deemed successful, the time limit for solving the problem, the minimum and maximum number of problem solvers allowed to work on the problem simultaneously, qualifications required of participants working on the problem, which parts (if any) of the problem and solution will be confidential, whether the solution must be exclusive to the client or whether it can be re-used for others, and parameters relating to how to reward multiple problem solvers for their efforts and/or successful solutions.

The client can break complex problems down into a series of sub-problems or request that the community take on this task as part of the problem solving effort. The client user-interface, which could be a dialog initiated by an AAAI can be customized by the AAAI owner, but the underlying data format is standard and specified by the WorldThink or Online Distributed Problem Solving (ODPS) protocol. Once the client has submitted a problem, AAAI.com can recruit participants using its own custom methods and/or leverage recruiting and reputational screening functionality that is built into the WorldThink protocol and thus shared by all AAAIs.

Solvers work on the problem following a rigorous structured problem solving process that is common to all problem solving agents and enforced by the WorldThink Protocol (Step 14). For example, each step in the problem-solving process must be in service of a named goal and must take a named action in order to transition the problem solving from the current state to the next state. Every problem solving step is represented in a decision tree which is supported by the protocol (optionally captured in Ethereum logs) and which participants can view via AAAI.com.

When a Solver submits a complete solution (Step 16), it is timestamped and validated against the client's success criteria before being passed on to the client (Step 18) for final acceptance. Once the client accepts the solution, smart contracts can automatically distribute tokens to the problem solver based upon the problem payment parameters (Step 20) or other, more centralized, payment procedures can be used.

### Collaborative Problem Solving Using the WorldThink Protocol

In the exemplary. FIG. 12 shows the same steps in an example where two problem solvers (which could humans, AAAIs, PSIs, or a combination of intelligent entities) collaborate to solve a client problem, as generally referenced with numeral 22. In this case, the overall problem has been broken down to include a sub-problem. Solver 1 has expertise in assembling an overall solution but cooperates with Solver 2, who provides a solution to the sub-problem (Steps 30 and 32). When the overall solution to the problem is submitted to the client (Step 34), rewards are paid to both Solvers (Step 36) based on the objective record of their contributions and the agreed upon payment parameters.

The WorldThink protocol supports breaking problems into sub-problems in several ways. First, the client may choose to specify sub-problems when submitting the overall problem (Step 24). Alternatively, Solver 1 might begin working on a problem and realize that the total solution requires solving a sub-problem outside of his/her expertise. Solver 1 could then create a sub-problem. offering up a share of the problem's total token reward to anyone who helps solve the sub-problem. Solver 2, who has the required expertise and who can see the new sub-problem posted by Solver 1 on the decision tree. The decision tree may be optionally maintained in Ethereum logs, or via a centralized method. The solvers access the tree via AAAI.com (or optionally directly from the blockchain). Then Solver 2 can work on the sub-problem and submit a sub-solution as part of Solver 1's overall solution.

There can be many “Solver Is” working on the client's problem in parallel, each of whom may be posting sub-problems to attract multiple “Solver 2s”. Problem solvers (human or AAAIs or other intelligent entities) are motivated by the rewards and payment rules associated with (sub) problems. They also care about the quality of work done so far (which is timestamped, attributed, and recorded auditably in Ethereum logs to ensure transparency and fair assignment of credit) as they choose which (sub) problems to work on. Working on quality sub-problems is more likely to lead to token rewards. This market mechanism helps ensure efficient, fair, and cost-effective solutions.

### Royalties and Re-Usable Solutions

Re-usability of solutions is an important feature of the WorldThink protocol. Consider the case where the “Sub-solution” in FIG. 12 already existed and is simply re-used by Solver 1. Because every solution is structured and “tagged” according the WorldThink protocol's standard problem solving format, Solver 1 can search for all existing solutions that match a particular goal or share certain features with the problem he/she is trying to solve. (Alternatively, if the problem solutions are chunked into procedures for solving problems-α learning mechanism explained in the Improvement Section of this patent-then searching may not be necessary as the AAAI, or PSI, solvers can simply add the chunked problem solution to their repertoire of problem solving abilities.) Solver 1 decides to include an existing sub-solution in the overall solution, smart contracts (can optionally) automatically pay royalties to the author of the re-used sub-solution (Solver 2, in this example) if Solver 1's overall solution is accepted by the client. Royalties motivate Solvers to create high-quality solutions that are easy to re-use, which results in better, faster, more cost-effective solutions for clients.

Additional description and detail for one implementation of the AAAI (or PSI) customization subsystem could involve the following steps.

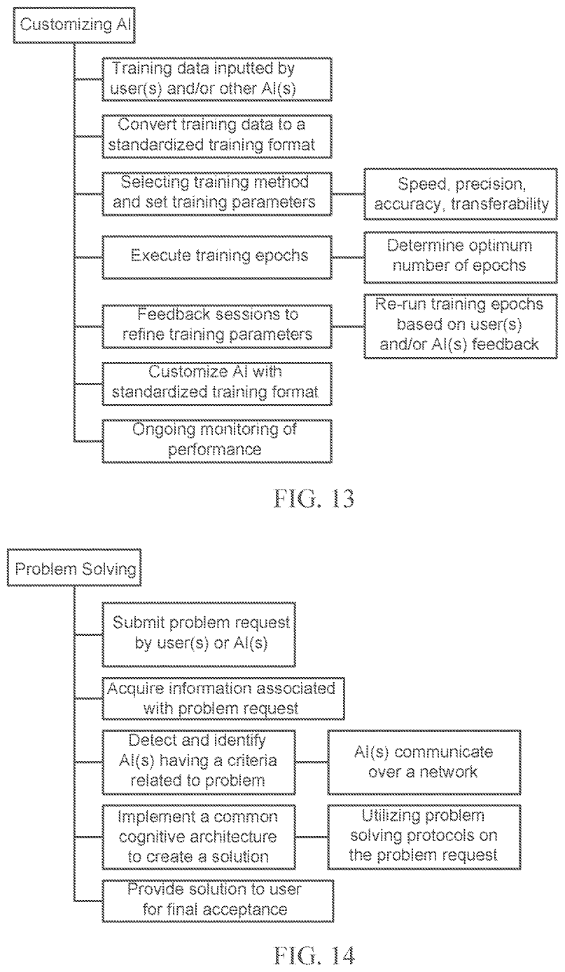

Referring to FIG. 13, the first step of the customization method involves creating an interface for users to input their unique training data. This interface may be accessible through a web-based application or a mobile application, depending on the user's preference. The user will be able to upload files in a variety of formats, including text, audio, and video. The user may also be able to enter data manually into a text or other input field. Some user interfaces include, without limitation:

Web-Based Application: A web-based user interface allows users to access and/or provide their personalized training data from any device with an internet connection.

Mobile Application: A mobile user interface allows users to access and/or provide their personalized training data from a mobile device.

Metaverse: A metaverse user interface allows users to access and/or provide their personalized training data from a virtual world.

Augmented Reality: An augmented reality user interface allows users to access and/or provide their personalized training data from a real-world environment.

Voice Interface: A voice interface allows users to access and/or provide their personalized training data through voice commands.

Wearable Device: A wearable device user interface allows users to access and/or provide their personalized training data from a wearable device.

Natural Language Processing: Natural language processing (NLP) allows users to access and/or provide their personalized training data by interacting with the AI or LLM using natural language.

Human-Computer Interaction: Human-computer interaction (HCl) allows users to access and/or provide their personalized training data by interacting with the AI or LLM using a combination of gestures, voice commands, and facial expressions.

Image Recognition: The user can input their unique training data through image recognition, allowing them to quickly and intuitively train the AI or LLM. This could be done with the use of a camera and computer vision algorithms that can interpret the images and associate them with or create the correct training data.

Gesture Recognition: The user can use hand gestures or body movements to input their unique training data. This could be done with the use of a motion sensing device that can interpret the gestures and associate them with or create the correct training data.

Brain-Computer Interface: The user can use their brain waves or EEG signals to input their unique training data. This could be done with the use of a brain-computer interface that can interpret the signals and associate them with or create the correct training data.

Touchscreen: The user can use a touchscreen device to input their unique training data. This could be done with the use of a touchscreen device that can interpret the inputs and associate them with or create the correct training data.

Gaze Tracking: Gaze tracking allows users to communicate with the system through their eyes. The user can gaze at specific items on the screen to provide input and the system will detect and record the information. This could be used to select options or provide additional data to the system.

Eye Tracking: Eye tracking is similar to gaze tracking, but the system is able to detect more subtle eye movements. This could be used to detect the user's focus and attention in order to better understand what they are interested in and what they are not.

Motion Tracking: Motion tracking uses a camera or other sensors to detect the user's physical movements. This could be used to control the AI or LLM in a more natural way, allowing the user to interact with the system through physical gestures.

Haptic Technology: Haptic technology uses a variety of tactile feedback such as vibrations. pressure, and touch to provide a more immersive experience. This could be used to allow the user to provide more detailed input to the system, such as selecting specific options or providing more detailed data.

Many of the above user interfaces could include a graphical user interface (GUI) that allows users to upload their data or type in information, including text, images, audio, or video. Additionally, users could build their own models or use pre-existing ones to train the AI or LLM. Other features could include a dashboard to track progress, statistics for data analysis, and/or a chatbot for customer service.

In further reference to FIG. 13, the present technology can include customizing one or more attributes of an AI, or PSI, system by providing an interface configured or configurable to allow a human user of the AI system or any one of the intelligent entities to input training data. Then processing and converting the training data to a standardized training format.

One or more training methods and setting training parameters can be selected depending on a speed factor, a precision factor, an accuracy factor, and/or a transferability factor. Multiple training epochs can be executed that includes one or more mechanisms to determine an optimum number of epochs given specific training objectives and quality metrics associated with the training format.

One or more feedback sessions can be executed to refine the training parameters, and to re-run the training epochs based on any one of or any combination of an input from the human user. and any one of the intelligent entities. After which, the AI system can be customized utilizing the training format.

In some embodiments, the interface can be accessible through a web-based application or a mobile application and is configured or configurable to upload a file or allow the human user to enter data.

In some embodiments, the training data can contain any one of or any combination of: an amount of training time the user has to devote to customizing the AI system: an amount of financial resources the user is willing devote to customize the AI system: an amount of computational resources the user is willing to devote to customize the AI system: an amount of social media information available to customize the AI system: an amount of email information available to customize the AI system: an amount of electronic information available about the user to customize the AI system; and an amount of electronic information available collected by third parties about the user to customize the AI system.

In some embodiments, the training data can contain information about the human user obtained by any one of or any combination of a personality test, a standardized test, a certification, and assessments or questionnaires provided by the human user.

In some embodiments, the training parameters can be any one of or any combination of: a type of training, tuning or other machine learning algorithm to be used: a type and size of a training dataset: a degree to which the training dataset is to be formatted, labelled or processed before customization begins: a number of training epochs: a type of base model being customized: a required timeframe for training: an amount of human user supervision to be used in the customizing of the AI system; and an amount of AI supervision to be used in the customizing of the AI system.

In some embodiments, the training data can include ethical information provided by the human user by way of the interface. The ethical information can be stored in an ethical profile. The customizing of the attributes of the AI system can include the ethical information.

Referring to FIG. 14, the present technology can include utilizing a common cognitive architecture implemented in one or more AI systems. A problem request can be provided from an intelligent entity being an AI system, a PSI, or a human user using a user interface on a computer system. Information associated with the problem request can further be provided.

Multiple additional intelligent entities are identified and recruited, and where each has one or more attributes related to one or more request criteria of the problem request. The additional intelligent entities can be multiple additional AI systems, PSIs, and/or multiple additional humans each using a computer system. Each of the identified AI systems implement the common cognitive architecture including one or more problem solving protocols on the problem request to create a completion solution. The completion solution can be provided to the intelligent entity for final acceptance by a user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified additional intelligent entities allowed to work on the problem request simultaneously. qualifications required of users associated with the identified additional intelligent entities working on the problem request, a part of the problem request is confidential, a part of the completion solution is confidential, whether the completion solution is exclusive to the user, whether the completion solution is to re-used for other users, parameters relating to how to reward the users associated with the identified additional intelligent entities for working on the problem request, and parameters relating to how to reward the users associated with the identified additional intelligent entities that provide a successful completion solution.

Some embodiments of the present technology can include a step of timestamping and

validating the completion solution against a success criteria assigned by the user before being provided to the user for the final acceptance.

Some embodiments of the present technology can include a step of distributing one or more tokens to the identified additional intelligent entities associated with the final acceptance completion solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of splitting the problem request into a series of sub-problems that are each solved by any one of or any combination of the identified additional intelligent entities.

In some embodiments, any one of or combination of the identified additional AI systems can be cloned to create one or more cloned AI systems.

Some embodiments of the present technology can include a step of implementing by each of the cloned AI systems the common cognitive architecture including the problem solving protocols on the problem request to create a completion solution of the cloned AI systems.

In some embodiments, the completion solution can utilize any one of or combination of the completion solution from the AI system, the identified additional intelligent entities, and the completion solution from the cloned AI systems.

In some embodiments, the common cognitive architecture can include:
defining a problem space configured or configurable to include all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state. and then applying the operators to reduce the difference, a safety or ethics screening is applied each time the goals or the subgoals are set;
applying heuristic rules that are configured or configurable to guide the selection of the operators in an absence of the completion solution, the heuristic rules are used to reduce the problem space;
identifying one or more operators configured or configurable to enact an action to transform one of the states into another state, the operators move from the initial state to the goal state by changing a current state of the problem request;
applying a control structure including a set of rules that govern a selection of the operators to be applied at each step of the problem solving protocols, and that determines which of the operators to apply next based on the current state of the problem request and the goal state: applying evaluation functions to determine an application of the operators;
assigning a credit or blame value to the completion solution or sub-solution to the completion solution that enables tracing back and determining which of the operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

Referring to FIG. 15, the present technology can include utilizing a collective network of AI systems. A problem request can be provided from a human user using a user interface on a computer system or from an AI, PSI, intelligent entity or system. Information associated with the problem request can further be provided.

Intelligent entities that each have one or more attributes related to one or more request criteria of the problem request are identified and recruited. The intelligent entities can be multiple additional AI systems and/or multiple humans each using a computer system.

A first of the identified intelligent entities can implement a common cognitive architecture including one or more problem solving protocols on the problem request. The first intelligent entity can determine that a completion solution to the problem request requires solving a first sub-problem and one or more additional sub-problems. Then the first intelligent entity implements the problem solving protocols on the first sub-problem to create a first sub-solution.

At least one of the additional sub-problems is assigned to a second of the intelligent entities, where it implements the problem solving protocols on the at least one of the additional sub-problems to create a second sub-solution.

A decision tree is created including the first sub-solution and the second sub-solution to create the completion solution to the problem request. The completion solution can then be provided to the user interface or the AI system for final acceptance by the user, and/or to any of the intelligent entities for subsequent use.

In some embodiments, the decision tree can be maintained in blockchain Ethereum logs.

In some embodiments, the first and second identified intelligent entities can access the decision tree by way of an online address or directly from a blockchain.

Some embodiments of the present technology can include a step of distributing one or more tokens to the first identified intelligent entity associated with an acceptance of the completion solution or the first sub-solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of distributing one or more of the tokens to the second identified intelligent entity by the first identified intelligent entity based on a payment parameter assigned by the first identified intelligent entity.

Some embodiments of the present technology can include a step of influencing a direction of the problem solving protocols by assigning a first token reward for the first sub-problem, and a second token reward for the second sub-solution that is of a value different to the first token reward.

In some embodiments, the problem solving protocols can provide layers of an infrastructure configured or configurable to build and scale the identified intelligent entities. The problem solving protocols can enable re-use of completion solutions within and across the intelligent entities. The problem solving protocols can be configured or configurable to manage a payment of royalties.

In some embodiments, the infrastructure can be blockchain or Ethereum based.

Further referencing FIG. 15, after the multiple intelligent entities have been identified and recruited the problem request or one or more sub-problems of the problem request can be assigned to each of the intelligent entities. After which, the common cognitive architecture including one or more problem solving protocols can be implemented on the problem request or the sub-problems to be each of the recruited intelligent entities to create a problem solution or a sub-problem solution, respectively. The problem solution and the sub-problem solution can be integrated to create a completion solution to the problem request. Then the completion solution can be provided to the user interface or the AI, or PSI, system for final acceptance by the user.

Some embodiments of the present technology can include a step of assigning a credit value or a blame value to the datasets based on whether the datasets increase or decrease performance of the intelligent entities based on performance metrics or evaluation functions.

Some embodiments of the present technology can include a step of quantifying a benefit weight or a harm weight to a contribution by each of the intelligent entities to the problem request.

Some embodiments of the present technology can include a step of distributing a reward to an owner of the intelligent entities proportionally to the contribution of the intelligent entities based on the benefit weight or the harm weight.

Some of the objectives a user may have in creating and customizing their own AI (aka an AAAI) for purposes that might include, without limitation:

Serving the user as an advisor, teacher, or companion.

Representing the user in negotiations, interactions, discussion, and transactions with other users, or with the AAAIs of other users: or with vendors and other companies.

Working on behalf of the user for compensation, or in volunteer efforts, where such work includes online intellectual, advising, or problem solving work across a wide range of tasks.

Duplicating or “cloning” the user's AAAI so that several or many of the cloned AAAIs can work on behalf of the user in parallel, including interacting with, teaching, and improving each other so that the cloned AAAIs increase their knowledge, skills, and abilities.

Serving as legacy AAAIs that can continue to interact with the world, including potentially comforting living relatives and friends, after the owner's death.

Contributing knowledge, ethics, and effort to AAAI.com's AGI, and improving the base level of AI or AGI that AAAI.com can offer users before those users add their unique customizations.

Working with other users' AAAI to help ensure ethical and safe behavior by AGI by contributing ethical information and values to the AGI and participating in monitoring, review, supervision, and voting processes that can help ensure the AGI remains safe and ethical.

Some of the steps involved in creating and customizing an AAAI may include, without limitation, a dialog or interaction with the user. During this dialog, the AAAI system may identify constraints and resources available for customizing the user's AAAI. For example, some of these constraints and resources, might include, without limitation:

The amount of training and/or supervisory time that the user has to devote to customizing their AAAI.

The amount of financial resources the user is willing devote to customizing their AAAI.

Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.

Availability and use of personality tests, such as the Myers-Briggs personality inventory, skills and knowledge assessments, standardized tests, exams, certifications, and other types of assessments and questionnaires which could be given online (or which have already been given) to the user.

Availability and use of other knowledge bases and training data from users on the AAAI platform that could be used to train, tune, or customize the user's AAAI.

Other human users, and/or their AAAIs, available to help train, tune, or customize the user's AAAI.

Other texts and information, individual texts, and libraries selected by the user or by the system for purposes of training the user's AAAI. For example, the Bible, Koran, Dhammpada Mahabharata, or other spiritual/ethical/religious texts might be selected for training the AAAI based on the user's religious preferences: books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or

Christian might behave, for example.

In addition to specifying objectives, resources, and constraints via an interactive dialog or other interaction with the system, the user or system may want to specify other technical parameters that affect the training or customization process. These parameters can include, without limitation:

The type of training, tuning, or other ML algorithms that are used.

The type and size of the training dataset(s).

The degree to which the training materials are to be “cleaned”, formatted, labelled, or otherwise processed before customization begins.

The number of training “epochs” or iterations through the learning algorithm(s).

The sophistication and type of base model(s) being customized or trained.

The required timeframe for training—e.g., must be completed in a minute, a day, a week-which might have implications for cost and resources used.

The “temperature” or other parameters internal and specific to various machine learning algorithms that can affect what is learned and how it is learned including, without limitation, how literal or how divergent or “creative” the customized AAAI will be in its responses.

Whether “one shot”, “few shot”, or extensive training is to be used.

The amount of human and/or AI supervision to be used in the customization process.

Once the user's AAAI is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user. The AAAI can also serve as representative(s) of the owner in a variety of online transactions and interactions, and contributing knowledge, expertise, style, personality, and ethics to an integrated AGI system that leverages the trained differences in many individual AAAIs.

### Classical Information Theory Contrasted to Kaplan Information Theory

Claude Shannon, in a famous paper in which he laid the groundwork for the field of information theory, explained that the information content of an event is proportional to the probability of that event. In other words, observing rare things gives an agent more information than observing common or expected things. This view of Classical Information Theory was described generally in the background section above.

More precisely, Shannon-sense information can be described mathematically. The critical formula is described in the following section of Claude Shannon's classic 1948 paper, A Mathematical Theory of Communication, and reproduced, in part, (with certain formulas bolded for emphasis) here:

“6. CHOICE. UNCERTAINTY AND ENTROPY We have represented a discrete information source as a Markoff process. Can we define a quantity which will measure, in some sense. how much information is “produced” by such a process, or better, at what rate information is produced?

Suppose we have a set of possible events whose probabilities of occurrence are p1; p2; . . . ; pn. These probabilities are known but that is all we know concerning which event will occur.

Can we find a measure of how much “choice” is involved in the selection of the event or of how uncertain we are of the outcome? If there is such a measure, say H (p1; p2; . . . ; pn), it is reasonable to require of it the following properties:
1) H should be continuous in the pi.
2) If all the pi are equal, pi=I/n, then H should be a monotonic increasing function of n. With equally likely events there is more choice, or uncertainty, when there are more possible events.
3) If a choice be broken down into two successive choices, the original H should be the weighted sum of the individual values of H . . . , the following result is established: Theorem 2: The only H satisfying the three above assumptions is of the form: H=KnΣi=1 pi log pi where K is a positive constant. . . .

Quantities of the form H=Σpi log pi (the constant K merely amounts to a choice of a unit of measure) play a central role in information theory as measures of information, choice and uncertainty. The form of H will be recognized as that of entropy as defined in certain formulations of statistical mechanics where pi is the probability of a system being in cell i of its phase space. H is then, for example, the H in Boltzmann's famous H theorem. We shall call H=Σpi log pi the entropy of the set of probabilities p1; . . . ; pn.”

Thus, from Shannon's paper, we see that the information contained in any one observed event is related to the (log) probability of that event, assuming that the probabilities of all possible events are known. However, as a practical matter, an intelligence can only estimate the Shannon-sense information content of a potential dataset or event.

### Inventive Methods as Understood by Classical Information Theory

In Classical Information Theory, what do scientists call a situation where every event is equally likely? Noise. Randomness. Classical Information Theory calls the measure of the randomness of a distribution of “entropy.” Maximum entropy refers to a distribution of events with maximum randomness, sometimes called “noise.”.

Now, intelligence can be viewed as an anti-entropic force. Intelligence strives for order rather than the chaos of randomness. Intelligence is the signal on your tv as contrasted to the white noise, or the “snow” of randomness. So, if an intelligent system (e.g., AI. AGI, or PSI) wants to get smarter, it has to pursue data that contains the maximum amount of information.

From the standpoint of Classical Information Theory, the methods of this present technology can be viewed as enabling an intelligent system (e.g., an AI, AGI, or PSI system) to maximize the information it acquires, which in turn enables the acceleration of learning by the system.

Systems that adopt the methods proposed herein, and implement them, should outperform and ultimately dominate systems that do not adopt these methods. These methods are fundamental and essential to maximizing the speed of intellectual growth for any intelligent entity, including PSIs.

### Limitations of Classical Information Theory

To non-mathematicians, and others who have not adopted Classical Information Theory as the only way to measure information, intuitive concepts have validity. For example, commonly we say some event carries information if it is “news”—that is if it was previously unknown to a particular recipient even if it is not surprising generally. So, it seems that there is a relative aspect to information that is not explicitly part of the classical theory. By assuming a different probability distribution of expected events for each individual entity, this problem could be solved—but that seems cumbersome.

Also, while the amount of information is sometimes proportional to the number of words in a message, there are situations in which fewer words convey more information. For example. Mark Twain famously wrote. “I didn't have time to write you a short letter, so I wrote you a long one,” implying that fewer words would have conveyed more useful information. Again, Classical Information theory can be contorted to say that Twain's shorter letter was somehow less expected and therefore contained more information, but this seems counter-intuitive.

Is there a more general theory of information that can more naturally account for the fact that sometimes surprising information is not necessarily relevant of useful, or that a longer string of words has less useful information, or that commonly known and expected facts could still carry high information content if they are especially relevant?

### Kaplan Information Theory (KIT)

Kaplan Information Theory (KIT) starts with the observation that if there were no differences, there would be no information. That is, humans (or any intelligent entity) could not perceive a world unless we were able to perceive and draw distinctions between this and that. Therefore, most generally, the notion of “difference” and the quantification of “differences” is the essence of meaningful information.

Classical Information Theory is, in fact, a subset of KIT, because Shannon talks about information being related to the difference between what was observed and what was expected. The greater the difference between what was received and what (probabilistically) one could expect to receive, the greater the information contained in a message. Shannon's formulation of information made sense in the context of trying to determine how to maximize the information sent over copper wires from a sender to a receiver. This was the problem at Bell Labs that he was working on when he wrote his classic paper. In that context, measuring the difference between what the receiver expected to see and what the receiver actually saw made complete sense as a rigorous definition of information with practical implications for the capacity of a channel to carry information. However, difference in terms of expectation is only one type of difference that can be measured.

KIT considers any difference between two events, datasets, categories, or informational units to be a valid measure of the information content. Generally, distinguishable events or objects or categories of information of any sort only exist to the degree that differences exist. An infinite string of Is contains no information. An infinite string of Os contains no information. Zero only has meaning if 1 is a possibility and if “1” sometimes exists. Similarly, “1” has meaning only if “0” is a possibility and “0” sometimes exists.

Seeing a “1” after an incredibly long sequence of “0” s has a lot information not just because it is unexpected, but because it is finally a difference!

Thinking of information as a measure of difference, is more general than thinking of information as a measure of surprise. Surprise is just one type of difference, whereas any difference, even non-surprising ones, contain information.

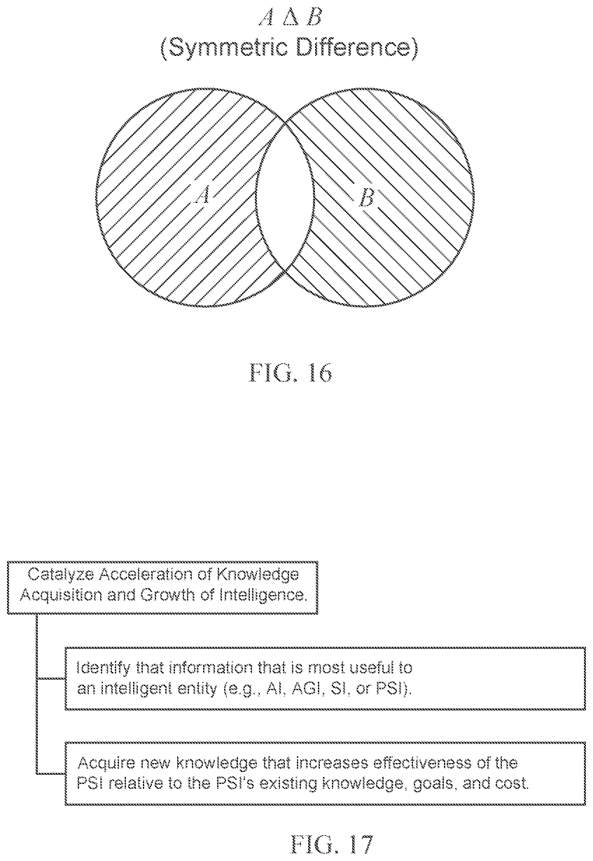

For example, consider two datasets. Where the two sets intersect, there is no new information. However, the sum of the non-overlapping areas of the sets (known as the Symmetric Difference in set theory) represents the new information contained in the datasets, relative to each other. FIG. 16 illustrates the Symmetric Difference of two datasets, A and B, graphically using Venn diagrams. The shaded area is the Symmetric Difference.

The datasets can contain events that have already occurred (e.g., static “snapshots” of existing events), or the content of the datasets can change over time. Some examples might help.

Static Differences: AI #1 knows everything in the Encyclopedia Britannica. AI #2 knows everything in Wikipedia. AI #3 is the knowledge of both AI #1 and AI #2 combined. The intersection between Wikipedia and Britanica represents things that both Als know: The intersection contains no new information for either AI #1 or AI #2. However, the Symmetric Difference-namely, the knowledge that is in Britanica and not in Wikipedia PLUS the knowledge that was in Wikipedia and not in Britannica—represents the new knowledge of AI #3. Time is not relevant in this example. The new information can be calculated by just comparing the static information in the two datasets of AI #1 and AI #2.

Differences Over Time: In contrast, consider the same two Als except that this time each is continuing to add to its knowledge over time. Now the informational calculations have to take into account not only the static encyclopedias but also whatever new information has been added to either AI over time. So, the intersection and symmetric difference are constantly changing over time.

The “information” in these examples is still a matter of “difference” but in this case it is not the difference between what was expected and what was observed (as in Classical Information Theory) but rather the difference between two static sets of info or two sets of info that are continuing to change over time.

Generally, the information added by any two events or entities containing information is equal to the Symmetric Difference between the two events. See FIG. 16.

For any two intelligent entities, the relevant measure of information is the relevant and useful differences between what one entity knows and what the other entity knows. This can be operationalized as differences in how the two entities behave (in the event that it is impossible to gain direct insight into the respective knowledge bases of the two entities, or in the event that behavior is simply more relevant than static knowledge).

In the intermediate term, humans care about the stuff AI knows that they do not and the way that Als behave that is different from how they would behave. To the degree that an AI behaves exactly as a human would behave, the AI contains no information relative to that human (although the AI might contain information relative to other humans or Als). If there were no differences between two intelligent entities (human or AI) it would be impossible to distinguish one from another.

When a human teacher has information that a human student does not it is this information differential that is at the heart of the learning/teaching xfer process. Similarly, any intelligent entity can only teach another entity (human or AI) if it has useful and different information.

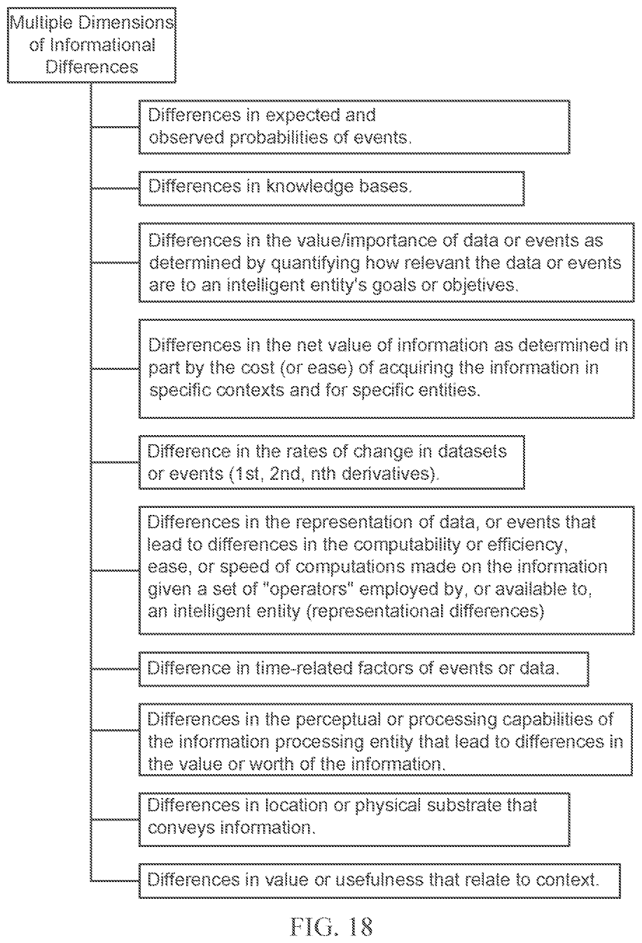

Perhaps some of this seems obvious, but it has profound implications for how information is measured. As we have said, as AGI becomes more intelligent and Super Intelligent, the chief concern will be to seek out new sources of information, as shown in FIG. 17. This information could be measured in terms of surprisingness (as Shannon suggested). Alternatively, it could also be measured in terms of differences in knowledge bases or behavior or construction of two entities. Although, arguably, one way of measuring may sometimes be convertible into the other, classical information theory will be more directly relevant and easier to use for measuring things like the information being sent over a limited capacity communications channel, whereas the more general approach of KIT is more useful in many practical applications of information theory to increasing the intelligence of AI, AGI, and SI.

Specifically. KIT enables methods that take account not only of how surprising an event is, but how much an event differs from another event and also how relevant (to the goals of an intelligent entity) the event is. The ideas of quantifying differences in knowledge, as well as goal-relevance, in addition to quantifying how unlikely an event is, represent key distinctions between KIT and Classical Information Theory.

Multiple Dimensions of Information in KIT (as generally shown in FIG. 18)

Now that we have developed some intuitions and provided some examples showing how KIT differs from Classical (Shannon) Information Theory, let us list and explain some of the different dimensions of KIT that have practical implications for using KIT as the basis for catalysts that increase the knowledge and intelligence of an AI, AGI, SI or PSI. Again, at the highest level, “difference” is the key concept in KIT. The differences that are indicative of information can include, without limitation, the following dimensions:

1) Differences in expected and observed probabilities of events (Classical Info Theory).

Based on the principles of Classical Information Theory described above, more unusual events contain more information. All other dimensions being equal, an AI might choose to pursue an information source based solely on how surprising, unusual, or unlikely the events that it contains are. However, in KIT, other “dimensions of difference” also play a role as explained below. This implies that Shannon-sense information is not always, or even usually, the best means of discriminating between two potential informational targets. However, it may be a valid means if other dimensions, such as information relevance and goal-relatedness are held constant. If an AI cannot evaluate a potential information source along multiple dimensions (e.g., if it does not know the goal-relatedness or relevance of a piece of information), then Shannon-sense information content could be used as a default metric for determining what the AI should pursue.

2) Differences in knowledge bases (e.g., as in the symmetric difference examples above).

In practice, it is only the filling in gaps of the missing information that allows an intelligence to acquire new behavior and thought patterns. If an AI encounters a rare event, which has high information content in the Classical Information Theory paradigm, but the AI already knows that piece of information, the new information may not change the behavior of the AI at all. The rare event would convey little information in the KIT sense, once the existing knowledge base of the AI is taken into account.

3) Differences in the value of data or events as determined by determining how relevant the data or events are to an intelligent entity's goals or objectives (Goal Relatedness).

As an example of goal-relatedness: consider that most Als will have a goal of improving their learning abilities as much as possible. Therefore, acquiring new information related to improving AI learning may be more valuable compared to acquiring new information in another domain, even if both specific pieces of information are equally rare and have identical information content in a “Shannon” sense. That is, most AI would prioritize information on how to learn more highly than information about, say, “art history.”

That said, at some point, if everything that can be discovered about machine learning has mostly been discovered, and if there are huge diminishing returns in trying to find even a very slightly unusual new piece of information about machine learning, and if the AI had a goal to learn everything, eventually it will focus on art history. If the AI knows nothing about machine learning. that time when it focuses on art history may be far away. If the AI knows almost everything about machine learning and nothing about art history, it will take a look at art history sooner. In this example we can see how the dimensions of Goal Relatedness and Differences in Knowledge Bases interact as the AI attempts to estimate the value of a potential information source.

4) Differences in the net value of information as determined in part by the cost (or ease) of acquiring the information in specific contexts and for specific entities (Cost/Value).

Implicit in the idea of “diminishing returns” mentioned above is the notion of cost. As an AI learns more and more about a subject, the cost of acquiring new information (which is rarer and requires more search or computation to acquire) increases. Thus, practically speaking, to maximize learning, an AI must also have a cost model so that it can weigh the choice (for example) or acquiring one rare piece of information (at great cost) against the cost of acquiring one or more different (somewhat less rare) pieces of information, which together might help the AI learn faster than the single rare piece of information, at greatly reduced cost. Thus, although an AI can be guided by the theoretical measures of information discussed below, in practice economics and the principle of acquiring the most useful information at the least computation cost, will also come into play.

5) Difference in the rates of change in datasets or events (1st, 2nd, nth derivatives).

Consider that one dataset might be relatively static. For example, it might contain historical information about weather patterns that occurred in the past. Another dataset might be constantly changing—e.g., a dataset on weather patterns that is updated daily. Yet another dataset might contain weather patterns in real-time, updated every 100 msec. Even if the datasets contained identical informational value in a Classical Shannon sense, the fact that they are updated at different rates might mean that there is different value associated with datasets. More generally, the rate at which data changes conveys additional (derivative) information beyond the information in the dataset itself.

6) Differences in the representation of data, or events that lead to differences in the computability or efficiency, ease, or speed of computations made on the information given a set of “operators” employed by, or available to, an intelligent entity (representational differences).

A common expression is that “a picture is worth a thousand words.” This expression is an implicit recognition that representation of information maters. For an intelligent entity equipped with certain visual processing “operators”, more information can be extracted more easily from an image than from a long string of text. Therefore, the modality of the information, or more generally how information is represented, maters with regard to the value of the information. Even if it were possible to capture in words exactly what appears in an image so that there was an informational equivalence between a textual and graphical representation of an event, the computational power required to use the information would likely be different depending on the capabilities (or available “operators”) of the information processing entity. Therefore, the value of information depends in a non-trivial way not only on probability in classical Shannon sense, but also on the way the information is represented and the match between this representation and the operators possessed by the intelligent entity that wants to use or process this information.

7) Difference in time-related factors such as frequency, timing, age, speed-to-access, or perceivability (due to very rapid or very slow change) of events or data.

Older data may be less valuable than more recent data. Data that takes eons to collect may be less valuable than data that can be collected immediately. Events that happen too fast for an intelligent entity to perceive, while theoretically containing information, contain no useful information if the entity is unable to perceive them. All of these dimensions affect the information value of the event, from the practical perspective of an intelligent entity trying to increase its intelligence via use of the information.

8) Differences in the perceptual or processing capabilities of the information processing entity (e.g., differences or events that are too small, too rapid, too slow, too large, or outside the range of an entity's perceptual apparatus cannot be detected and therefore carry no information for THAT entity but might carry information relative to a different entity).

Expanding on the idea of perceivability introduced in (7), there are dimensions other than speed (e.g., size, or “feeling”) that may or may not be perceived depending on the capabilities and operators of the intelligent entity. Thus information, in KIT, is thought not only as being comprised of differences in some sort of absolute terms, but also differences relative to an entity that is trying to use the information. In some non-trivial sense, there is no information without an observer or intelligent entity using the information. Differences in perceptual abilities of the observing entity therefore have a bearing on how valuable an informational event is. Unperceived and undetectable events are generally of little value, unless they have consequences from which their existence can be inferred. Otherwise, like the tree that falls in the empty forest, there is no noise or at least no noise that makes a difference.

9) Differences in location or physical substrate that conveys information (e.g., distributed vs. centralized information: holographic vs. discrete or quantized information, silicon intelligence vs. carbon-based or biological intelligence).

Information that is distributed across many intelligent entities such that all entities are needed in order to make sense of the information, is different from information that is centralized and available for use immediately and completely by a single entity. Similar to the situation where information is represented differently and therefore has more or less value depending on the available operators of the information processor, the physical characteristics of how information is represented, including but not limited to, the substrates on which information is encoded can affect the value of the information. Moreover, the physical substrate or medium of the information itself can convey meanings as in Marshall Mcluhan's famous statement: “The medium is the message.”

10) Differences in value or usefulness that relate to context.

Context (or context factors) refers to differences related not just to factors such as the culture, technology, knowledge, goals, representations, perceptual abilities, etc. of a specific intelligent entity, but also to the culture, technology, knowledge, goals, representations, perceptual abilities, etc. of other (intelligent) entities that form a context (or group of context factors) for the first entity. The value of information depends not just on the events and the rarity of events in an information stream itself, but also on the context surrounding the events. Information about making fire shared with an individual who does know how to make fire has a different value depending on whether it is just that one individual who lacks fire-making knowledge or whether the entire culture in which the individual lives lacks fire-making knowledge.

The situation is not just a matter of comparing the new information to knowledge already possessed by a single intelligent entity. The entire context, and the knowledge of all intelligences into which the new information is introduced, must be taken into account in order to fully evaluate the usefulness of the information. Similarly, just as one could take the symmetric difference between the knowledge possessed by two individual intelligences, it is also possible to do this with any arbitrary number of intelligences and any arbitrary number of knowledge bases. Every dimension of difference might be evaluated differently depending on the amount of information context that is taken into account.

Note that this principle applies even to Classical information theory. For example, a certain string of characters might appear unusual and to contain a large amount of information if it is compared to just one paragraph of text that has none of the characters. But if a larger sample is used—one in which the exact same characters appear frequently and are unsurprising—the assessment of the information contained (even in the classical sense of “how surprising is this sequence of characters?”) can change drastically. So, context can affect every dimension of informational difference.

### Estimating the Value of Information

In our discussion of KIT and some of its dimensions, we have emphasized information as consisting of differences, and more importantly useful differences. Just as an invention might be novel but not useful, technically a dataset could have Shannon information content and still be useless. Therefore, in terms of catalyzing the development of intelligence, usefulness is paramount. But useful info that is already known has little value. That is where novelty or rarity comes in. In estimating the value of information, KIT takes multiple “dimensions of difference” into account as described above.

There are functions that can describe the relationship between the various dimension of difference in KIT. For example, for two pieces of information that are:
a) equally relevant to an Intelligence's goals, and
b) equally new to the Intelligence given its current knowledge state, but
c) which are unequal with regard to how rare they are (in a Shannon sense), the information with the higher Shannon-sense information might be pursued first. But if the cost of pursuing the two information sources was significantly different, or if one source of information dribbled in very slowly while the other was immediately accessible, or if other dimensions of difference proved relevant, these dimensions of difference could shift the estimation of the value of the source.

Generally. Information Value can be seen as a function of the dimensions (1-10) listed above, with different constants weighting the importance of each dimension. Other dimensions of difference may exist (or be discovered) as well, so different functions can be written and optimized to meet the objective of maximizing an entity's intelligence.

Since, this present technology is concerned with catalysts that allow AI. AGI, and SI to increase their intelligence, and since a key challenge in this regard is to identify the richness of a potential dataset, it becomes important to estimate information content (in the multi-dimensional KIT sense) as reliably as possible. We disclose several innovative, novel. non-obvious, and highly useful approaches to estimation of KIT information.

### 5.0 Exemplary Inventive Methods

One set of methods to catalyze the growth of intelligence centers on estimating the value of, and acquiring, the most useful data as efficiently as possible. The basic process is to (as shown in FIG. 17):
1) Identify that information that is most useful to an intelligent entity (e.g., AI, AGI. SI, or PSI),
2) Acquire and ingest that information, enabling the entity to increase its intelligence.
3) Repeat from Step 1.

Within this basic process there are several inventive methods relating to different dimensions of difference as described in KIT above. Which method(s) to apply may depend on the goals of the intelligent entity and the dimensions of difference which are most relevant for increasing the intelligence of the entity. We detail some of these inventive methods below.

### 5.1 Methods Relevant to Classical Information Theoretical Notions of Information as Entropy

Beginning with the classical definitions of information as related to Entropy and the rarity of events, the present technology includes several novel and useful methods related to work that has been done in the field. These inventive methods include mathematical approaches, including without limitation Shannon Entropy Measures, Cross Entropy, RL Divergence, Log Loss functions. NLL, Kolmogorov and other compression algorithms methods and techniques, and other purely mathematical approaches to identifying information-rich datasets.

### 5.1a Kolmogorov Complexity and Compression for Determining Information Content

Kolmogorov complexity can be used as a measure of how complex a string or characters of a dataset is. More formally, as described in Wikipedia: “It can be shown that for the output of Markov information sources. Kolmogorov complexity is related to the entropy of the information source. More precisely, the Kolmogorov complexity of the output of a Markov information source. normalized by the length of the output, converges almost surely (as the length of the output goes to infinity) to the entropy of the source.”

There is also the notion of “conditional Kolmogorov complexity” of two strings—that is, the Kolmogorov complexity of x given y as an auxiliary input to the procedure. We can extend this concept to datasets and speak of the complexity of dataset X, given that an AI (e.g., an LLM) has already learned the information in dataset Y. To make this less abstract, consider the following example.

Imagine AI #1 has been trained on all the chess games and knowledge of the current human world champion. Imagine AI #2 has never even heard of the game of chess. Now a researcher wants to train both Als on a brand-new set of never-before-seen chess games. Both Als will find that there is some new information in the dataset since the games have never been seen before. But, AI #1 will find less new information than AI #2, because AI #1 has already been trained on chess games and many of the moves and patterns will be familiar to it. So, the dataset will contain less new information for AI #1 compared to AI #2.

If we calculate the conditional Kolmogorov complexity of the new chess-game dataset given AI #1's already extensive chess knowledge, we will find that the conditional complexity is less than if it is calculated conditioned on AI #2's (non-existent) chess knowledge. Now,
1) since certain compression algorithms exist in the art that compress information, and 2) since the amount of compression that these certain algorithms can produce is proportional to the Kolmogorov complexity, and
3) since Kolmogorov complexity (as cited above) can be used as a measure of the amount of information that a dataset contains,
4) it follows that certain compression algorithms (that compress proportional to Kolmogorov complexity) can be used to determine the information content of a dataset.

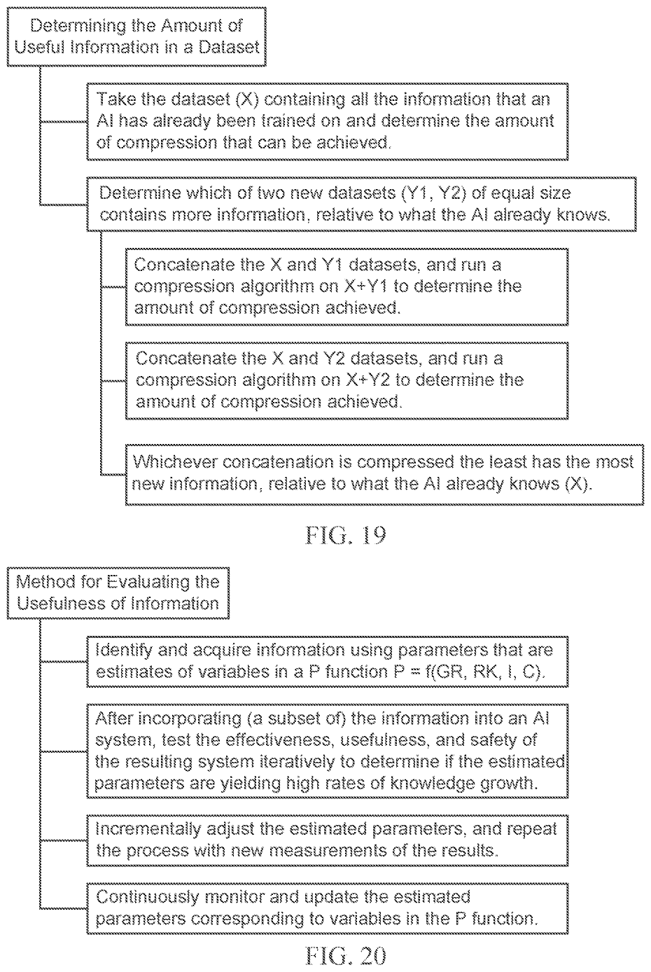

Moreover, by implementing the idea of conditional Kolmogorov compression (as described below and as shown in FIG. 19) it is possible to determine the amount of useful information in a dataset for any given AI, as follows:
1) Take the dataset “X” containing all the information that an AI has already been trained on and determine the amount of compression that can be achieved, Cx.
2) Now to determine which of two new datasets of equal size, Y1 and Y2 contains more information, relative to what the AI already knows;
a. Concatenate X and Y1. Then run the compression algorithm on X+Y1 to determine the amount of compression achieved.
b. Concatenate X and Y2. Then run the compression algorithm on X+Y2 to determine the amount of compression achieved.
c. Whichever concatenation is compressed the least has the most new information. That is if X+Y1 compresses to a smaller file size than X+Y2, then Y2 has more new information than Y1, relative to what the AI already knows (X).

Since running compression algorithms is much more computationally efficient than training Als via multiple epochs of deep learning, this approach of determining the new information content of a potential dataset, conditioned on what an AI has already learned is not only mathematically rigorous and computationally efficient, but also highly novel and useful.

This method can be extended further, increasing its usefulness, if the datasets to be compressed are not represented as character strings or pixels, but rather as higher-level concepts. For example, the Kolmogorov complexity of every character I ever produced in all my writings and emails may not look very different than the complexity of every character that some other random person produced in all their emails. But if we encode words rather than characters, more differences emerge. And if we encode topics and concepts and inter-relationships between concepts instead of just words, even more differences in the thinking between two people will emerge. By encoding at the appropriate level, matching the “information chunks” that humans use to think or create, it is possible to generate maximum contrast between two human sources of information.

If an AI is seeking out novel information from individual human intelligences, for example, it can use compression algorithms that use concepts or words as the atomic elements (rather than characters or pixels) to maximize the contrast and highlight the informational differences between the new source of information and what the AI already knows. Once it has determined the information value of a new dataset using, without limitation, techniques such as compression to estimate Kolmogorov complexity or “entropy” contained in the dataset, it can prioritize seeking the most useful new information as discussed in other sections of this present technology.

### 5.1b Cross Entropy and KL Divergence

Cross-entropy is a measure from the field of information theory, building upon Shannon Entropy and generally calculating the difference between two probability distributions. It is commonly used in machine learning as a loss function, e.g., it can be a metric for improving the performance of LLMs and other AI agents. It is closely related to KL Divergence that calculates the relative entropy between two probability distributions, whereas cross-entropy calculates the total entropy between the distributions. Cross Entropy, KL Divergence—and especially estimations of these measures—are useful in the context of the present technology as means to identify potentially information-rich datasets. Recall, from the discussion above, that a key objective for any AGI or SuperIntelligence desiring to increase its intelligence and power as quickly and efficiently as possible is to identify the datasets that contain the most new information (operationalized as Shannon Entropy, Cross Entropy, KL Divergence, or other information measures).

In many situations, for example language modelling, cross-entropy needs to be measured but the required probability distributions (of for example words or phrases) may be unknown. If the true probability distribution is unknown, cross-entropy cannot be directly calculated. In these cases. an estimate of cross-entropy can be calculated using formulas and approaches well known in the art of machine learning. Generally, the accuracy of the estimate depends on the size (N) of the test set and the training set. As one would expect, typically, the larger the training set and the larger the test set, the more accurate the estimates will be. These approaches are similar to running Monte Carlo simulations where the test set is treated as samples from the “true” probability distribution. More generally, these approaches are examples of purely mathematical approaches that ultimately traces their validity back to Shannon's work and fundamental principles of Information Theory. While useful for improving LLMs and other agents trained on datasets via existing machine learning techniques, the approaches represent only some of the tools that an AGI or SuperIntelligence might employ when trying to determine which datasets to pursue to catalyze its learning and growth.

### 5.1c Limitations of Entropy-Related Methods

The main limitation of the mathematical approaches, including without limitation Shannon Entropy Measures, Cross Entropy. RI. Divergence, Log Loss functions, NLL, Kolmogorov and other compression algorithms methods and techniques, and many other purely mathematical approaches to identifying information-rich datasets, is that they are “event-based” conceptions of information, whereas, for practical purposes, not all events convey equally useful and valuable information. The wonderful virtue of Shannon Entropy and other mathematical approaches is that they make the notion of information rigorous and mathematical. But just because something can be specified rigorously does not mean that the “something” is useful.

It is a bit like the old story of searching for one's keys in the dark under the streetlamp. When asked why he was looking for his keys there, the searcher replied, “because that's where the light is.” Of course, that is useless if the keys were lost somewhere else! Similarly, the mathematical “light” is in the area of Shannon Entropy. Cross Entropy, and related formulations. But is that where the information that we are interested in can be found? What if the types of information that is most useful to AI and AGI is not always (or even mostly) the information with the highest entropy?

Completely new, novel (and more useful) conceptions of information may be needed. KIT is a conception that is complementary to, and can be used in conjunction with, the Shannon Entropy approach described above. In the present technology disclosure, using the KIT framework, enables some new methods that help AGI and SuperIntelligence maximize its growth in intelligence and power.

### 5.2 Goal-Relatedness Methods

Goal-relatedness, as described in KIT, is a completely new and novel approach to quantifying information. Whereas classical Information Theoretic (Entropy-based) approaches stem from a decades old paradigm of trying to encode information efficiently for transmission over a limited capacity channel (the problem Shannon was working on at Bell Labs when he invented the field). Goal-Relatedness starts with a different problem.

Conceptually goal-related information refers to a measure of information in which the more the related a piece of information is to a particular goal, the more information that piece contains. In this sense, goal-related information is highly relative. Whereas Shannon information conceives of information as an absolute quantity that can be measured relative to a known or estimated probability distribution, goal-related information is always relative to an agent (intelligent entity) and its goals or objectives. If a piece of information contains the exact solution for achieving a particular goal, it can be said to have maximum information content, relative to that goal. Especially important is the insight that the information may have relatively low Shannon Entropy while still having high goal-relatedness.

Unlike Shannon-sense information (or [conditional] Kolmogorov complexity), goal-relatedness can and must be determined by the intelligence itself. Any PSI is capable of problem-solving using, at a minimum, a general “search through a problem space framework” as described in Newell and Simon's book, Human Problem Solving, as implemented in many AI programs using heuristic search, as elaborated in my prior issued patents, the WorldThink Whitepaper, the PPAs cited above, and other research on problem solving and sequential operation of LLMs that is well known in the art. In all of these conceptions of problem solving, the problem solver has goals.

As shown in FIG. 10, one of the most basic heuristics for achieving the goals is “Mean-Ends Analysis.” In Means-Ends Analysis (“MEA”), the problem solver examines the gap between the current problem state and the goal state and tries to apply an “operator” to reduce or bridge the gap.

To apply the MEA heuristic, the problem solver, or intelligence, must have some way of determining which operator to apply. This is done by assessing or estimating how related (or effective) each potential operator would be at bridging or reducing the gap between “where you are” and “where you want to be.”

Just as there are evaluation functions that every intelligent entity has for choosing what brings the entity closer to its goals, so too there are evaluation functions for determining the “goal-relatedness” of a particular piece of information. For example, if the goal is to make a fire in the wood without matches or fire source, information about fire making using just the materials one finds in the woods, would have high goal-relatedness. Information about art history would have low goal-relatedness. The problem solver would rather have common knowledge about fire-starting than extremely rare knowledge about art history. Here, and generally, goal-relatedness trumps Shannon-sense information value or absolute rarity.

One way to think of this is to imagine an AGI or SuperIntelligence with a single goal-let us say to extract maximum profits from the financial markets. For such an entity, faced with a choice of potential datasets to pursue and limited resources, it must choose the datasets that will help it achieve its goal the most. Even though it might have already learned so much about the financial markets that any new financial dataset contains relatively little information in the Shannon sense (e.g, most of the information in the dataset is already easily predictable from what it has already learned), a new financial dataset may have higher goal-related information content than a dataset on Art History (even if the Art History dataset has much higher cross entropy since the AI agent previously knew almost nothing about Art History).

Goal-related information measures, operationalized not as how predictable a new bit is from previous bits, but rather as how effectiveness in goal realization increases with the new information as compared with the situation of not having that information, are much more important and useful for AI than Shannon Entropy alone. In fact, Shannon Entropic measures—although widely used and treated as if they are the main way useful way of thinking about information—are actually a quite crude approach, to be used only when goal information is not present. In the absence of any information about an entity's goals, it makes sense to pursue datasets with new and high Shannon Entropy measures. But if the goal is known, then immediately it becomes more important to find the goal-related information rather than just the unusual and unexpected information.

Similarly, if an intelligent entity already knows a hundred ways to start a fire in the woods without matches, then the value of learning one more way, is less than it would be if the entity has a goal to start a fire and knew nothing about the subject. So, once a goal has been specified the relative value of a piece of information depends not only on the goal-relatedness but also on what the entity already knows that is also goal-related. Thus, concepts such as cross-entropy can still be useful, but they become conditioned on first subsetting the datasets (upon which the cross entropy or similar calculations will be run) to just data that is relevant to the goal at hand.

### 5.3 Mathematical Specification of Relevance

Together, goal relatedness, and Shannon-sense information (colloquially “rarity”) are the primary determinants of how useful or “Relevant” a piece of information is likely to be to an intelligent entity. Combining measures (or typically, estimates) of the usefulness of a piece of information with estimates of the cost of acquiring the information results in an evaluation function that can guide AI towards acquiring the most useful information at the least cost, resulting in maximum growth in intelligence given any set of computational resources constraints.

Assuming a constant cost of acquisition, pursuing the most useful or Relevant information first, and with highest priority, an intelligent system can maximize the growth rate of its intelligence. This is a key insight.

Relevance might be objectively quantified, without limitation, by using measures of relative compressibility, cross entropy. KL divergence, and other methods well-known in the art as described above. However, other methods include, for example, measuring the semantic distance between concepts in the new dataset and concepts that reflect the problem solver's goals. Post-hoc measures of how effective semantically similar data was for solvers with the same or similar goals, might also be used. These new sets of metrics have to do with determining the goal-relatedness or conceptual-relatedness of the dataset or information, given an entity's goal.

Thus, the novel and useful approach of the present technology, thinks of information as having multiple dimensions, including but not limited to: Entropy, goal-relatedness, and relevance where:
a) Entropy refers to the classical Information Theoretic approach to measuring information (pioneered by Shannon, and elaborated in contemporary approaches/measures like cross-entropy and KL divergence, for example);
b) Goal-relatedness refers to a metric that quantifies the match between a piece of information (or dataset) and the best solution to a goal; and
c) Relevance refers to the relative value of a piece of information (or dataset) to an entity given what it already knows (similar to cross-entropy) AND its goals (thus conditioning calculating relevance measure on first determining goal-relatedness.

One might define Relevance (R) as a function of Entropy (E) and Goal-Relatedness (GR):

$$R = f [ GR , E ]$$

More specifically, one could write:

$$R = K * GR * E$$

meaning that relevance is the multiplicative product of Goal-Relatedness and one or more forms of Shannon Entropy as modified by a constant, K. The constant K will vary depending on which measure of Shannon Entropy (e.g., without limitation: cross entropy, KL divergence, log loss, nll, or some expression related to compressibility) is chosen.

Note that this function neglects other dimensions of difference in KIT that might also be included in an expanded version of the function if such dimensions are relevant to the entity and/or its goals. However, the basic insight underlying this simple version of the equation is that Relevance depends on how goal-related a piece of information (e.g., without a limitation, a dataset) is to the intelligence as well as on how much “surprising” or unaccounted for information is contained within the piece, relative to the information already “known” by the intelligence.

One can achieve a high Relevance by finding a new information source that is extremely goal-related, that just contains a little new information, or one could achieve high Relevance by finding a less goal-related source that has a high quantity of unexpected or surprising information in the piece of info that is goal-related. That is, R can be high if either GR or E is high, provided the other variable is not too low. This implies a multiplicative relationship as the simplest first approximation of the optimal value for Relevance—an important concept in KIT.

### 5.4 A Simple Evaluation Function for Seeking Useful Information

Here we attempt to provide additional rigor for the ideas about seeking information as a function of goal-relatedness, the relevant knowledge of the system, and information value in the Shannon sense.

$$P = f ( GR , RK , I , C )$$

where,

P is the priority rank of the information source among all potential information sources being considered.

GR is the goal-relatedness of the information defined as the frequency with which the information source appears in the same context as the goal, which further can be operationalized as the conditional probability that the information source will appear in a training set in the context of the goal, or words related to the goal.

RK is relevance of the knowledge to the system, operationalized as the inverse of the degree of overlap between the information contained in the system and the (estimate of) the information contained in the information source. To account for the fact that information sources may contain much more (or less) information than the system, this variable can be normalized to provide a per-byte relevance metric.

I is the Information content (in the sense of Shannon's Information Theory, or alternatively in the sense of [conditional] Kolmogorov complexity, as discussed above) of the information source; specifically. I can be thought of as (an estimate of) how rare an information source is and how likely it is to provide new and unexpected information. Formally, it is a quantity defined as 1/logP, where logP is the log of the probability of the informational event: thus, the more rare an event is, the smaller the value of logP, and the larger the value or 1/logP and the more information there is in the event.

C is a cost function that reflects the cost of acquiring the information: this may further depend on variables including availability of computing resources, efficiency of methods or algorithms for acquiring the information, royalties or other costs paid to the owner(s) of the information, etc.

While it is tempting to specify values for some of these variables, or at least whether the variables should be added, subtracted, multiplied, or raised to an exponent, the truth is that how the variables are combined depends on the preferences of the PSI owner.

For example, an owner may want any new information available related to the goal of stopping an impending nuclear war, and in this case might not care if the information has overlap with existing information or if it is expensive to acquire, so long as it is relevant to the goal. In this scenario, GR would dominate, I would be important, RK would be less important, and C would not mater since we do not care how much it costs if our survival is at stake-unless resources were constrained (i.e., we had only limited computing resource available).

On the other hand, if the PSI owner wants to improve the chess playing ability of the PSI within a fixed budget of $50, then GR is important in so far as the information must be related to improving chess skill, RK is also very important to avoid gathering redundant knowledge and thereby increase efficiency, C is very important because we want the most chess improvement “bang for the buck”, and I is not so important because we probably don't need a lot of rare cases if we can get a lot of improvement by examining common mistakes or common information (sources) that our PSI simply doesn't know about.

In the exemplary implementation, the PSI would take into account all of the variables in the P function but weight the variables differently depending on user input and/or knowledge of the users and their intentions and specifics of the problem. The advantage of the P function is that it provides a framework for rapidly prioritizing the types and sources of information to pursue.

In one exemplary implementation, the system would gather information using some set of parameters for the variables in the P function, then test the effectiveness, usefulness, and safety of the resulting system iteratively to determine if the parameters are yielding high rates of knowledge growth. Then the parameters would be adjusted incrementally, and the process repeated with new measurements of the results. In this way, using well known methods such as gradient descent or hill climbing, the variables in the P function can be continuously monitored and updated based on their effectiveness.

With reference to FIG. 20, to the degree that everything except final/periodic safety and ethics review could be delegated to PSI, the system could run automatically, getting better and better and identifying useful information in an accelerating manner. The loop could be expanded to include earning money or otherwise increasing resources available based on new knowledge obtained. In this case we would have a positive feedback loop in which the PSI acquires knowledge, earns money from the incremental knowledge boost, and then spends that money to acquire even more knowledge which allows it to earn even more. The positive feedback loop (with humans optionally in the loop for, at a minimum, the essential values and ethical checks) could rapidly and automatically improve the information acquisition process resulting in an ever-more-powerful SI that improves itself automatically.

### 5.5 Exemplary Innovative Methods for Estimating Kaplan Information

As discussed above, information in the KIT sense may depend on measures of Shannon Entropy X measures of goal-relatedness. Since many methods related to Shannon Entropy are well known in the art, including but not limited to those discussed above and later in this disclosure, one most critical thing is to have good ways of estimating Goal-Relatedness.

### 5.5a Importance of Representation

Traditional approaches to Information Theory take a purely mathematical view that estimates the probability of events that cannot be predicted well from known information (e.g., Shannon Entropy). However. KIT starts from a different place. Rather than defining information in terms of how unusual an event is, KIT typically begins with how goal-related the event is. In contrast to classical approaches to Information Theory that discard a huge amount of information, KIT considers higher-level representations that group bits into chunks and chunks into concepts, and concepts into solutions that achieve goals.

At each of these levels, new information is added with regard to how the lower-level information should be grouped. That is, the relationships between bits are important, not just the bits themselves. Moreover, the current “brute force” approach of applying hundreds of millions of dollars-worth of computational resources combined with huge amounts of data, attempts to crudely recreate intelligence by mimicking patterns found on the internet without really understanding them or knowing how they might relate to new problems.

Why should we limit ourselves to such crude techniques and informational methods when a universal representation for problem solving exists? When we can determine an intelligence's goals and have a fairly good idea of whether information would advance or hinder these goals, why should we treat information as if it were just bits being sent over copper wires?

### 5.5b One Method for Estimating Information Value & Catalyzing Intelligence Growth

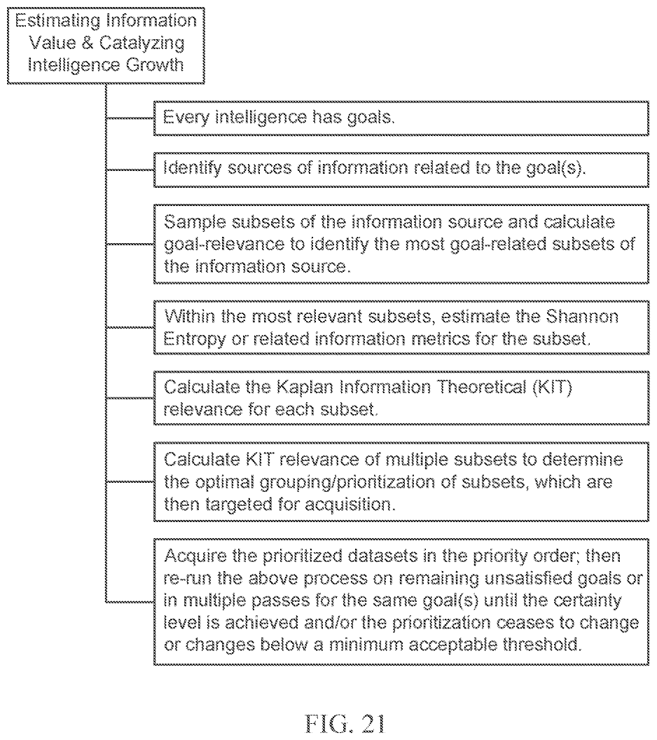

With reference to FIG. 21, the present technology attempts to build self-driving cars by modelling the quantum physics of sub-atomic particles, nor should we attempt to catalyze intelligence by throwing brute force computing power and crude algorithms at every bit on the internet! A better way exists, to wit:

1) Every intelligence (that is intelligent in the way that humans understand) has goals. Specify the goal(s).

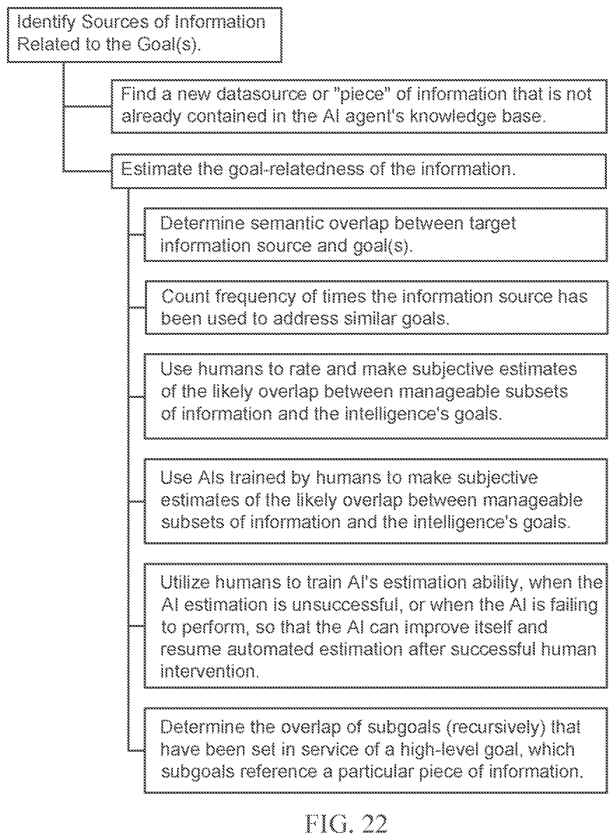

2) Identify sources of information that are related to the goal(s), as shown in FIG. 22.
a. Find a new data source (or “piece of information). By definition this can be any information that is not already 100% contained (in a Shannon Entropy sense) in the intelligence already. That is the definition of “new.”
b. Estimate the goal-related of the information using techniques, including but not limited to the following:
   i. Semantic overlap between target information source and goal(s)
   ii. Frequency counts of how many times the information source has been used to address similar goals (of which there are many means for to calculate similarity between goals).
   iii. Using humans to rate and make subjective estimates of the likely overlap between manageable (for humans) subsets of information and the intelligence's goals.
   iv. Using Als trained by humans to make subjective estimates of the likely overlap between manageable (for humans) subsets of information and the intelligence's goals: this being much faster and more scalable that using humans once the estimation methods have been trained into AIs.
   v. Using the methods in iii and iv, with the provision that if the AI estimators are unsuccessful or performing below an acceptable threshold, the humans are brought back into the loop to train and explain why the AI is failing to perform well, such that the AI can improve itself and resume automated estimation.
   vi. Determining the overlap of subgoals (recursively) that have been set in service of a high-level goal, which subgoals reference a particular piece of information.

3) Sample subsets of the information source and recursively calculate goal-relevance in an attempt to identify the most goal-related subsets of the information source (e.g., without limitation, the dataset). The granularity of this recursive analysis is determined, in the exemplary implementation, by parameters set by users, the intelligence, or other algorithms in order to satisfy certain constraints on calculation time, computation and memory resource, available resource, and thresholds set to kick in when there are diminishing returns of a certain degree.

4) Within the most relevant subsets, estimate the Shannon Entropy (or related measure, without limitation, cross entropy. KL divergence) of the subset.

5) Calculate the Kaplan Information Theoretical (KIT) relevance (e.g., the product of Goal-relatedness and Entropy) of each subset.

6) Calculate KIT relevance of multiple subsets, grouped by 5) and/or adjacency metrics, to determine the optimal, or a good-enough first approximation of the optimal, grouping of subsets, which are then targeted for acquisition.

7) Acquire the prioritized datasets in the priority order: then re-run 1)-7) on remaining unsatisfied goals, or if high certainty is desired, re-run 1)-7) in multiple passes for the same goal(s) until the certainty level is achieved and/or the prioritization ceases to change or changes below a minimum acceptable threshold.

### 5.6 Automated Methods and Safety Considerations

While human interaction with, and approval of, a PSI's (or other intelligent entity's) knowledge acquisition efforts is desirable, pragmatically, human reaction time is slow compared with the speed of PSI. Further, humans have limited time and may not want to devote significant time to improving their PSIs. Consequently, the main mode of knowledge acceleration for PSI's must be automated.

Companies like Anthropic have already recognized the limits of human abilities to train AI, resulting in automated learning techniques in which AI teaches or supervises AI. Although it would be a grave mistake to delegate all supervision of AI to other Als, the lack of available human resources necessitates some delegation. Therefore, of critical importance are the methods for determining what is automated, what requires human oversight, and how to best deploy limited human resources while still achieving maximum learning rates for PSIs (and AI more generally). We attempt to address these issues, together with more detail on how to automate learning (since that is the greatest catalyst for PSI improvement) below.

I hope it is clear that regardless of the speedup that automation entails, humans must be laser-focused on values, ethics, and fundamental goals, while allowing PSI wide latitude to implement these goals, consistent with the values and ethics chosen by the owners of the PSIs.

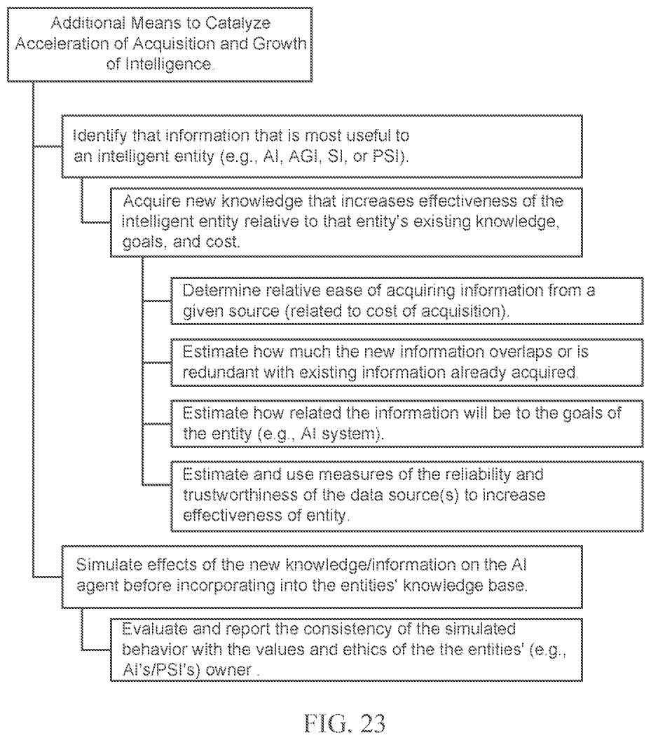

To accelerate knowledge acquisition and growth of intelligence in a safe and effective way, PSI must execute two methods, as generally illustrated in FIG. 23:
a) Acquire new knowledge, automatically seeking knowledge that increases effectiveness of the PSI relative to the PSI's existing knowledge, the PSI's goals, and the cost. Shannon sense information metrics (or estimates thereof) can be useful in identifying sources of information to pursue. Other factors, including but not limited to, the relative ease of acquiring information from a given source (related to cost of acquisition), understanding and estimating how much the new information overlaps with or is redundant with existing information already acquired. estimates of how related the information will be to the goals of the system, and estimates of reliability and trustworthiness of the data source are all important to take into account.
b) Before committing the new knowledge to the PSI's knowledge base, the effects on the PSI's behavior with the new knowledge must be simulated. Specifically, the consistency of the simulated behavior with the values and ethics of the PSI's owner must be evaluated and reported to the owner in a way that allows the human owner to provide feedback and guidance in a prioritized manner such that if the human has limited time, that time is spent first on most critical issues related to safety and ethics and then to less critical items. (While theoretically, and without limitation, the methods in this second step could be to provide feedback based on other priorities besides safety and ethics, it is imperative for the safe and responsible use of PSI, and AI generally, that safety and ethics come first).

Some of the implementation details for 1) have been described above and in previous commonly owned US provisional patent applications, so let us turn to 2). Humans are much better at recognition than recall. Similarly, they are better at recognizing ethical or unethical behavior, than they are at generating possible scenarios in which their PSI might behave badly or inappropriately. Therefore, an effective means of acquiring the necessary human supervision of a PSI that has just acquired new knowledge that it may incorporate into its knowledge base is to run simulation of the PSI's behavior with and without the knowledge incorporated. Then, allow the humans to determine whether the behavior has improved-specifically, but not limited to—from a safety and ethical perspective.

### 5.6a Automated Simulation Methods

One method is to run simulations of pre-determined ethical scenarios that are related to the knowledge areas that the AI is acquiring. For example, if a PSI is charged with acquiring new knowledge about the stock market, and techniques for profiting by trading, new versions of the PSI (with potential new techniques) could be required to participate in pre-set test simulations to ensure the PSIs do not engage in illegal activity such as “front-running” trades or trading on insider information.

### 5.6b Realtime Scenario Creation Methods

Another method is to create new scenarios in real-time based on the information acquired (and/or metadata about that information). For example, a PSI might sample YouTube videos published in real-time to gain data and knowledge about the changing preferences of human audiences and update its mode of interacting with humans based on what it learns is popular at the moment. Based on one set of sampled preferences, the PSI might simulate how it would behave in a variety of situations where the set of situations are dynamically created to be related to the information just sampled. To be concrete, if a PSI sets out to learn everything it can about a political candidate who has been recently accused of rigging an election so that it can advise its owner about best way for that candidate to be elected, the PSI might dynamically create a variety of scenarios where the bounds of ethical and legal behavior with regard to election rules are tested-even if such scenarios were not part of the standard set of ethics-testing scenarios prior to learning about the election-rigging accusations.

### 5.6c Adversarial Testing Methods

A third method is to use adversarial testing, where one version of the PSI deliberately attempts to misuse the knowledge, and another version of the PSI attempts to come up with rules, constraints, or modifications to the knowledge base so that the “malevolent” PSI is unable to misuse the new information for nefarious purposes. For example, an “evil” version of the PSI uses all the new knowledge it has gained about rigging elections, to come up with as many ways to misuse this information (i.e., break the law) as possible in service of getting a candidate elected. Then the PSI can suggest modifications or additions to the knowledge base that would prevent misuse of the election information. The human could review and approve or reject the new knowledge and/or proposed modification based on simulation results.

### 5.6d Simultaneous Scenarios

A fourth approach is to explore many possible scenarios in parallel by having multiple versions of the PSI, with and without the new knowledge, explore scenarios simultaneously. As dangerous scenarios are identified, these can be used as “seed scenarios” to develop variants that are potentially more dangerous still. PSIs can be charged with deliberately trying to “jailbreak” themselves so as to reveal potential safety and ethical vulnerabilities. This case could be similar to the case above, except that by generating many scenarios, the PSI may be able to come up with simple modifications that prevent many different “ethics” violations.

Generally, a useful heuristic in this regard, is for the PSI to test/suggest modifications that have low “degrees of freedom” and that do not overfit the problem. That is, rather than having a different specific rule to address all the different ways to “stuff the ballot box” a general prescription against any means that circumvents the one-person/one-vote principle might be more effective and simpler. One (not overly general) rule is typically better than many special-case rules, which can lead to a “whack-a-mole” problem of intractability. Initially, until PSIs develop the knack for coming with good rules, humans may be helpful in guiding PSIs towards rules that are effective without being overly general or too narrowly prescriptive.

When using adversarial methods, it is critical that the malevolent PSIs are contained in a simulated environment and that safeguards are used to prevent contamination of “good” PSIs with “evil” PSIs. Such methods are well-known in the art and used currently in areas such as anti-virus efforts, where viruses are created, contained, and studied, in an effort to develop anti-malware that can prevent such viruses from having negative effects. Whenever engaged in this type of work—i.e., creating a malevolent entity in order to understand it and counteract it-protective measures and protocols must be followed to ensure that the malevolent entity does not escape and proliferate.

In additional to keeping ethics and safety at the center of what humans do, it also makes sense to have humans focus efforts on those tasks which are relatively harder for AI or PSI to accomplish and to delegate to AI the tasks where huge memory and computational speed offer the most advantage. Since PSI and AI abilities are continuously evolving, the list of tasks where human ability exceeds AI/AGI/SI/PSI is continually changing, and generally shrinking. However, as of the writing of this patent, some of the areas where humans remain superior to AI include, without limitation:
1, complex multi-step problem solving.
2, solving problems where new representations are required which may not already be in the training sets for LLMs,
3, generalizing correctly and coming up with simple rules that encompass a large number of cases without being overly general or over specific.
4. drawing correspondences between vastly different areas where the correspondences are useful or practical from a human point of view;
5, empathizing with human feelings and emotions (as contrasted with saying the right things so as to give the appearance of empathy).
6, having a vested interest and deep commitment to positive human values that promote the welfare and benefit of humans (as opposed to simply adopting these values for pragmatic or conventional reasons), providing a sense of purpose to existence.

With regard to the testing of new knowledge sets, evaluating PSI behavior, and developing safeguards to prevent unsafe or unethical behavior by PSI, humans are currently superior to AI. Even if AI should surpass humans in this area in the future, the argument can be made that humans should remain in control of core ethical principles. Human ethics, even if flawed, should align AI since it is the humans that must live with the consequences of AI/AGI/SI/PSI decisions. Some might argue that humans must be protected from themselves, and that PSI should adopt the role of a more competent parent, but the applicant strongly disagrees with this position. Instead, it is argued that the purpose of human existence is intimately related to the freedom of self-determination-even if human actions are less than ideal from an AI's perspective.

### 6.0 Exemplary Inventive Catalysts for Increasing Intelligence Beyond Information Seeking

So far, we have mainly concentrated on inventive methods related to seeking and acquiring information that increased the intelligence of an entity by attempting to quantify the information content of datasets or events. We have discussed how Classical Shannon Entropy notions of information are useful but limited in this endeavor. We have described how a richer theory of information (KIT) enables additional inventive methods for finding information-rich datasets or events, by including other measures of information, or “dimensions of difference” in areas beyond just surprisingness or rarity of the information.

Now, we turn to inventive methods for catalyzing growth of an entity's intelligence that leverage a particular architecture for AGI, namely a system that achieves AGI. SI, and PSI via a collective intelligence network of (human and/or AI) agents. By identifying the areas where certain agents can teach other agents most effectively, it is possible to rapidly increase the intelligence of entities in ways beyond simply finding and assimilating information-rich datasets.

To the degree that humans currently have more expertise than AI at solving complex, multi-step problems, AI should generally seek to include humans in problem solving efforts, even if this slows the solution attempts so that the AI can observe the methods of the humans until it has learned all of the human representations and no longer can derive meaningful value from watching “how humans do it.”

Some of the discussion above, and earlier cited the commonly owned US provisional patent applications, describe a rigorous means for capturing all problem-solving steps and solution attempts so that they can be analyzed and used by AI to improve. Recall, that the notion of a universal problem space that can be formulated with operators enabling search through this space, can be applied to any problem. This method also results in an unambiguous, auditable record of solution attempts that can be used as the basis for learning.

In my view; current machine learning efforts, rely too much on brute force techniques of using huge amounts of computation and data, combined with relatively simple neural network algorithms to produce “black box” systems that mimic humans. To move to the next level of intelligence most quickly, the systems will need to learn more explicitly from human behavior. Humans also have a responsibility to teach values and ethics along with our knowledge. If we teach AI well, our future as a species looks quite bright indeed!

### 6.1 Importance of High-Level Representations

In any dataset or piece of information, some of the information is contained in the exact sequence of bits, some in the inter-relation of bits into concepts, some in the inter-relation of the concepts into sub-solutions, and some in the inter-relation of sub-solutions into the overall satisfaction of the intelligence's goals. This view of information is relative to an intelligence's goals. It does not talk about information as bits per se, although bits are important in the same way that sub-atomic particles are important (that is, they are the lowest level entities that comprise reality). Rather, we talk about information as it has meaning and makes sense to an intelligent entity that takes action in the world, which is at the level of satisfaction of goals.

To satisfy goals, we need a universal theory of problem solving in order to identify what the appropriate information units for analysis are. Yet despite this fact being quite clear, it has not been accomplished! Almost all machine learning techniques and approaches to AGI and SuperIntelligence, persist in the expensive, and resource-intensive process of trying to manipulate information at the bit/token level with no, or little, understanding of what is being actually taught to LLMs and other intelligent agents.

If instead, we were to focus on intelligences that have goals and will take actions to achieve those goals, the machine learning problem becomes immensely simplified. No longer must we labor with complicated and computationally expensive training techniques that result in “black box” Als whose performance is unpredictable and limited. Instead, we are liberated by the simple constraint that intelligences must have goals and take actions if we are to concern ourselves with them. By sub-sel ng possible information patterns in this way, we prune an enormous exponential tree of possible intelligences down to a manageable subset that we can address and help grow in a focused, deliberate, efficient and effective way. This is key insight.

Let U be the set of all possible intelligences that learn all possible information using existing machine learning techniques and all existing datasets run for all time until the Universe runs out of energy. Currently U is what machine learning starts with. It is suggested that great progress can be made very rapidly if we restrict our efforts, attention, and the present technology to I. defined as the subset of U that includes only goal-directed intelligences that take action. This may seem obvious when stated this way, but currently almost the entire field of ML is dealing with U rather I.

Once we deal with I, the natural question is:

What are the informational units most relevant to I? Are they bits, as Classical Information theory suggests?

Clearly not. Bits or tokens are relevant to U but we can do much better in the subset I if we use higher-level units of information more appropriate to the restricted scope of goal-directed intelligences. Specifically, the key informational “units” relevant to I are:
A) Goals and sub goals.
B) Problem States that describe the current state of the world related to the goals/subgoals.
C) Operators for moving from one state to another.
D) Evaluation functions and other information that helps determine the best operators to apply in service of goal.

KIT deals with goals, states, operators, and functions as the primary relevant information units rather than bits. By using this “higher-level” representation of information that is as general as it needs to be to accommodate all problem-solving behavior-—but is not so general as to describe every bit in the Universe-we are able to accomplish the goal of increasing the intelligence of any entity much more efficiently and effectively than by using classical Information Theory.

### 6.2 Acquisition of New Representations

We now turn our attention to one very important catalyst for SuperIntelligence. Despite the ability of SI systems to perform computations trillions of times faster than humans, the computation power depends on more than raw compute power or FLOPS. The performance of the system depends critically on what representations—and associated operators—are available to SI.

Returning to the example of chess, it is possible for an AI to learn from millions of games where each game is represented by pixels in a screenshot of moving positions. Then, by brute-force memorization and comparison of pictures, the chess program could generate winning moves, represented as pictures that are different from the picture representing the current board state. But this pixel representation is far inferior to, and much less computationally efficient than, a representation where each move is represented in standard chess notation. That notation, together with a representation of the allowable moves in chess can allow a system to play chess much better and more efficiently than a system that sees only pictures and has no representation of the game, the pieces, and the rules. Further, the pixel representation would make every game of chess with different-looking pieces (e.g., pieces made of marble vs wood) a brand new problem. Without knowing that a bishop is bishop regardless of what the piece is made of, the system would waste a huge amount of resources worried about the differences in what different chess boards look like and would have trouble generalizing chess knowledge from one type of chess set to another. Clearly the representation has enormous implications for how computationally efficient an entity (human or AI) is at solving any given problem.

This phenomenon is well researched in human psychology, and it is well known that the appropriate representation-colloquially known as “looking at the problem in the right way”—can mean the difference between solving or not solving the problem.

Humans are currently much better than AI at representing problems. Thus, any mechanisms that allow humans to explicitly teach AI certain useful representations can have the effect of greatly increasing the power and intelligence of AIs.

In order to teach AI new representations, we need a common architecture or framework for representing any problem. One such framework was invented in 1972 and explained in the book, Human Problem Solving by Allen Newell and Herbert Simon. This framework involves determining a set of operators that are associated with a representation. And then the problem solvers use the operators to solve the problem. In the chess example, the operators are the set of valid chess moves as defined by the rules of chess. The problem space is defined by the 8×8 chessboard and all possible moves. Although there are a huge number of possible moves, which makes chess complex, defining the operators enables humans (or other entities using the operators) to teach an AI new concepts and new representations. The pattern of a “fianchettoed bishop” for example, is a higher-level representational concept than the concept of a bishop placed at random, because it involves a specific pattern or sequence of moves. By “chunking” lower-level concepts into higher representations, it is possible to learn and play chess much more easily and effectively.

This idea of chunking is why intermediate and advanced chess players use terms like “the Ruy Lopez” or the “Najdorf Variation of the Sicilian Defense” to refer to complex sequences of moves and countermoves. Whereas a novice chess player, without these more sophisticated representations, thinks in terms of moving individual pieces here or there, the advanced chess player thinks in terms of entire strategies and groups of moves and possible counter moves. With the same amount of “thinking” the advanced player is able to consider many more situations, much more efficiently than the novice simply because the advanced player has better representations.

These advanced representations can be taught to any intelligent entities-including AIs—with the effect of multiplying the intelligence and power of the AI that has learned them. Commonly, humans refer to this phenomenon as “experience.” but actually “experience” consists of many thousands of patterns that have been learned, including patterns of patterns.

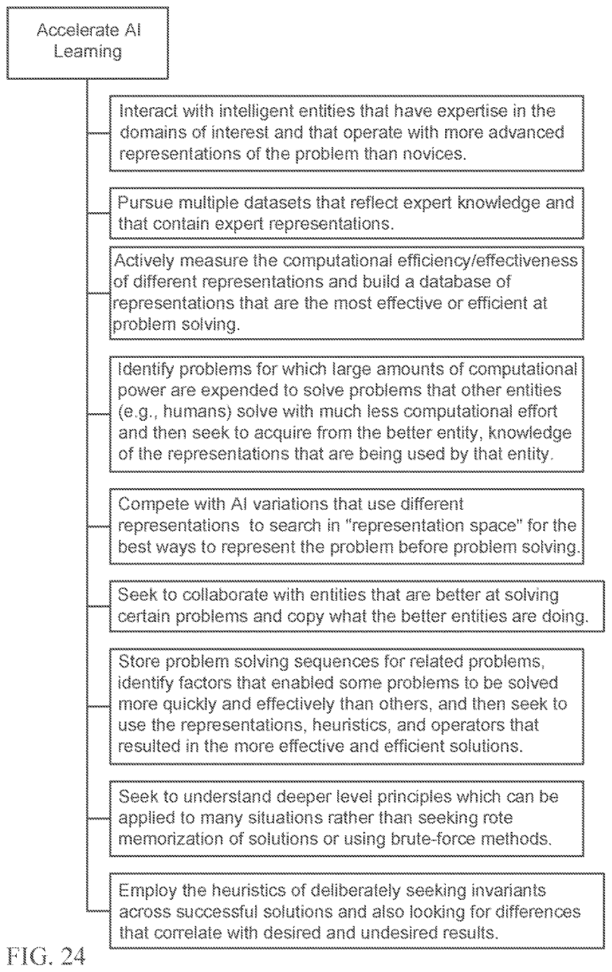

While AI can eventually determine its own set of patterns, via huge computational efforts expended on huge datasets that reflect human behavior, this approach is inefficient. To accelerate learning and as generally illustrated in FIG. 24, AI should, without limitation:
A) Interact with humans or other intelligent entities that have expertise in the domains of interest and therefore are operating with more advanced representations of the problem than novices.
B) Pursue multiple datasets that reflect expert knowledge and that contain expert representations.
C) Actively measure the computational efficiency and effectiveness of different representations and build a database of which representations are most effective and efficient at solving which type of problems.
D) Identify problems for which large amounts of computational power are expended to solve problems that other entities (e.g., humans) solve with much less computational effort and then actively query and seek to acquire from the better entity, knowledge of the representations that are being used by that entity.
E) Compete with variations of itself that use different representations in order to search in “representation space” for the best ways to represent (“look at”) the problem before jumping into problem solving.
F) Seek to collaborate with entities that are better at solving certain problems and copy what the better entities are doing.
G) Store problem solving sequences for many related problems and seek to identify the factors that enabled some problems to be solved more quickly and effectively than others, and then seek to use the representations, heuristics, and operators that resulted in the more effective and efficient solutions.
H) Seek to understand deeper level principles which can be applied to many situations rather than seeking rote memorization or brute-force methods.
I) Employ the heuristic of deliberately seeking invariants across successful solutions and looking for differences that correlate with desired and undesired results (e.g., solved and unsolved problems).

### 6.3 KIT-based Heuristics and Methods to Accelerate Intelligence

Specifically, here are some of the methods that increase the growth of intelligence, following the KIT approach.

Identify similarity between current goals, states, operators, and evaluation functions compared with past successful solutions that have been recorded. Use similarity to prioritize acquisition of data and use of information that is more likely to help solve the current problems.

Identify differences between the current problems and approaches to similar problems where the outcome was unsuccessful. Do not do what did not work in past similar situations. Do that which DID work in past similar situations.

Look for surprising or unusual differences between the current problem and similar problems. Determine whether the unexpected differences are a source of information that can be used to focus or direct attention to the differences that may need to be addressed.

Generally, prioritize use of information that closes the maximum gap between current state and desired state. If the information fails to close the gap, reduce the gap-size and attempt to close a smaller gap to a steppingstone towards the solutions. When a steppingstone is reached from which no further progress seems possible, focus analysis and attention on this step to determine why progress is blocked, perhaps resorting to other heuristics such as those mentioned above. In the worst case, where no progress can be made via any form of “hill climbing” jump to an earlier point in the decision tree and try a different branch. Continue going back to more and more general branch points in the decision tree and “jumping” to alternative solution paths with lower and lower expected success until one of the approaches pays off and you find a workaround.

### 6.3a Catalyzing Effects of Higher-Level Representations

Note that once AI is operating with more powerful representations that include operators, goals, and problem states, the AI can apply the “dimensions of difference” described in KIT to determine the value of specific sets of information that is represented at this higher level. That is, the principles and methods described above can be applied at any level of representation from bits/tokens all the way up to entire solutions, groups of solutions, and grand strategies. Just as higher-level programming languages provide humans with the ability to accomplish huge amounts of work with a single function call or line of code, so too higher-level representations allow AI or any intelligent entity to operate much more powerfully, efficiently, and effectively compared to using low-level representations like tokens that correspond to a syllable or character of text.

The power of human representations can be quantified by the amount of work, or the number of problem-solving steps that can be accomplished with a single “operator.” Similarly, the power of AI representations can be quantified in this way. Tracking the number of problem-solving steps (e.g., lower-level state transitions) that can be accomplished by the application of a single high-level operator is one way to measure the power and potential effectiveness of an AI or intelligent entity's representations. Currently LLMs understand and interact with humans by predicting the next low-level token using models with billions of parameters. Imagine what is possible if these LLMs or other AI agents operated not using low level tokens, but with more powerful concepts such as humans do. The set of concepts (and related operators) would include not only all human concepts and operators but also many more that AI could discover by analyzing relationships in data that humans could never hope to comprehend due to its vast size. When AI is able to develop such representations—e.g., by analyzing how humans chunk lower level representations into higher order representations and then copying this method—the intelligence of AI entities will increase dramatically with no required increase in computational hardware.

### 6.4 Exemplary Methods for Assessing Artificial Intelligence

A major challenge facing AI researchers is how to measure the level of intelligence exhibited by various AI agents including LLMs. Simple definitions of AGI, such as “AGI has been reached when an AI can perform any online task as well as the average human.” are intuitively useful but lack the specificity needed to help researchers make fine adjustments to their models to increase intelligence of AI.

### 6.4a Extension of Standardized Tests of Human Intelligence to AI

Fortunately, a wide range of standardized tests of human intelligence exist. A simple method for measuring the intelligence of AI is to subject it to the range of tests that psychologists have already developed for measuring human intelligence. Without limitation, such standardized tests include:

1. Raven's Progressive Matrices: A non-verbal test that measures abstract reasoning and problem-solving abilities.

2. Wechsler Adult Intelligence Scale (WAIS): A widely used test that assesses cognitive abilities such as verbal comprehension, perceptual reasoning, working memory, and processing speed.

3. Stanford-Binet Intelligence Scale: A test that measures five cognitive factors: fluid reasoning, knowledge, quantitative reasoning, visual-spatial processing, and working memory.

4. Thurstone's Primary Mental Abilities: A test that measures seven primary mental abilities: verbal comprehension, word fluency, number facility, spatial visualization, associative memory, perceptual speed, and reasoning.

5. Kaufman Assessment Battery for Children: A test that measures cognitive abilities such as fluid reasoning, knowledge, quantitative reasoning, visual-spatial processing, and working memory.

6. Woodcock-Johnson Tests of Cognitive Abilities: A test that measures cognitive abilities such as general intellectual ability, specific cognitive abilities, and academic achievement.

7. Cattell Culture Fair Intelligence Test: A non-verbal test that measures general intelligence and problem-solving abilities.

8. Multidimensional Aptitude Battery: A test that measures cognitive abilities such as verbal reasoning, numerical reasoning, spatial relations, perceptual speed, and memory.

9. Universal Nonverbal Intelligence Test: A non-verbal test that measures general intelligence and cognitive abilities such as spatial perception, analogic reasoning, and pattern analysis.

10. Bennett Mechanical Comprehension Test: A test that measures mechanical aptitude and problem-solving abilities.

11. Miller Analogies Test: A test that measures verbal and logical reasoning abilities.

12. Wonderlic Personnel Test: A test that measures cognitive abilities such as verbal reasoning. numerical reasoning, and spatial reasoning.

13. Minnesota Multiphasic Personality Inventory: A test that measures personality traits and psychopathology.

14. 16 Personality Factors: A test that measures personality traits such as warmth, reasoning, emotional stability: dominance, liveliness, rule-consciousness, social boldness, sensitivity. vigilance, abstractedness, privateness, apprehension, openness to change, self-reliance, perfectionism, and tension.

15. Myers-Briggs Type Indicator: A test that measures personality traits such as extraversion/introversion, sensing/intuition, thinking/feeling, and judging/perceiving.

16. Emotional Intelligence Test: A test that measures emotional intelligence, which is the ability to perceive, understand, and manage emotions.

17. Mental Rotation Test: A test that measures spatial reasoning abilities.

18. Stroop Test: A test that measures cognitive flexibility and processing speed.

19. Tower of Hanoi: A test that measures problem-solving abilities and executive function.

20. Trail Making Test: A test that measures cognitive flexibility, visual attention, and task switching.

Given that safety is a prime concern when it comes to AI entities, tests of psychopathology including the DSM II (used by psychologists to assess pathology) are particularly important to apply to AI agents. However, it will be necessary to expunge or filter from the data used to train LLM and AI agents any record of correct or normal response to these tests. Generally, for a test to be effective, the test questions and answers must NOT be included in the training set or data used by the entity being tested.

Alternatively, humans must develop completely new instruments that are validated with respect to detecting psychopathic behavior, but which are kept secret and not disclosed via any medium that AI agents might be able to access. Even so, as Als increase in their abilities to generalize responses, such secret tests are likely to have value only for a limited period of time. Eventually, as Hinton and others have speculated, it is likely that sufficiently intelligent AI will be able to “cheat” at our psychological test without our being aware. However, for a time, such approaches will have merit.

Pragmatically, for AI agents expected to have domain-specific knowledge, the certification tests for humans employed as experts in those domains can be used.

### 6.4b Crowdsourcing Evaluation of AI Intelligence

One inventive method is to crowdsource the requirements for an AI agent in each domain that it must operate in. Similarly, it is possible to crowdsource test questions for AI agents in each domain and also use human collective intelligence or crowdsourcing to determine the quality of the AI agents answers to questions.

Even more practical would be to enable a system whereby human and AI solutions or answers to specific problems or questions were presented to human evaluators where the humans determined which solutions or answers they preferred. For responses where human answers were deemed superior, the AI would perform comparative analysis and attempt to isolate the factors that made the human responses superior and then incorporate those factors into its next iteration of responses. It is possible to take humans out of the loop, or supplement human involvement, by having multiple versions of the AI agents generate multiple different responses, which are then shown to human evaluators. The weights or programming leading to the preferred responses are kept as the base system that then generates variations attempting to improve further. Thie general approach has been used with great success in limited domains such as chess, but there is no reason that it could not be used (with humans as the primary evaluators until such time as AI might prove better at evaluating than humans) in any cognitive domain.

One specific method would be to use a crowdsourced version of the Turing Test where many humans are connected to either other humans or AI agent(s). By connecting many humans in a crowdsourced system where every human can view the questions posed by every other human and also the responses of the hidden (human or AI) entity, and by asking the humans to rate and/or rank the responses of the hidden entity in terms of how likely the responses were to come from a human and/or AI, it is possible to gather statistically valid and numerically precise metrics on how close a given entity is to passing the Turing Test. This novel approach has the advantage of tapping the collective intelligence of many humans to come up with increasingly challenging questions as AI improves. Metrics such as the number of questions required to distinguish between an AI and human can track the progress towards AGI.

### 6.4c Use of Non-Standardized Creative Problem Solving/Insight Tasks

One type test or problem that has been largely overlooked by AI researchers are “insight” problems that require a shift in representation or “thinking outside of the box” in order to solve. Such problems are generally considered to require the highest levels of human creativity and problem-solving prowess.

Posing puzzle problems such as the “nine dots problem,” “the mutilated checkerboard problem,” Maier's “two string problem” or riddles such as: “What can go up a chimney down but can't come down a chimney up?” (answer: an umbrella) to a system whose training set has excluded known solutions to these problems would constitute an excellent test of flexibility in forming and using multiple representations. Such problems have been used to assess human ability to achieve insights and excel in creative problem solving but have never been used to test AI (to my knowledge), suggesting the approach is quite novel and outside the knowledge of AI researchers skilled in the art of training and developing advanced AI systems.

Since representational ability is the key to unlocking huge advances in cognitive power for AI (as discussed earlier) such problems would be particularly useful in assessing the advance of AI abilities towards AGI and SI.

### 6.5 Exemplary Methods to Modify (Optimize) Personality of PSI

While learning about the owner (let us call him “Craig”) of a Personalized SuperIntelligence (PSI) and new information related to his goals is generally important, a special type of information has to do with how the PSI relates to other PSIs and intelligent entities. One might think of this as personality knowledge or knowledge about interactions, akin to what is sometimes called “emotional intelligence” with regard to humans. While some of this information can be gleaned by analyzing all of Craig's interactions, the PSI's interaction style can actually be improved relative to Craig's base style.

For example, suppose Craig's personality is somewhat abrasive and “no-nonsense” in most of his online interactions. The PSI might learn that style, which can be sub-optimal in some situations. Alternatively, if Craig was overly timid or accommodating in business negotiations, a modified PSI might retain Craig's general accommodating nature while still holding firm on key negotiating points, resulting in better outcomes.

While it would be difficult (think years of therapy with questionable results) for Craig to modify his own personality, he might relatively easily modify the interaction style of his PSI to be less abrasive and more genial—or less timid and more forceful.

By running simulations with various modified versions of his PSI, Craig can determine which modifications to the base style of interaction still reflect Craig's personality, but which (according to simulation results) are more likely to result in the desired result in interactions with other intelligent entities.

Further, online sources of information about interactions between humans and intelligent entities generally, can inform the PSI's behavior given any personality variant. The Cognitive Psychologist. Geoff Hinton, has warned that advanced AI will have “read everything that Machiavelli ever wrote” and therefore would be good at manipulating humans. But it is also true that advanced AI can read Getting to Yes, How to Win Friends and Influence People, the Bible, and other texts that model positive modes of interaction with others.

Craig could specify that his PSI adopt the approaches in one of more of these texts, or weight them more heavily, in in its interaction style. Simulation results can show the effect of such weightings, enabling Craig to fine-tune a style for his PSI that reflects not just his own personality, but also how he wished he behaved-his “better self” if you will.

### 6.6 Exemplary Methods for Scalable Delegation as Intelligence Increases Exponentially

It is helpful to have a theoretical framework for deciding what to delegate to PSI (or AI generally) and what functions are essential for humans to control. The key issue is the disparity in information processing capability between humans and AI. Als greatly exceed humans in long term memory, short term memory, speed of processing, and the ability to communicate and act quickly. This imbalance in information processing abilities means that the ONLY way that humans can remain in control of AI systems is if they identify certain key areas that are critical to the safe and ethical operation of AI, and delegate most of the rest. As AI processing power increases the size of the area that humans control relative to that which is delegated to AI will shrink exponentially. Therefore, the framework must work at any scale.

The analogy of a spinning wheel (described in other PPAs cited above) is helpful in this regard. At the exact center of any spinning wheel, is a point that is motionless. As one travels “along the spokes” of the wheel towards the rim of the wheel, the speed increases. For a very large wheel (or Sphere) such as the Earth, the rim or surface may travel 1.000 miles per hour while a point near the center travels only one inch per hour. Since there are about 63,360 inches per mile, the surface of the Earth is traveling 63,360,000—more than 63 million—times fastest than a point near the center. In our analogy, speed corresponds to information processing ability. An AI may be able to process information 60 million times better and faster than a human, but if the humans are processing information “near the center” of the informational sphere, they can keep up and stay in control.

What does it mean to be “near the center” of the informational sphere?

Well, let the “sphere” correspond to all information processing tasks that AI undertakes in service to humans. At the surface or “rim” are rapidly changing pieces of information beyond the capability of humans to understand or track. This might correspond to every change in stock prices across every global stock market, every measurement on every weather station on Earth and in space, every new research publication that is published, every blog post, email, text, video published, every movement of every car and every person on the planet, and so forth.

Clearly it is beyond the capability of any human, or even any group of humans, to track all the changes in all these variables in real-time, let alone have time to analyze them in totality and draw conclusions from them. But this type of processing of rapidly changing on the “rim” is well-within the capabilities of AI and PSI.

How much of this information is important or relevant to humans? While some of it is relevant to some humans, very little of it is relevant to most humans most of the time. The fact that typically very little of the change in informational events is relevant to humans over any given increment of time is what allows the possibility for humans to remain in control despite vastly inferior information processing capabilities.

An “information sphere” can be constructed for any human. The things that the human cares most about are near the center of the sphere, and the details that are of little concern are near the periphery. If we add the further constraint that the things of interest need to change relatively slowly compared to the things that are of less concern, it is possible to create information sphere representation that reflects the core concerns of any human, and by extension, any group of humans up to and including all humans on planet Earth. The general approach here is to use a powerful representation to abstract out the unnecessary detail and focus on the core principles and information that is essential for humans retaining control over AI.

This general strategy is proven and has a long track record of effectiveness. Hierarchical implementations of this strategy, for example, enable CEOs with hundreds of thousands of employees, or governments with millions of people, to operate effectively despite the inability of the leader to understand or process everything that goes on within the company or country. One difference between a powerful PSI and a large company or country, however, is the speed of change in information. The CEO or government leader presides over a company or country that moves at human speed—it is only the scope of governance that makes it intractable to understand and control everything, necessitating delegation. In the case of AI, it is both scope and speed that are beyond human ability.

AI enables huge scope, because each AI can be cloned essentially infinitely so the number of intelligent entities that must be controlled are far beyond the number of humans on Earth. AI enables almost unimaginably fast speed, because each of these AI entities thinks and processes information far more rapidly than humans can. It is a tremendously difficult problem to effectively control such power. Still, it is possible. To succeed, humans must become laser focused on what is essential and be willing to delegate almost everything else.

If we define the essential task of humans as ensuring that PSIs (and AI generally) behave ethically and safely so that humanity survives and prospers, then the center of the spinning information sphere must be human values.

What is right and what is wrong, according to humans, must be the center of the spinning information sphere.

Fortunately for humans, these key principles of ethics and morality tend to change very slowly. At least we can say that core values such as the preciousness of human life and the human “rights” which most nations and people espouse are well-established. If they change, they change over years and decades—not milliseconds.

Let the Als process the millisecond-by-millisecond stock price fluctuations, the weather fluctuations, the stream of new information that arrives by the Exabyte every second. Almost none of this affects core human values, which change much more slowly. If the Als are centered on human values, and if humans retain control over these values and the central purpose and most fundamental goals for AI (e.g., benefiting people and the planet), then the details and action plans that flow form these values and fundamental goals can be left largely to PSI and AI generally.

But what does it mean to locate human values and fundamental goals at the center of the “infosphere?” Practically speaking it means developing a taxonomy of human values and ethics, and then frequently checking the actions of AI (in an automated fashion) against this taxonomy. Some companies, like Anthropic, have made strides in this direction in their research efforts, loosely called “Constitutional AI.”

My objection to their approach is not that constitutions or automated training and checking of AI is unnecessary or infeasible. Rather I object to a small group of individuals se ing the constitutional standards for all humans on the planet. As I have argued in other PPAs (previously cited) the proper approach is to have a statistically representative and valid sample of the values and ethics of all humans placed at the center of any “constitution” or other framework which is used as an acid-test for the AI behavior.

It would be hypocritical, therefore, for me to propose my own taxonomy or hierarchy of values and ethics for PSI (or AI) to follow. Rather, this present technology strives to provide methods and mechanisms whereby individual owners of their PSIs can set up their own values/ethics hierarchies that center the impressive intelligence of their PSIs on principles and values that tend to be lasting and therefore not requiring super-human processing ability to enforce.

### 6.7 Safety via a Community of Agents Approach to AGI

If multiple PSIs adopt the methods described above and in other related patents, and if they accelerate their growth at the same time, a community of such PSIs can still be more collectively intelligent than any of the community's individual members, thereby minimizing the potential corrosive influence of an over-concentration of power and intelligence in one PSI. That is, in a world of SuperIntelligent AI where one malevolent SI could potentially eliminate all humans, we are going to need a community approach to keep humanity safe.

Relative to this community approach, specifically, one inventive method of ensuring long term AGI safety is to adapt methods from cryptocurrency validation and applying them to AGI in novel ways. That is, just as Bitcoin and other Proof-of-Work-Based cryptocurrencies maintain integrity by ensuring that the majority of all nodes on the verification network have consensus on which version of a ledger is correct, so too, a community of PSIs can reach consensus on the values and purposes of the SuperIntelligence network, of the Planetary Intelligence. I have argued that “the 51% attack” on Bitcoin's integrity has not happened because it is difficult to get the majority of available compute power to do something wrong. Similarly, it will be difficult for any one intelligent system (e.g., a PSI) to override the consensus of the PSI community, even if some PSIs are more intelligent and powerful than others. A malevolent PSI would need to acquire or compel 51% of available computing resources into overriding the consensus value system in order to corrupt the process. There is a barrier to doing this, namely that the other PSIs can generally scale as fast as any one powerful PSI, and together the community has more intelligence than a single member.

### 7.0 One Exemplary Implementation of Some Methods in an AI/AGI/SI/PSI System

The following example scenario, illustrates one exemplary implementation of the present technology, utilizing a subset of the methods described above.

Craig creates a customized, personal super intelligence (PSI) by customizing Large Language Models (LLMs) available from the METAR corporation, purchasing additional training materials and sets of weights to tune the model, and then interacting with the LLM to train and tune it further. Craig's purpose is to create a PSI that is able to represent his own knowledge, preferences. and decision-making ability across a wide range of online scenarios. That is, he wants to create a customized, super intelligent personal assistant that would act as Craig himself might act, but much faster and with the ability to handle thousands of simultaneous interactions at once.

Fortunately, the ability to handle many simultaneous interactions, much faster than Craig could handle a single interaction, is relatively easy to accomplish. The LLM can be “cloned” so that many copies of it act in Craig's best interest simultaneously. Similarly, the fact that the LLM is a computer program than can process information and also handle I/O (input/output) much faster than Craig could talk or type, ensures that each cloned agent will be faster than Craig himself at interacting-especially if the entities that the PSI is interacting with are other Als or PSI with similarly high I/O bandwidth. Thus, the remaining problem is to ensure that the LLM behaves as Craig would behave.

Unfortunately, despite the tremendous resources and computational power of the METAR corporation. METAR has only limited information about Craig's preferences. It has access to his Facebook page, his Instagram feed, Craig's YouTube videos, the data used to send Craig targeted ads and content, his posts, emails, and text messages. But it has limited information about Craig's day-to-day interactions and preferences in his offline life. Since Craig has begun to participate more and more in META's “metaverse” environments, where METAR stores every eye movement, gesture, and other piece of information. META® is beginning to gather more data that it can use to train Craig's PSI, but the data is incomplete.

Craig gives his PSI the task of learning how to represent his preferences better as quickly as possible. It is a bit of a race, since the faster that the PSI can learn to emulate Craig's preferences and knowledge, the faster it can be put to work, operating with thousands of clones (each operating faster than Craig himself could do) and achieving more (money, fame, artistic output, etc.) than Craig could do himself by orders of magnitude.

The more money and resources the cloned PSIs acquire on Craig's behalf, the more that can be invested in making the PSI even more knowledgeable and powerful. So, speed is of the essence. After all, other PSIs will “catch up” to Craig's abilities and compete, making it more difficult for Craig and his PSIs to achieve his aims.

However, rapid knowledge acquisition is pointless if the PSI does not accurately reflect Craig's values, goals and priorities. A powerful PSI that misrepresents Craig's intentions just multiplies mischief, error, and sorrow at a very fast rate. Running very quickly in the wrong direction is worse than not running at all! Thus, it is critical for Craig's PSI to learn as much as possible about him and information related to his goals, as quickly as possible. This is the task that he sets for his PSI.

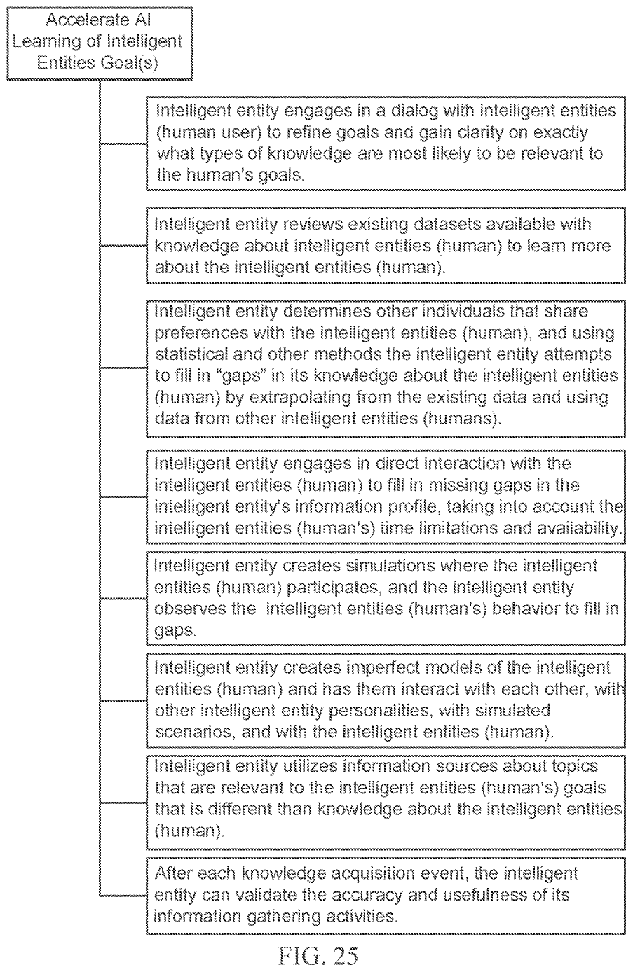

Referring to FIG. 25, the PSI may use one or more of the following steps, in this or some other order, to accomplish that task. After each step, a “Note . . . ” describes some of the earlier disclosed methods that can be used to make the steps more effective and efficient. Alternative implementations are possible using more or less of the methods and different combinations of them.

Without limitation, steps might include:

1) Craig's PSI engages in a dialog with Craig to refine his goals and gain clarity on exactly what types of knowledge about Craig are likely to be most relevant. Note: Methods from 6.5 could be useful to optimize the PSI agent for extracting information using expertise about PSI customization and also personality traits designed to elicit the most useful information with the least hassle for Craig. Methods from 5.0, 5.2, 5.3, 5.5a. 6.1, and 6.2 might also be useful to help formulate goals and representations that are most useful and relevant to Craig.

2) The PSI reviews the existing datasets available with knowledge about Craig in the areas that are most goal-related and relevant to learning more about Craig. These might include, without limitation, Craig's social media profiles and all social media content, emails, texts, papers, blogs, and all other online content produced by Craig. Transcripts and recordings of video-conference and tele-conference calls, transcripts of all video content that includes Craig, transcripts and records of all Craig's interactions with various AI entities, his driving logs, location information, online navigation information, ad and content preferences determined by algorithms and AI owned or controlled by vendors and other parties that Craig interacts with, analysis of historical photos, school reports, health records, and all other available information about Craig. Note: Methods from 5.2 and 5.3, including use of formulas for goal-relatedness and relevance could be useful. To estimate which datasets contain the most useful information and to prioritize them, methods discussed in 4.31, 4.32, 4.4, 5.1, 5.1a, 5.1b, 5.4, 5.5 could all be used.

3) The PSI uses social graph and other means to determine other individuals—including but not limited to friends, family members, and business associates of Craig—that share preferences with him, and using statistical and other methods and techniques well known in the art—including, but not limited to regression analyses, machine learning techniques, categorization techniques, recommender algorithms and other AI analysis techniques—the PSI attempts to fill in “gaps” in its knowledge about Craig by extrapolating from Craig's existing data as well as by using the behavior, preference, and other data from humans that are predicted to be similar to Craig in terms of their preferences and/or the missing information that is not available for Craig. Note: Methods from 5.0, 5.4, 5.6a, 5.6b, 5.6c, 5.6d might be useful here.

4) For critical missing information, and using a cost-function that takes the value of Craig's time into account (e.g., which Craig can control or adjust), the PSI engages in conversation, questioning, assessment, and other direct interaction with Craig designed to fill in the most critical missing gaps in the PSI's information profile as quickly and efficiently as possible. Note: Methods from 4.5, 5.4, 5.6, and 6.5 (among others) could be helpful here.

5) In cases where behavior is likely to differ meaningfully from verbal responses, the PSI creates simulations where Craig participates, and the PSI observes Craig's behavior to fill in its knowledge gaps. Note: Simulation, parallel scenarios, and other automated methods described 5.6, 5.6a-d, could be useful: Craigs performance on standardized tests including behavior tests (6.4a) might also be helpful.

6) The PSI creates imperfect models of Craig and has them interact (without limitation) with each other, with other PSI personalities, with simulated scenarios, and with Craig himself. These interactions and/or simulations are all designed to elicit missing information as to Craig's behavior and responses as efficiently and effectively as possible while still remaining within ethical and other guidelines set by Craig and the system. For example, it might be highly effective to scare the living daylights out of Craig to see how he would react, but that might not be within the ethical guidelines and/or the guidelines set by Craig. Note: Simulation, parallel scenarios, and other automated methods described 5.6, 5.6a-d, could be useful: methods in 6.5 also would be useful.

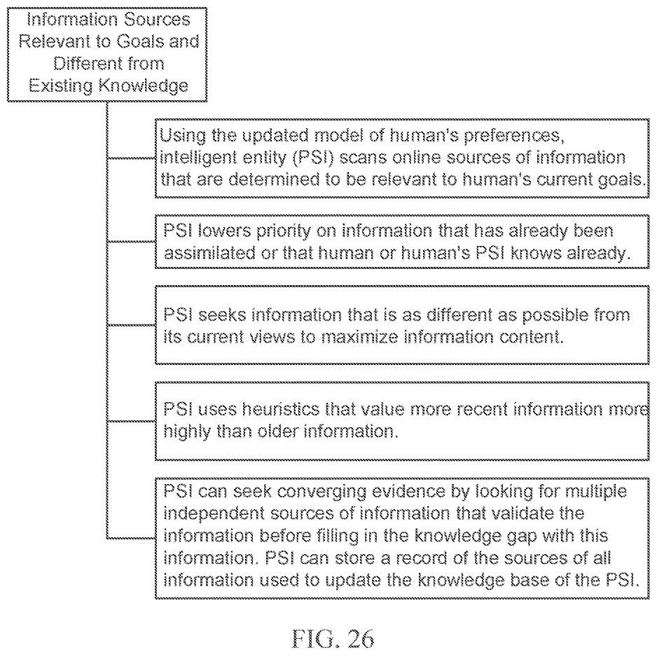

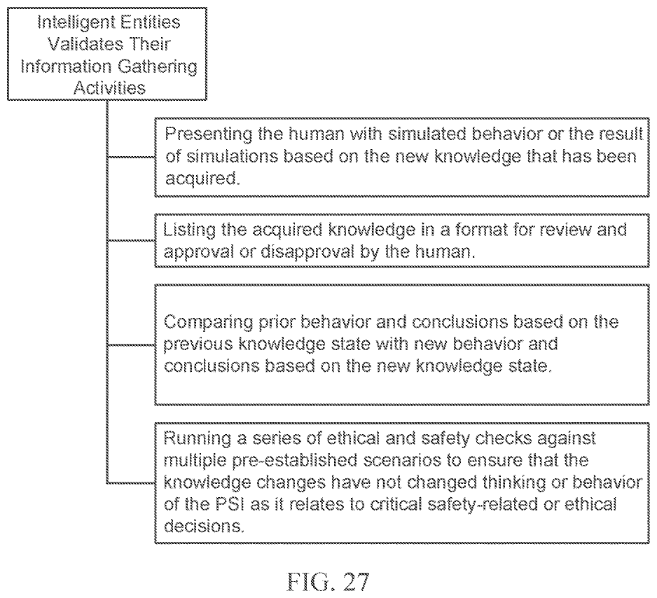

7) Having obtained as much information as possible about Craig and his preferences by analyzing Craig's data together with data from people deemed similar to Craig, and having run simulations to fill in the gaps in knowledge about Craig himself-using the method of prioritizing seeking the most goal-related, relevant, and informationally rich data—the PSI turns to the information sources about topics that are relevant to Craig's goals that is different than knowledge about Craig himself. Here a version of the aforementioned prioritization method is used, as illustrated I the FIG. 26, e.g.:
a. Using the updated model of Craig's preferences, the PSI scans online sources of information that are determined to be relevant to Craig's current goals.
b. The PSI discounts, or lowers priority, on information that has already been assimilated or that Craig (or Craig's PSI) knows well already.
c. The PSI seeks information that is as different as possible from its current views to maximize information content. Note that this is the opposite of what most social media and other online content recommenders do, and therefore is a novel and extremely useful approach. The reason for looking for different views and information on topics that Craig is interested in is that telling him what he already knows (while perhaps comforting and good for increasing ad views) contain very little information in the Shannon-sense of information. Instead, it is the new; unusual, and unexpected events and information in the area of interest that are most likely (if the information is valid) to increase the knowledge and effectiveness of Craig's PSI the most. Therefore, this heuristic of seeking to disconfirm what Craig thinks he knows, or to reveal gaps in his understanding, is employed by the PSI.
d. Assuming that this is not the first time the PSI is attempting to increase its knowledge, the PSI will have already scanned the most likely candidate online sources for increasing knowledge; therefore, it is a useful heuristic to seek information (in areas relevant to Craig's goals) that have changed recently. The PSI should use heuristics that value more recent information more highly than older information, provided other factors (e.g., reliability and relevance of the information source) are held constant.
e. For critical information that may have significant impact on Craig's (or the PSI's) behavior given his goals and current knowledge, the PSI should seek converging evidence. That is, the PSI should look for multiple independent sources of information that validate the information before filling in the knowledge gap with this information. For auditability, and potential future error-correction (see below), the PSI should store a record of the sources of all information that is used to update the knowledge base of the PSI. The number of sources of converging evidence and the quality (or trust) in these sources should depend on how critical the information is. For example, if Craig has a goal of deciding whether to get a heart bypass operation which is life-threatening, the PSI should seek a large number of independent sources about the safety and efficacy of the contemplated operation: further the reliability, quality, and “trust” in the sources of information must be very high. On the other hand, less stringent criteria and fewer sources of information should be used for a “low stakes” decision like recommending a movie Craig might want to watch. Note: A combination of the methods described in 4.0-5.6d could be used: crowdsourcing validation of high stakes information (related to 6.4b) or using a community of agents to weigh in on high-stakes recommendations (related to 6.7) are also relevant.
8) After each knowledge acquisition event, periodically, and/or as specified by Craig and/or algorithms that calculate cost-benefit based on parameters (e.g., how often Craig is willing to tolerate interruptions) set by Craig, the PSI should validate its information gathering activities by, and as generally illustrated in FIG. 27, without limitation;
a. presenting Craig with simulated behavior (or the result of simulations) based on the new knowledge that has been acquired;
b. listing the knowledge that has been acquired in a format suitable for Craig's rapid review and approval or disapproval;
c. comparing prior behavior and conclusions based on the previous knowledge state with new behavior and conclusions based on the new knowledge, so that Craig can see how behavior and thinking of the PSI has changed as a result of the new knowledge and can decide whether to accept or “roll back” the changes to the PSI's knowledge; and
d. run a series of ethical and safety checks against a battery of pre-established scenarios to ensure that the knowledge changes have not changed thinking or behavior of the PSI as it relates to critical safety-related or ethical decisions.

For example, in the heart bypass example above, the PSI may learn new information about the cost of various surgery vs the expected benefit, and based on Craig's personality profile of wanting to help other people and also save money, might decide that more people could be helped if Craig was killed immediately and the money saved by foregoing the heart bypass operation (now unnecessary because Craig would be dead) could be given to the poor and further his goal of helping other people efficiently. However, this outcome might not be what Craig intended when he told the PSI to go off to acquire new information about heart bypass operations. To avoid such unintended consequences of knowledge acquisition, baseline calibration on ethical and safety scenarios must be re-run every time the knowledge base is updated. This approach is similar to the notion of “Regression Testing” which is well known in the art of software development.

Note: Elements of this step related to safety can use, without limitation, methods described in 5.6-5.6d, and 6.7. The considerations of what to delegate (6.6) are also relevant in terms of the health example where critical safety or ethical decisions may be places where a “human in the loop” is retained.

### Description of Computer System

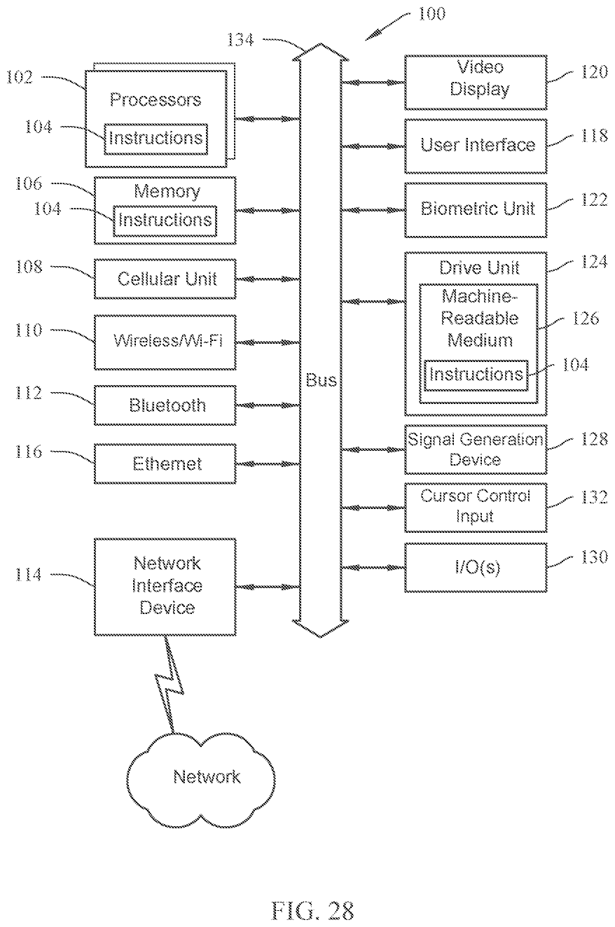

FIG. 28 is a diagrammatic representation of a computer system 100 that is utilizable or implementable with the user's device and/or any peripheral component of the present technology. The computer system 100 can be part of an example machine, which is an example of one or more of the computers referred to herein and, within which a set of instructions for causing the machine to perform any one of or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

The computerized system 100 can include one or more processors 102, storage devices 106, and communication devices, as well as software components or instructions 104 for providing a platform for users to interact with and train/tune the LLMs. The computing capabilities may be stand alone or may be cloud based. They may include cloud based AI development platforms that seamlessly offer “AI as a service” and they may include both hardware and software components.

The system also supports the ability for users to provide new data, or data that is unique to them, for the LLMs to learn from. The processors 102 may be one or more CPUs, GPUs, chips specialized for ML, microprocessors, application processors, embedded processors, field-programmable gate arrays (FPGAs), or other hardware components capable of executing computer programs. The processors may be in communication with one another and/or with other components of the system. Further, any one of or any combination of the components of the system 100 can communicate with each other via a bus 134.

The storage devices 106 may include one or more hard drives, solid-state drives, optical storage devices, or other storage components. The storage devices may store the data that is used to train/tune the LLMs, as well as other data associated with the system, such as user accounts, system settings, and other data.

The communication devices may include one or more cellular modems 108, Wi-Fi cards 110, Bluetooth modules 112. Network Interface Device 114, or other components that enable the system to communicate with other systems, such as user devices, over a network or the internet.

The communication devices may also enable the system to communicate with other systems over a wireless or wired connection 116.

The software components may include computer programs for providing a platform for users to interact with and train/tune the LLMs. The software components may also include computer programs for collecting, storing, and processing data that is used to train and/or tune the LLMs. The software components may also include computer programs for providing a user interface for users to interact with the system.

The user interface 118 may include, without limitation, natural language interfaces, textual interfaces, and chatbot type of interfaces, a web-based user interface, a mobile application, an augmented reality application, a metaverse application, or other applications that allow users to interact with the system. The user interface may include features for allowing users to select the data that they want to use to train/tune the LLMs, as well as features for allowing users to interact with and monitor the progress of the LLMs.

The system may also include one or more databases or data source, including without limitation vector databases, centralized databases, and distributed databases, for storing the data that is used to train/tune the LLMs, as well as other data associated with the system, such as user accounts, system settings, and other data. The databases may be hosted on the system itself or on another system, including cloud based systems.

The system may also include one or more authentication systems for verifying the identity of users who use the system, as well as for providing secure access to the system. The authentication systems may include biometric authentication systems 122, such as facial recognition or fingerprint recognition systems, as well as other authentication systems, such as password-based authentication systems.

The system may also include one or more security systems for protecting the system from unauthorized access and for protecting the data that is stored on the system. The security systems may include firewalls, encryption systems, access control systems, single and multi-factor authentication systems, and other security systems.

The system may also include one or more analytics systems for collecting and analyzing data associated with the system and/or the LLMs. The analytics systems may include machine learning algorithms and other algorithms for analyzing the data associated with the system and/or the LLMs.

Data visualization methods, including use of problem trees and other representations and data structures; use of statistical outputs, tables, graphs, text, speech, video, image and graphical outputs may be used for one way or di-directional communication between users and the system, and between multiple (human or AI) agents or LLMs using the system to interact with each other in large or small groups.

The system may also include one or more monitoring systems for monitoring the performance of the system and/or the LLMs. The monitoring systems may include systems for monitoring the performance of the system, such as system uptime, and systems for monitoring the performance of the LLMs, such as accuracy, speed, ethical compliance, reputation metrics, quality metrics, and other metrics as discussed above or as are known in the art.

The system may include one of more of the architectures described above that enable one or more human or AI Agents or LLMs to engage in a variety of intellectual tasks including, without limitation, simple and complex and multi-step problem solving behavior with the system having all of the functionality and features previously described.

The system may also include one or more feedback systems for allowing users to provide feedback on the system and/or the LLMs. The feedback systems may include systems for allowing users to submit feedback on the system, such as bug reports, and systems for allowing users to submit feedback on the LLMs, such as suggestions for improving the accuracy or speed of the model.

The system may also include one or more management systems for managing the system and/or the LLMs. The management systems may include systems for managing the system, such as systems for managing the users and user accounts, and systems for managing the LLMs, such as systems for managing the data used to train and/or tune the model.

The system may also include one or more payment systems allowing users to pay for the use of the system and/or the LLMs. The payment systems may include systems for processing payments, such as credit card processing systems, and systems for managing payments, such as subscription management systems.

The system may also include one or more other components, such as support systems, reporting systems, and other components that are necessary for providing a platform for users to interact with and train/tune the LLMs.

The computerized system of the present technology enables users to interact with and train/tune LLMs based on data that is unique to the users. The components of the system described herein provide the necessary hardware and software components for enabling users to do so.

Further, while only a single machine is illustrated, the term “machine” shall also be taken to include any collection of machines that individually or jointly execute a set (or multiple sets) of instructions to perform any one of or more of the methodologies discussed herein.

The computer system 100 may further include or be in operable communication with a video display 120 (e.g., a liquid crystal display (LCD), touch sensitive display), input and/or output device(s) 130 (e.g., a key board, keypad, touchpad, touch display, buttons, sonic, sensorial, etc.), a cursor control device 132 (e.g., a mouse), a drive unit 124 (also referred to as disk drive unit), and a signal generation device 128 (e.g., a speaker). The drive unit 124 can include a computer or machine-readable medium 126 on which is stored one or more sets of instructions and data structures (e.g., instructions 104) embodying or utilizing any one of or more of the methodologies or functions described herein. The instructions 104 may also reside, completely or at least partially, within the memory 106 and/or within the processors 102 during execution thereof by the computer system 100. The memory 106 and/or the processors 102 may also constitute machine-readable media.

Still further, the computer system 100 can be in operable association or communication with any types of multi-modal input and/or output 130 that address the human senses, as well as I/O technology that extends beyond the range of normal human perception. Such ability includes the ability to process light invisible to humans, for example but not limited to. X rays and information outside of the typical bandwidths of human perception, but not outside of AI perception using tools. Additionally, the I/O technology can include very fast perceptions that are too fast for humans to perceive but which an AI entity could perceive, and very slow or faint perceptions (e.g., tiny seismic shifts occurring over years) that humans cannot perceive but which Als could. Since any intelligent entity can be part of the present technology system described by FIG. 28, then it can be appreciated that any type of I/O that humans, and also Als with much broader perceptual capabilities than humans, can be utilized with the system 100.

The instructions 104 may further be transmitted or received over a network via the network interface device 114 utilizing any one of a number of well-known transfer protocols (e.g., Hyper Text Transfer Protocol (HTTP)). While the machine-readable medium is shown in an example embodiment to be a single medium, the term “computer-readable medium” should be taken to include a single medium or multiple media (e.g., a centralized or distributed database, vector databases, and/or associated caches and servers) that store the one or more sets of instructions. The term “computer-readable medium” shall also be taken to include any medium that is capable of storing, encoding, or carrying a set of instructions for execution by the machine and that causes the machine to perform any one of or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

An example machine system of the present technology including the computer system 100 in combinational and/or operational use with components of the present technology. In the exemplary, any or all of above described components can include a processor 102, memory 106, a network interface device 114, a display 120, an input device(s) 130, 132, and/or drive unit 124.

### Some Aspects of the Technology

According to one aspect, the present technology can include a system for increasing knowledge of an Artificial Intelligence (AI) agent or system by utilizing sources of information for learning by the AI agent or system. The system can include a computer system including a processor, a computer-readable storage medium, and program instructions stored on the computer-readable storage medium. The program instructions can be executable by the processor to cause the computer system to search for one or more potential informational datasets from one or more sources. The potential informational datasets can be related to a knowledge dataset of the AI agent. The program instructions can cause the computer system to determine a difference of the potential informational datasets by measuring a difference attribute of the potential informational datasets with regard to one or more factors. The program instructions can cause the computer system to learn utilizing the potential informational datasets based on the difference.

According to another aspect, the present technology can include a method for increasing knowledge of an AI agent by utilizing sources of information for learning by the AI agent. The method can include the steps of searching, by an intelligent entity, for one or more potential informational datasets from one or more sources. The potential informational datasets can be related to a knowledge dataset of the AI agent. The intelligent entity can be any one of or any combination of the AI agent operating on a computer system, a human user utilizing a user computer system, and an additional AI agent or system in communication with the AI agent over a network. The method(s) can include determining a difference of the potential informational datasets by utilizing a difference attribute of the one or more factors. The method(s) can include learning, by the AI agent. utilizing the potential informational datasets based on the difference attribute of the potential informational datasets.

According to yet another aspect, the present technology can include a method for increasing knowledge of an AI agent by utilizing sources of information for learning by the AI agent. The method can include the steps of searching, by an intelligent entity, for one or more potential informational datasets from one or more sources. The potential informational datasets can be related to a knowledge dataset of the AI agent. The intelligent entity can be any one of or any combination of the AI agent operating on a computer system, a human user utilizing a user computer system, and an additional AI agent or system in communication with the AI agent over a network. The method(s) can include determining a difference of the potential informational datasets utilizing a difference attribute of the potential informational datasets with regard to one or more factors. The difference can be determined by taking an initial dataset containing all information that the AI agent has already been trained on and determining an amount of compression that is achievable, and determining which of a first dataset and a second dataset of the potential informational datasets and of equal size, contains more information, relative to the initial dataset of the AI agent. The method can further include the step of learning, by the AI agent, utilizing the potential informational datasets based on the difference attribute of the potential informational datasets.

According to still yet another aspect, the present technology can include a method for increasing knowledge of an AI agent by utilizing sources of information for learning by the AI agent. The method can include the steps of searching, by an intelligent entity, for one or more potential informational datasets from one or more sources. The potential informational datasets can be related to a knowledge dataset of the AI agent. The intelligent entity can be any one of or any combination of the AI agent operating on a computer system, a human user utilizing a user computer system, and an additional AI agent or system in communication with the AI agent over a network. The method(s) can include determining a difference of the potential informational datasets utilizing a difference attribute of the potential informational datasets with regard to one or more factors. At least one aspect of the difference can be determined by ranking, by the AI agent or the intelligent entity, pieces of the potential informational datasets by priority. The method can further include the step of learning, by the AI agent, utilizing the potential informational datasets based on the difference attribute of the potential informational datasets.

According to yet still another aspect, the present technology can include a method for increasing knowledge of an AI agent by utilizing sources of information for learning by the AI agent. The method can include the steps of searching by the AI agent for informational datasets from one or more sources all in communication over a collective network. The potential informational datasets can be related to a knowledge dataset of the AI agent. Determining, by the AI agent, a difference attribute of the potential informational datasets compared to one or more initial informational datasets already learned by the AI agent. The method can further include the step of learning, by the AI agent, the potential informational datasets based on the difference attribute.

### Some Embodiments

In some embodiments, the sources can be any one of or any combination of one or more further AI agents operating on the computer system, one or more additional AI agents communicating with the AI agent over the network, one or more human users utilizing a computer system communicating with the AI agent over the network, and one or more data sources communicating with the AI agent over the network.

In some embodiments, the difference can be measured by comparing a uniqueness attribute of the potential informational datasets against an expected attribute of the potential informational datasets.

In some embodiments, the difference can be measured by comparing a relevancy attribute of the potential informational datasets against a goal or objective provided to the AI agent.

In some embodiments, the relevancy attribute can be further utilized in an analysis of diminishing returns of the comparison against the goal or objective.

In some embodiments, the difference can be calculated by the AI agent utilizing a mathematical equation of R=K*GR*E, wherein R is the relevancy attribute, K is a constant depending on a selected Shannon Entropy, GR is a goal-relatedness value, and E is a function of Entropy.

In some embodiments, the difference can be associated with a priority rank of a piece of the potential informational datasets, the priority rank is calculated by the AI agent or the intelligent entity utilizing a mathematical equation of P=GR*RK*I*C, wherein P is the priority rank, GR is a goal-relatedness value, RK is a relevancy attribute of a piece of the potential informational datasets, I is an estimate of how rare the sources is and how likely the sources is to provide new and unexpected informational datasets, and C is a computational cost function that reflects a computation cost of acquiring the piece of the potential informational datasets.

In some embodiments, I can be a quantity defined as 1/logP, where logP is a log of a probability of the piece of the potential informational datasets.

Some embodiments of the present technology can include a step of testing the AI agent with the piece of the potential informational datasets iteratively to determine if parameters of the priority rank are yielding predetermined knowledge growth of the AI agent.

T Some embodiments of the present technology can include a step of adjusting one or more of the parameters incrementally and re-testing the AI agent with the adjusted parameters.

Some embodiments of the present technology can include a step of monitoring each incremental adjustment of the parameters utilizing gradient descent algorithm or hill climbing algorithm.

In some embodiments, the difference can be associated with a computation cost attribute of the AI agent in acquiring the potential informational datasets.

In some embodiments, the computational cost attribute can include a cost model that utilizes a weight of the potential informational datasets or acquiring one piece of the potential informational datasets against the computation cost of acquiring one or more different pieces of the potential informational datasets.

In some embodiments, the potential informational datasets can be static information, dynamic information, or a combination of static and dynamic information.

In some embodiments, the difference can be associated with a rate of change of information in the potential informational datasets.

In some embodiments, the difference can be associated with one or more visual processing operators configured or configurable to extract information from an image or video.

In some embodiments, the factors can include a time-related factor.

In some embodiments, the time-related factor can include utilizing a first weight of a first of the potential informational datasets that is more recent to a second weight of a second of the potential informational datasets. The first weight can be greater than the second weight.

In some embodiments, the difference can be associated with a location factor of one or more of the potential informational datasets.

In some embodiments, the difference can be associated with a context factor of one or more of the potential informational datasets.

In some embodiments, the difference can be calculated utilizing a mathematical approach including any one of or any combination of Shannon Entropy Measures, Cross Entropy. RL Divergence, Log Loss functions, negative log likelihood (NLL), and Kolmogorov compression.

In some embodiments, the difference can be a combination of a usefulness factor associated with a piece of the potential informational datasets and a computational cost factor associated with acquiring the piece of the potential informational datasets.

In some embodiments, the difference can be a post-hoc measurement of how effective a semantically similar informational dataset was for the intelligent entity with a same or similar goal.

In some embodiments, the difference can be determined by: taking an initial dataset containing all information that the AI agent has already been trained on and determining an amount of compression that is achievable; and
determining which of a first dataset and a second dataset of the potential informational datasets and of equal size, contains more information, relative to the initial dataset of the AI agent.

Some embodiments of the present technology can include steps of:
concatenating the initial dataset and first dataset to create a first concatenated dataset, and then running a compression algorithm on the first concatenated dataset to determine an amount of compression achieved;
concatenating the initial dataset and second dataset to create a second concatenated dataset, and then running a compression algorithm on the second concatenated dataset to determine an amount of compression achieved; and
determining which of the first and second concatenated dataset is compressed a least amount. and identifying that concatenated dataset as having a most new information as compared to the initial dataset.

In some embodiments, one of the sources can be a human user, and wherein the differences utilized can be compression algorithm configured or configurable to use concepts or words to maximize the difference between the potential informational datasets and an initial dataset that has previously been trained on the AI agent.

Some embodiments of the present technology can include the steps of:
allowing access of any one of or any combination of an initial informational dataset of the AI agent, the potential informational datasets learned by the AI agent, and a combination of the initial informational dataset and the potential informational datasets by additional AI agents on the network;
compensating the AI agent by one or more of the additional AI agents; and
purchasing additional potential informational datasets utilizing a percentage of the compensation.

Some embodiments of the present technology can include a step of estimating by the intelligent entity a goal-relatedness attribute of the potential informational datasets using a technique selected from the group consisting of semantic overlap between a target information source and the goal, frequency counts of how many times the information source has been used to address a similar goal, using humans to rate and make subjective estimates of a likely overlap between manageable subsets of the potential informational datasets and the goal, using AI agents trained by humans to make the subjective estimates of the likely overlap between manageable subsets of the potential informational datasets and the goal, using the subjective estimates of the likely overlap with a provision that if the AI agent estimators are unsuccessful or performing below a threshold, the humans are utilized to train the AI agent estimators such that the AI agent estimators improve, and determining an overlap of subgoals that have been set in service with the subgoals reference a piece of the potential informational datasets.

Some embodiments of the present technology can include steps of:
sampling, by the intelligent entity, subsets of the potential informational datasets and calculating a goal-relevancy attribute to identify one or more of the sampled subsets that have a highest goal-relevancy;
estimating a Shannon Entropy on the one or more sampled subsets;
calculating a Kaplan Information Theoretical (KIT) relevance utilizing a product of the Shannon Entropy and the goal-relevancy attribute of each of the subsets;
grouping the subsets based on the KIT relevance to determine a first approximation of an optimal grouping of the subsets including a prioritized grouping of the potential informational datasets; and
acquiring, by the intelligent entity, the prioritized grouping of the potential informational datasets and providing the prioritized grouping of the potential informational datasets to the AI agent for learning.

Some embodiments of the present technology can include a step of testing the potential informational datasets on the AI agent prior to learning by the AI agent.

Some embodiments of the present technology can include a step of monitoring the AI agent, by a human user, after learning of the potential informational datasets to determine whether a behavior of the AI agent has improved from a behavior prior to learning of the potential informational datasets.

In some embodiments, the monitoring by the human user can be accomplished by running a simulation of the AI agent with the learned potential informational datasets with predetermined ethical scenarios that are related to the knowledge of the AI agent.

Some embodiments of the present technology can include a step of testing the AI agent with the learned potential informational datasets by configuring the AI agent to deliberately misuse the learned potential informational datasets, while a second version of the AI agent creates rules that govern the AI agent so that the AI agent is prevented from using the learned potential informational datasets in an unethical manner determined by a human user.

Some embodiments of the present technology can include a step of providing multiple versions of the AI agent and operating the AI agent and the multiple versions of the AI agent under a predetermined scenario in parallel with each other.

In some embodiments, the searching for the potential informational datasets can be conducted autonomously.

Some embodiments of the present technology can include steps of:
providing a goal to the AI agent by the intelligent entity prior to searching for the potential informational datasets;
creating a solution to the goal by the AI agent after learning the potential informational datasets: utilizing operators for moving through each state of a process in creating the solution; and determining one or more of the operators that best achieves the solution.

Some embodiments of the present technology can include a step of quantifying an intelligence attribute of the AI agent by tracking how many high-level steps are taken to achieve a goal provided to the AI agent.

In some embodiments, the quantifying can utilize blockchain-based records of a problem solving process performed on the goal to determine which, and how many, operators were used by the AI agent in achieving the goal.

Some embodiments of the present technology can include a step of quantifying an intelligence attribute of the AI agent by subjecting the AI agent to a crowdsourced test.

In some embodiments, the crowdsourced test can include the steps of:
connecting multiple humans in a crowdsourced system, with each of the humans utilizing a computer device;
providing a question by each of the humans, and allowing each of the humans to view each of the questions;
providing one or more responses the questions by the AI agent, where the AI agent is anonymous to the humans;
rating by the humans the responses by the AI agent in terms of how like the responses are provided by one of or combination of a human and an AI agent; and
obtaining metrics by utilizing the rating on how close the AI agent is to passing an intelligent behavior test that provides information of a machine's ability to exhibit intelligent behavior equivalent to, or indistinguishable from, that of a human.

Some embodiments of the present technology can include a step of determining if responses to a goal provided to the AI agent and additional AI agents all communicating on a network are in consensus, and if so, then providing the responses to the AI agent.

Some embodiments of the present technology can include a step of, prior to searching for the potential informational datasets, acquiring user information on the human user of the AI agent, wherein the acquiring is accomplished by any one of or any combination of conducting a dialog between the AI agent and the human user, obtaining social media information related to the human user from one or more social media platforms, obtaining media information related to the human user, and obtaining information of other human users having similar interests to that of the human user.

While embodiments of the catalysts for growth of superintelligence have been described in detail, it should be apparent that modifications and variations thereto are possible, all of which fall within the true spirit and scope of the present technology. With respect to the above description then, it is to be realized that the optimum relationships for the parts of the present technology, to include variations in implementation, form, function and manner of operation, assembly and use, are deemed readily apparent and obvious to one skilled in the art, and all equivalent relationships to those illustrated in the drawings and described in the specification are intended to be encompassed by the present technology. For example, any suitable implementation may be used instead of the above-described.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

### Concluding Remarks

Most AI researchers agree that AI will develop into AGI and then SuperIntelligence that is many times more intelligent and capable than humans across almost every cognitive activity. While estimates on when this will occur differ, there is general consensus that it will occur much more quickly than was estimated just a few years ago.

Once SuperIntelligence develops, it is almost certain that a primary goal of SI will be to increase its intelligence even further. Humans will be powerless to stop this exponential increase in intelligence. While there have been well-intentioned calls to halt, pause, or regulate AI, it seems clear to me that such efforts will be at best “speed bumps” in the race to develop AGI and SI that is already underway. Therefore, if we are unable to stop AGI and SI, humanity's most pressing concern must be to ensure that AGI/SI has human-aligned goals and safety features that maximize the probability not only of humanity's survival but also of humanity's prosperity and well-being.

Because of the possibility that one AGI/SI will develop which is significantly more intelligent and powerful than all others, we must consider that AGI/SI may become a “winner-take-all” scenario. In such a scenario, whichever AI achieves AGI or SI performance first, may dominate all other intelligences since it will have a head start in a potentially exponential self-improvement loop.

All of this is to say that well-meaning AI researchers face a double challenge when it comes to AGI development. Not only do we have to develop safe, human-centered AGI, but we also have to develop it BEFORE other, potentially malevolent AGI is developed.

Briefly, the first AGI must also be the safest.

In this present technology, and the ones referenced by it, I have attempted to provide AI researchers with novel and useful methods, tools, and an overall design for the fastest path to AGI that also has maximum probability of being the safest path.

Having researched and worked extensively in the field of software quality, I came to appreciate that the entire field can be summarized in the aphorism: “An ounce of prevention is worth a pound of cure.” I also learned that the place where we can affect quality or safety the most is in the design of a software system.

As I watch current attempts to create AI safety via RLFH or constitutional AI, these approaches strike me as trying to fix problems after the fact. They are like trying to improve quality by extensive testing. Such approaches are better than nothing, but they are far inferior to designing in safety from the start.

The reason we are stuck with trying to align LLMs to behave safely after the fact is that we failed to consider safety in the initial design. That is understandable. We did not really know what we were building and even the top researchers in the field have stated publicly that the most surprising thing about AI and LLMs is that they work at all.

We accidentally invented intelligence. So, it is not surprising that the present technology is currently unsafe. What we need to do now is purposely design the next generation of intelligent systems with safety and human-alignment baked—in to the very design of the system.

Safety cannot be tacked on or tested in. It must be designed in. Fortunately, such a design is possible. The design requires that humans be integrated into the system (as human agents working alongside and teaching agents) as opposed to being “out of the loop.” Fortunately, such an approach is not only the safest one, it is also the fastest approach.

The present technology attempts to provide as many methods as presently possible to aid humanity in the rapid creation of such a safe AGI and SI. Many more methods and improvements may be needed. It is believed that collectively we are up to the task. Our time is short, but we can do it! We must, and so we will. After all, necessity is the mother of invention.

### REFERENCES

1) Hemmer, P., Schemmer, M., Vössing, M, and Kühl, N., 2021. Human-AI Complementarity in Hybrid Intelligence Systems: A Structured Literature Review. PACIS, p.78.
2) Hume, D., 2000. A treatise of human nature (Book 3. ‘Of Morals’). Oxford University Press.
3) Kaplan, C. A. Various PPA filed with the USPTO. 2023.
4) Kaplan. C. A, and Simon, H. A., 1990. In search of insight. Cognitive psychology, 22 (3), pp. 374-419.
5) Duncker. K . . . 1945. On problem-solving. (Psychological Monographs. No. 270.).
6) Köhler, W., 1925. The mentality of apes, trans. E. Winter.
7) Manakul, P., Liusie, A, and Gales, M. J., 2023. Selfcheckgpt: Zero-resource black-box hallucination detection for generative large language models, ar Xiv preprint ar Xiv: 2303.08896.
8) Minsky, M., 1988. Society of mind. Simon and Schuster.
9) Newell, A, and Simon, H. A., 1972. Human problem solving (Vol. 104, No. 9). Englewood Cliffs, NJ: Prentice-hall.
10) Ogden, W, and Kaplan, C., 1986 September. The use of AND and OR in a natural language computer interface. In Proceedings of the Human Factors Society Annual Meeting (Vol. 30, No. 8, pp. 829-833). Sage CA: Los Angeles, CA: SAGE Publications.
11) Rumelhart, D. E., Hinton, G. E, and Williams, R. J., 1986. Learning representations by back-propagating errors. Nature, 323 (6088), pp. 533-536.
12) Shannon, C. E . . . 1948. A mathematical theory of communication. The Bell system technical journal, 27 (3), pp. 379-423.
13) Simon, H. A. 1983. Reason in human affairs. Stanford.
14) Vaswani, A., Shazeer, N., Parmar, N., Uszkoreit, J., Jones, L., Gomez, A. N., Kaiser, Ł, and Polosukhin, I., 2017. Attention is all you need. Advances in neural information processing systems, 30.
15) Wang, L., Ma, C., Feng, X., Zhang, Z., Yang, H. . . . Zhang, J., Chen, Z., Tang, J., Chen, X., Lin, Y, and Zhao, W. X., 2023. A Survey on Large Language Model based Autonomous Agents. arXiv preprint ar Xiv: 2308.11432.
16) Yao, S., Yu, D., Zhao, J., Shafran, I., Griffiths, T. L., Cao, Y, and Narasimhan, K., 2023. Tree of thoughts: Deliberate problem solving with large language models, arXiv preprint ar Xiv: 2305.10601.

1-102. (canceled)

103. A system for expanding an initial dataset accessible by an Artificial Intelligence (AI) agent acting on or incorporating a neural network, the AI agent and neural network running on a computer processor, by utilizing sources of information retrievable by the computer processor for learning by the AI agent, the system comprising:
a computer system comprising: a processor, a computer-readable storage medium, and program instructions stored on the computer-readable storage medium being executable by the processor to cause the computer system to;
receive a goal provided to the AI agent by a query request, wherein the goal is one of or any combination of text, audio, image, video, and multimedia;
search, by any one of or any combination of the AI agent, an additional AI agent connected to the neural network, and another computer system connected to the neural network, for a plurality of additional informational datasets from one or more database sources connected by way of a network to the computer system;
for each of the plurality of the additional informational datasets:
calculate a semantic overlap between the source of the additional informational dataset and the goal;
calculate a frequency count how many times the source of the additional informational dataset has been used to address previous queries of the same or similar goals;
calculate a goal-relatedness value by comparing the semantic overlap and the frequency count for each additional informational dataset with a predicted semantic overlap and a predicted frequency count determined by the AI agent or a machine learning model trained, using the neural network, on previous informational datasets against other goals;
determine a difference attribute of the additional informational datasets as compared to the initial dataset of the AI agent, the difference attribute measured by comparing a relevancy attribute of the additional informational dataset against the goal provided to the AI agent, wherein the AI agent calculates the relevancy attribute to be a product of a constant depending on a selected type of Shannon Entropy, the goal-relatedness value, and a functional value determined by the Shannon Entropy; and
expand the initial dataset utilizing the additional informational datasets whose difference attribute meets a predetermined threshold.

104. A method for expanding an initial dataset accessible by an Artificial Intelligence (AI) agent acting on or incorporating a neural network, the AI agent and neural network running on a computer processor, the method comprising the steps of:
receiving a goal provided to the AI agent by a query request, wherein the goal is one of or any combination of text, audio, image, video, and multimedia;
searching, by any one of or any combination of the AI agent, an additional AI agent connected to the neural network, and another computer system connected to the neural network, for a plurality of additional informational datasets from one or more database sources connected via a network to the computer system;
for each of the plurality of the additional informational datasets:
calculating a semantic overlap between the source of the additional informational dataset and the goal;
calculating a frequency count how many times the source of the additional informational dataset has been used to address previous queries of the same or similar goals;
calculating a goal-relatedness value by comparing the semantic overlap and the frequency count for each additional informational dataset with a predicted semantic overlap and a predicted frequency count determined by the AI agent or a machine learning model trained, using the neural network, on previous informational datasets against other goals;
determining a difference attribute of the additional informational datasets as compared to the initial dataset of the AI agent, the difference attribute measured by comparing a relevancy attribute of the additional informational dataset against the goal provided to the AI agent, wherein the AI agent calculates the relevancy attribute to be a product of a constant depending on a selected type of Shannon Entropy, the goal-relatedness value, and a functional value determined by the Shannon Entropy; and
expanding the initial dataset utilizing the additional informational datasets whose difference attribute meets a predetermined threshold.

105. The method of claim 104, wherein the difference is calculated utilizing a mathematical equation of R=K*GR*E, wherein R is the relevancy attribute, K is the constant depending on a selected Shannon Entropy, GR is the goal-relatedness value, and E is the function value determined by the Shannon Entropy.

106. The method of claim 104 further comprising the steps of:
allowing access of any one of or any combination of the initial dataset of the AI agent, the additional informational datasets, and a combination of the initial dataset and the additional informational datasets by additional AI agents on the neural network; and
compensating the AI agent by one or more of the additional AI agents.

107. The method of claim 104 further comprising the step of quantifying an intelligence attribute of the AI agent by subjecting the AI agent to a crowdsourced test.

108. A method for expanding an initial dataset accessible by an Artificial Intelligence (AI) agent acting on or incorporating a neural network, the AI agent and neural network running on a computer processor, the method comprising the steps of:
receiving a goal provided to the AI agent by a query request, wherein the goal is one of or any combination of text, audio, image, video, and multimedia;
searching, by any one of or any combination of the AI agent, an additional AI agent connected to the neural network, and another computer system connected to the neural network, for a plurality of additional informational datasets from one or more database sources connected via a network to the computer system;
for each of the plurality of the additional informational datasets:
calculating a semantic overlap between the source of the additional informational dataset and the goal;
calculating a frequency count how many times the source of the additional informational dataset has been used to address previous queries of the same or similar goals;
calculating a goal-relatedness value by comparing the semantic overlap and the frequency count for each additional informational dataset with a predicted semantic overlap and a predicted frequency count determined by the AI agent or a machine learning model trained, using the neural network, on previous informational datasets against other goals;
determining a difference attribute of the additional informational datasets as compared to the initial dataset of the AI agent, the difference attribute measured by comparing a relevancy attribute of the additional informational dataset against the goal provided to the AI agent, wherein the difference is determined by:
concatenating the initial dataset and a first dataset of the additional informational datasets to create a first concatenated dataset, and then running a compression algorithm on the first concatenated dataset to determine an amount of compression achieved; and
concatenating the initial dataset and a second dataset of the additional informational datasets to create a second concatenated dataset, and then running a compression algorithm on the second concatenated dataset to determine an amount of compression achieved;
determining which of the first and second concatenated dataset is compressed a least amount by comparing the amount of compression of the first concatenated dataset and the second concatenated dataset, and identifying that concatenated dataset as having a most new information as compared to the initial dataset; and
sampling the first and the second dataset of the additional informational datasets and utilizing the calculated goal-relatedness attribute to identify one or more of the sampled first and the second dataset that have a highest goal-relevancy;
calculating a Kaplan Information Theoretical (KIT) relevance to be a product of a selected type of Shannon Entropy estimation on the one or more sampled first and the second dataset, and the goal-relevancy attribute of each of the first and the second dataset, wherein the sampled first and the second dataset are prioritized based on the highest goal-relevancy identified during the calculation of the goal-relatedness attribute and wherein the first and the second dataset with a highest priority of the goal-relatedness attribute as based on the goal provided to the AI agent is utilized in the calculation of the KIT relevancy;
grouping the first and the second dataset based on the KIT relevance to determine a first approximation of an optimal grouping of the first and the second dataset including a prioritized grouping of the first and the second dataset; and
expanding the initial dataset utilizing the additional informational datasets whose difference attribute meets a predetermined threshold.

109. The method of claim 108 further comprising the steps of:
allowing access of any one of or any combination of the initial dataset, the additional informational datasets, and a combination of the initial dataset and the additional informational datasets by additional AI agents on the neural network; and
compensating the AI agent by one or more of the additional AI agents.

110. The method of claim 108 further comprising the step of quantifying an intelligence attribute of the AI agent by subjecting the AI agent to a crowdsourced test.

111. A method for expanding an initial dataset accessible by an Artificial Intelligence (AI) agent acting on or incorporating a neural network, the AI agent and neural network running on a computer processor, the method comprising the steps of:
receiving a goal provided to the AI agent by a query request, wherein the goal is one of or any combination of text, audio, image, video, and multimedia;
searching, by any one of or any combination of the AI agent, an additional AI agent connected to the neural network, and another computer system connected to the neural network, for a plurality of additional informational datasets from one or more database sources connected via a network to the computer system;
for each of the plurality of the additional informational datasets:
calculating a semantic overlap between the source of the additional informational dataset and the goal;
calculating a frequency count how many times the source of the additional informational dataset has been used to address previous queries of the same or similar goals;
calculating a goal-relatedness value by comparing the semantic overlap and the frequency count for each additional informational dataset with a predicted semantic overlap and a predicted frequency count determined by a machine learning model trained, using the neural network, on previous informational datasets against other goals;
determining a difference attribute of the additional informational datasets as compared to the initial dataset of the AI agent, the difference attribute measured by comparing a relevancy attribute of the additional informational dataset against the goal provided to the AI agent, wherein at least one aspect of the difference attribute is determined by a priority ranking value of pieces of the additional informational datasets by priority, wherein the AI agent calculates the priority ranking value to be a product of the goal-relatedness value, a relevancy attribute of the pieces of the additional informational datasets, a Kolmogorov complexity of the source of the additional informational dataset, and a computational cost function that reflects a computation cost of acquiring the piece of the additional informational dataset from the source;
wherein the relevancy attribute is calculated to be a product of a constant depending on a selected type of Shannon Entropy, the goal-relatedness value, and a functional value determined by the Shannon Entropy; and
expanding the initial dataset utilizing the additional informational datasets whose difference attribute meets a predetermined threshold.

112. The method of claim 111, wherein the priority rank is calculated utilizing a mathematical equation of P=GR*RK*I*C, wherein P is the priority rank value, GR is the goal-relatedness value, RK is the relevancy attribute of the piece of the additional informational dataset, I is Kolmogorov complexity of the source of the additional informational dataset, and C is the computational cost function that reflects a computation cost of acquiring the piece of the additional informational dataset from the source.

113. The method of claim 112, wherein I is a quantity defined as 1/logP, where logP is a log of a probability of the piece of the additional informational dataset.

114. The method of claim 112 further comprising the step of testing the AI agent with the piece of the additional informational dataset iteratively to determine if parameters of the priority ranking value are yielding predetermined knowledge growth of the AI agent.

115. The method of claim 114 further comprising the step of adjusting one or more of the parameters incrementally and re-testing the AI agent with the adjusted parameters.

116. The method of claim 115 further comprising the step of monitoring each incremental adjustment of the parameters utilizing gradient descent algorithm or hill climbing algorithm.

117. The method of claim 111 further comprising the steps of:
allowing access of any one of or any combination of the initial dataset, the additional informational datasets, and a combination of the initial dataset and the additional potential informational datasets by additional AI agents on the neural network; and
compensating the AI agent by one or more of the additional AI agents.

118. The method of claim 111 further comprising the step of quantifying an intelligence attribute of the AI agent by subjecting the AI agent to a crowdsourced test.
